(19) United States
(12) Patent Application Publication
(10) Pub. No.: US 2025/0217738 A1
(43) Pub. Date: Jul. 3, 2025

(54) Systems and Methods for Item Placement for Improving Warehouse Productivity

(71) Applicant: CHEWY, INC., Plantation, FL (US)

(72) Inventors: Aakash Bhatt, Plantation, FL (US); Matthew Jurado, Plantation, FL (US); Amith Tarigonda, Plantation, FL (US)

(21) Appl. No.: 18/930,993

(22) Filed: Oct. 29, 2024

Related U.S. Application Data
(60) Provisional application No. 63/594,105, filed on Oct. 30, 2023.

(51) Int. Cl. G06Q 10/0631

(52) U.S. Cl. CPC G06Q 10/06315

(57) ABSTRACT

A system and method are provided for controlling item placement for managing warehouse productivity. The system may include one or more warehouse databases, and one or more processors. The processors may be configured to interface with the one or more warehouse databases, extract, transform and load information from the one or more warehouse databases to form an input dataset, perform cost analysis and discrete event simulation to the input dataset to obtain a candidate dataset, and provide a recommendation for an optimal mix of volume flow through different forward pick areas of a warehouse by applying a linear programming solver on the candidate dataset.

### CROSS-REFERENCE TO RELATED APPLICATION

This application claims the benefit of U.S. Provisional Patent Application No. 63/594,105, filed Oct. 30, 2023, entitled “Systems and Methods for Item Placement for Improving Warehouse Productivity,” which is incorporated by reference herein in its entirety.

### TECHNICAL FIELD

The disclosed embodiments relate generally to supply chain management and more specifically to systems and methods for item placement for improving warehouse productivity.

### BACKGROUND

Businesses may have different types of warehouses, such as storage warehouses, distribution centers, and e-commerce fulfillment centers. Traditionally, warehouses were simple hub-and-spoke structures that served as storage locations for products before they were shipped to stores or customers. With the rise of e-commerce, traditional warehouses could not keep up with demand, leading to the creation of fulfillment centers (FCs)—large warehouse facilities dedicated solely to fulfilling online orders. FCs are specialized warehouses designed to process and fulfill online orders quickly, efficiently, and accurately. FCs handle a high volume of small and individualized orders with short delivery times-they have unique operational processes that differ from traditional warehouses.

Warehouse automation has become increasingly popular in recent years due to its ability to improve efficiency, reduce costs and increase accuracy. Automating warehouse operations involves utilizing technologies such as automated storage and retrieval systems (ASRS), conveyors, robotics, and other computerized systems to manage various tasks in the warehouse. In an FC, since order picking is the most expensive process, optimizing it with automation reduces operational costs and improves the overall warehouse efficiency in terms of productivity, accuracy, and order fulfillment speed. Goods-to-person (GTP) systems in automated FCs reduce approximately 65% of total labor time spent traveling by routing inventory and customer order boxes to order pickers on automated conveyance. When designing an FC, the physical layout, automation technologies, and storage configurations needs to be carefully chosen and customized to fit the needs of the e-commerce business.

Different storage configurations, such as pallet flow, carton flow, drive-in racks, mezzanine floors, vertical lift modules, and bin shelving, offer distinct advantages for organizing and managing inventory. Choosing the right storage configurations for both reserve and forward pick areas depend on the size and shape of the items being stored, the frequency of access, and the available space. For example, pallet flow storage is ideal for high-density storage of bulk goods, offering a first-in, first-out system, and gravity rollers to move the pallets to the front automatically.

### SUMMARY

Accordingly, there is a need for systems and methods that address at least some of the problems described above. Aspects of the system disclosed herein utilize discrete event simulation and linear programming techniques for item placement to improve warehouse productivity.

In accordance with some embodiments, a method executes at a computer system having one or more processors and memory storing one or more programs configured for execution by the one or more processors. The system may be used for controlling item placement and/or for managing warehouse productivity. The system may include one or more warehouse databases, and one or more processors. The one or more processors may be configured to interface with the one or more warehouse databases, extract, transform and/or load information from the one or more warehouse databases to form an input dataset, perform cost analysis and discrete event simulation to the input dataset to obtain a candidate dataset, and provide a recommendation for an optimal mix of volume flow through different forward pick areas (optimal slotting) of a warehouse by applying a linear programming solver on the candidate dataset.

In some embodiments, the one or more processors may be further configured to automatically control, based on the recommendation, physical item placement in the warehouse by causing automated storage and retrieval system robots to redistribute items between storage areas according to the recommendation, adjust automated conveyor system routing and merge point controls to implement the recommended volume flow, and/or dynamically adjust container release rates at merge points based on real-time monitoring of physical work-in-progress metrics to prevent system gridlock.

In some embodiments, the one or more processors may be further configured to continuously monitor container dwell times and physical work-in-progress at merge points, and automatically adjust container routing and release timing to maintain the recommended optimal mix while preventing gridlock conditions in a physical conveyor system

In some embodiments, the information loaded from the one or more warehouse databases may include data regarding Stock Keeping Units (SKU), physical storage locations, physical conveyance parameters and automation specifications.

In some embodiments, extracting information may include obtaining a list of items, slots and forward pick assignments by location type. Information related to slots may include data pertaining to slot numbers, aisle locations, rack positions, and any other relevant slot attributes, wherein information related to forward pick assignments include information on allocation of items to specific pick locations for enhancing order fulfillment efficiency.

In some embodiments, transforming the information may include cleaning, enriching, and manipulating data into a consistent format that meets format requirements of a discrete event simulation engine.

In some embodiments, loading the information may include transferring transformed data into a target network data storage system.

In some embodiments, performing discrete event simulation may include using a model representing a fulfillment center as a series of interconnected components or entities, including machines, workers, customers or combinations thereof, that interact with each other over time, as a series of discrete events that match how orders flow through the fulfillment center. The model may be run a plurality of iterations, with different input parameters and scenarios, to determine impact of different conditions and decisions on performance of the fulfillment center.

In some embodiments, the components may include orders, products, workers, equipment, robotics, automation, and transportation systems. The discrete events may include arrivals, product movements, equipment processing and worker actions, which occur at specific points in time.

In some embodiments, the model may include engineering computer-aided design (CAD) drawings that replicate infrastructure the fulfillment center. Data collected during the extract, transform and load may be used to populate key points within the model to build a logical model required for analysis.

In some embodiments, the model may be run continuously to build inputs for the linear programming solver.

In some embodiments, the model may be iteratively run based on the input dataset, until optimal volume thresholds flowing through different forward pick location types is determined.

In some embodiments, performing cost analysis may include determining net picking and replenishment cost per unit processed in a fulfillment center, segregated by storage configuration.

In some embodiments, performing cost analysis may include analyzing labor hours and cost, grouped by forward pick location type, utilizing employee clock-in records, department information, area specifications, transactional data or combinations thereof.

In some embodiments, performing the discrete event simulation may include performing random replications by running a simulation model multiple times with different sets of random input values, to obtain a range of results and analyze statistical measures such as mean, standard deviation, confidence intervals, or percentiles and get eliminate results based on chance or bias.

In some embodiments, performing the discrete event simulation may include defining a set of experimental parameters for a discrete event simulation engine to automatically run simulations, including defining a range or distribution for each parameter and using the discrete event simulation engine to automatically generate random values within those ranges for each replication.

In some embodiments, performing the discrete event simulation may include representing picking by container dwell times in both manual and automated picking areas/workstations. Dwell times may be modeled using a probability distribution based on historical data. The dwell times indicate how much capacity in each picking area is being utilized.

In some embodiments, the linear programming solver may be based on a Simplex method.

In some embodiments, the linear programming solver may optimize picking and replenishment cost per unit for a given target volume, minimizes cost per unit while meeting a target volume requirement.

In some embodiments, the one or more processors may be further configured to adjust item placement to align with recommended mix from different location types, continuously to reduce costs and improve cycle time.

In some embodiments, the one or more processors may be further configured to adapt to demand volatility by realigning item placement within a defined mix, including causing shifting items to more prominent locations, adjusting quantities based on demand forecasts, or accounting for new products allocated to a fulfillment center.

In some embodiments, the one or more processors may be further configured to generate a summary dashboard for real-time monitoring of fulfillment center slotting health, including listing open or unslotted location, charges by location type, and containers percentage with multi-MOD (Module Order Distribution) travel.

In some embodiments, the one or more processors may be further configured to monitor fluctuations in volume of incoming units to a fulfillment center and implement adjustments to achieve a balanced distribution of workload (units to be picked) across various mods, levels, and zones.

In some embodiments, the one or more processors may be further configured to track metrics in real time, compare the metrics against predefined targets or benchmarks, and set up browser alerts or e-mail notifications based on thresholds being exceeded.

In some embodiments, the one or more processors may be further configured to provide ongoing monitoring of benchmarked values pertaining to process path mix including an optimal number of units assigned to robots for picking tasks (ASRS) and an acceptable threshold that ensures uninterrupted flow during unit picking activities involving both robots (ASRS) and manual pickers.

In some embodiments, the one or more processors may be further configured to monitor week-over-week slotting performance metrics for each fulfillment center, analyze aggregated volume mix, heat mapping, identify improvement opportunities, and/or address constraints faced in achieving an optimal distribution of units between bot picking (ASRS) and manual picking activities.

In some embodiments, the one or more processors may be further configured to analyze distribution of orders across multiple MODs (Module Order Distribution).

In some embodiments, the one or more processors may be further configured to provide insights into number of containers fulfilled through inter-MOD travel, specifically within 1 MOD, 2 MODs, 3 MODs, and/or 4 MODs.

In some embodiments, the one or more processors may be further configured to adjust volume and mix across storage configurations by generating a locations user interface on a web portal that can be used to edit slotting parameters of forward pick locations.

In another aspect, an electronic device includes one or more processors, memory, a display, and one or more programs stored in the memory. The programs are configured for execution by the one or more processors and are configured to perform any of the methods described herein, according to some embodiments.

In another aspect, a non-transitory computer readable storage medium stores one or more programs configured for execution by a computing device having one or more processors, memory, and a display. The one or more programs are configured to perform any of the methods described herein, according to some embodiments.

Thus, methods and systems are disclosed that improve warehouse productivity using discrete event simulation and linear programming techniques for item placement.

Both the foregoing general description and the following detailed description are exemplary and explanatory, and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Embodiments below, in conjunction with the following drawings in which like reference numerals refer to corresponding parts throughout the figures.

FIG. 1 shows a block diagram of a system for optimal item placement for improving warehouse productivity, according to some embodiments.

FIG. 2 is a block diagram of an example architecture for optimal item placement for improving warehouse productivity, according to some embodiments.

FIG. 3A shows a flowchart of an example process for fulfillment operations, according to some embodiments.

FIG. 3B shows an example flow of goods in an FC, according to some embodiments.

FIG. 4A shows an example storage using packet flow racking, according to some embodiments.

FIG. 4B shows an example storage using carton flow racking, according to some embodiments.

FIG. 5A is a schematic diagram of an example process for optimal item placement for improving warehouse productivity, according to some embodiments.

FIG. 5B shows an example user interface for distribution fitting using ExpertFit, according to some embodiments.

FIG. 6 shows an exemplary process architecture for item placement for improving warehouse productivity, according to some embodiments.

FIG. 7A shows a flowchart for an example process for extract and transform, according to some embodiments.

FIG. 7B shows a flowchart for an example process for extract and transform, according to some embodiments.

FIG. 7C shows a flowchart for an example process for extract and transform, according to some embodiments.

FIG. 8 shows a flowchart for an example workflow for cost analysis, according to some embodiments.

FIG. 9 is a flowchart for an example process using discrete event simulation for flow analysis, according to some embodiments.

FIG. 10A is a schematic diagram of an example simulation engine, according to some embodiments.

FIG. 10B is a schematic diagram of an example process flow model, according to some embodiments.

FIG. 10C is a schematic diagram of an example process flow model, according to some embodiments.

FIG. 10D shows an example process flow and code that abstracts warehouse execution system control logic, according to some embodiments.

FIGS. 10E and 10F show a 5-to-1 merge example, according to some embodiments.

FIG. 10G shows a block diagram of an example method for lane release, according to some embodiments.

FIG. 11 shows a flow chart of a method for a linear programming solver, according to some embodiments.

FIG. 12 shows a table for example simulation scenarios and results, according to some embodiments.

FIG. 13A is an example optimal mix recommendation, according to some embodiments.

FIG. 13B is an example high-level report for an optimal mix recommendation, according to some embodiments.

FIG. 13C shows an example recommendation for an optimal mix, according to some embodiments.

FIG. 13D shows an example cost analysis output, according to some embodiments.

FIG. 13E shows an example linear programming solver tying cost and flow, according to some embodiments.

FIG. 14A is an example graphical user interface for an experimenter job setup, according to some embodiments.

FIG. 14B is an example graphical user interface for starting automated job runs, according to some embodiments.

FIG. 15 is a schematic diagram of an example process for rerunning workflows, according to some embodiments.

FIG. 16A shows an example slotting health summary, according to some embodiments.

FIG. 16B shows an example slotting tolerance report, according to some embodiments.

FIG. 16C shows an example slotting tolerance report with drill-down options for viewing zone container overview, according to some embodiments.

FIG. 16D shows an example slotting tolerance report with a detailed view of item and container, according to some embodiments.

FIG. 16E shows an example flow health tracker for container process path and daily ASRS trends, according to some embodiments.

FIG. 16F shows an example heat map for container process path and daily ASRS trends for containers of an FC, according to some embodiments.

FIG. 16G shows an example dashboard for container travel path details, according to some embodiments.

FIG. 16H shows an example user interface for viewing locations in a warehouse management system web portal, according to some embodiments.

FIG. 16I shows an example user interface for adjusting locations in a warehouse management system web portal, according to some embodiments.

FIG. 17A shows an example report for routing sorter recirculation, according to some embodiments.

FIG. 17B shows an example report for pack sorter recirculation and ship sorter recirculation, according to some embodiments.

FIG. 18 shows an example user interface to specify simulation inputs, according to some embodiments.

FIG. 19A is an example simulation dashboard for charge containers per minute (CPM), according to some embodiments.

FIG. 19B is an example simulation dashboard for auto-store virtual backlog, according to some embodiments.

FIG. 19C is an example simulation dashboard for system physical work in progress (WIP), according to some embodiments.

FIG. 19D is an example simulation dashboard for shipped CPM, according to some embodiments.

FIG. 19E is a table showing example cycle time breakdown, according to some embodiments.

FIG. 20A is an example dashboard for material flow, according to some embodiments.

FIG. 20B is an example dashboard for key metrics, according to some embodiments.

FIG. 21A is an example dashboard for viewing and/or selecting simulation experimentation runs, according to some embodiments.

FIG. 21B is an example dashboard for viewing container cycle time, according to some embodiments.

FIG. 22 shows an example user interface for comparing optimal mix recommendation results, according to some embodiments.

FIG. 23 shows an example user interface for real-time monitoring user interface, according to some embodiments.

FIG. 24A shows an example user interface for a warehouse management system, according to some embodiments.

FIG. 24B shows another example user interface for warehouse management system, according to some embodiments.

FIG. 24C shows another example user interface for warehouse management system, according to some embodiments.

FIG. 25 shows an example user interface for real-time monitoring flow recirculation, according to some embodiments.

FIG. 26 shows another example user interface for real-time monitoring flow recirculation, according to some embodiments.

FIG. 27A shows an example warehouse management system locations user interface, according to some embodiments.

FIG. 27B shows another example warehouse management system locations user interface with edit/add location option, according to some embodiments.

FIG. 28 shows an example warehouse execution system inventory management user interface, according to some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring one or more of these specific details.

### DESCRIPTION OF EMBODIMENTS

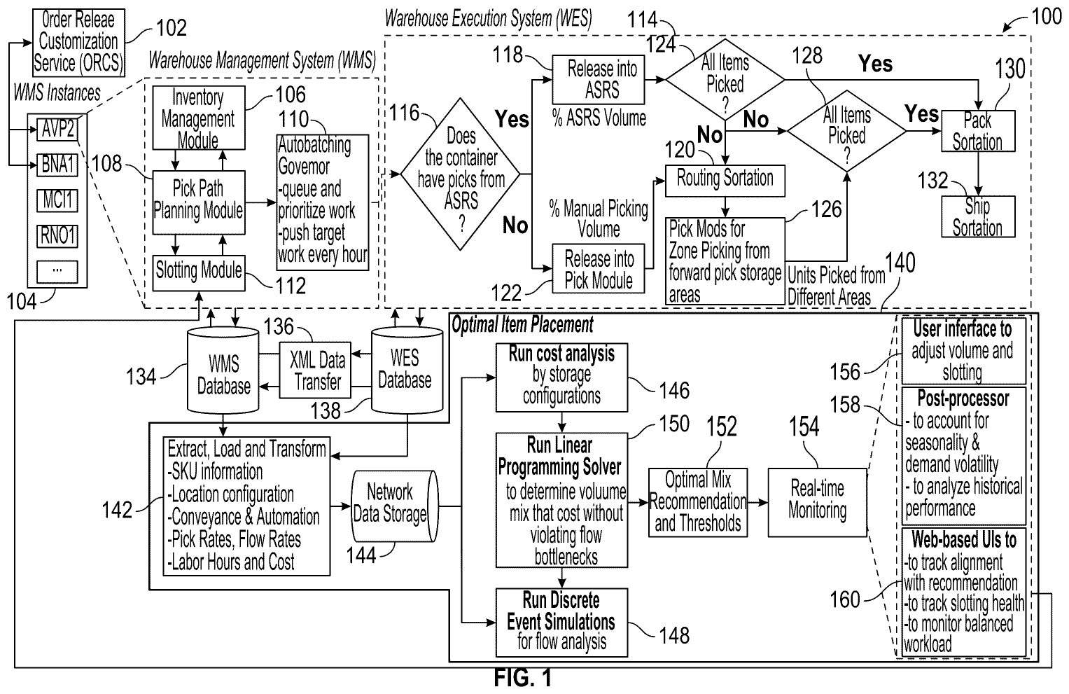

FIG. 1 shows a block diagram of a system 100 for optimal item placement for improving warehouse productivity, according to some embodiments. An order release customization service (ORCS) 102 may customize orders for routes (e.g., orders from an order management service) which are split into warehouse management system (WMS) instances 104. Each WMS instance 104 may include components for containerization, carrier rating, picking, and ship scanning. Each WMS instance 104 may include an inventory management module 106 for managing inventories, a pick planning module 108 for planning picking, a slotting module 112 for slotting, and/or an automatic batching governor 110 for queuing and prioritizing work and/or sending target work (e.g., work sent to a warehouse execution system (WES) 114, every hour).

The WES 114 may be configured to determine (116) if the container has picks from ASRS (e.g., an order assigned to robots for picking tasks). If there are no associated picks, the WES 114 may release (122) the container into pick module for routing sortation (120), where the release may be based on the percentage of manual picking volume. For the container that contains associated picks, the WES 114 may release (118) picks into ASRS, where the release may be based on the percentage of ASRS volume. The WES 114 may be configured to determine (124) if all items are picked. If all items are picked, the WES 114 may send picked items for pack sortation (130). If items are not all picked, the WES 114 may send unpicked items for routing sortation (120) and then to pick modules for zone picking (126) from forward pick storage areas, where units may be picked from different areas.

The WES 114 may be configured to determine (128) if all items are picked after zone picking (126). If all items are picked, the WES 114 may send picked items for pack sortation (130). Pack sortation is a conveyor system that diverts picked containers into any available pack stations to balance the workload across all pack stations. At pack stations, containers may be groomed by re-arranging items, filling void space with dunnage, and/or taping them prior to shipping. If items are not all picked, the WES 114 may send unpicked items back for routing sortation (120). A WMS database (134) may include data regarding WMS and a WES database (138) may include data regarding WES. The WMS database 134 and the WES database 138 may bilaterally exchange and transfer data through an XML data transfer (136). Both the WMS database 134 and the WES database may perform optimal item placement (140) to optimize picks for slotting module 112. The optimal item placement 140 may be configured to extract, load, and transform (142) data from the WMS database 134 and the WES database 138 to network data storage 144. The data sent to the network data storage 144 may include SKU information, location configuration, conveyance and automation, pick rates, flow rates, labor hours, and cost. The data may be used to run cost analysis by storage configurations (146) and discrete event simulations for flow analysis (148). The results from the cost analysis and the discrete event simulations may be used to run linear programming solver to determine volume mix that yield the least cost without violating flow bottlenecks, for optical mix recommendation and thresholds (152) and further real-time monitoring 154. The real-time monitoring 154 may include a user interface (156) to adjust volume and slotting, a post-processor 158 to account for seasonality and demand volatility and to analyze historical performance, and/or web-based user interfaces 160 to track alignment with recommendation, track slotting health, and monitor balanced workload. Outputs of the real-time monitoring step 154 may be sent to the slotting module 112, for pick path planning.

There are several technologies available for picking operations in FCs to increase the efficiency, speed, and accuracy of picking activities, each with its own advantages and disadvantages. Some embodiments include pick-to-light systems, voice picking systems, barcode scanning, and/or automated storage and retrieval systems. These technologies may be combined with selected storage configurations and/or automation layouts to achieve productivity gains in an FC.

Slotting is the practice of assigning and storing products across different storage locations based on factors including unit velocity, size, weights, and other considerations. It involves analyzing product characteristics, order patterns and storage constraints to determine the most effective location for each item within the warehouse. The goal of a slotting strategy includes minimizing the time and effort required to pick and store products, reducing travel time, and/or labor costs, improving overall warehouse performance and combinations thereof.

Conventional slotting strategies include organizing based on seasonality, utilizing warehouse space, reducing the travel time of products, balancing workflow and combinations thereof. Implementing an optimized slotting strategy that satisfies the needs of the business can be challenging due to various reasons. Slotting requires a significant amount of planning and organization, which can be difficult to achieve even with the right personnel and technological resources. Another challenge is the need to balance competing priorities, such as maximizing item density in each storage area while minimizing the negative impact density has on automated conveyance flow. Slotting requires substantial data analysis to determine the optimal location sizes and SKU placement within the FC based on business objectives. FCs must also account for high growth rates, seasonality, and demand volatility when making slotting decisions. Implementing a slotting strategy requires a thorough understanding of available physical infrastructure and automation, along with careful planning, organization, and data analysis, as well as the right personnel and technological resources. FCs fail to implement the right slotting strategy, leading to problems that impact warehouse efficiency, productivity, and profitability.

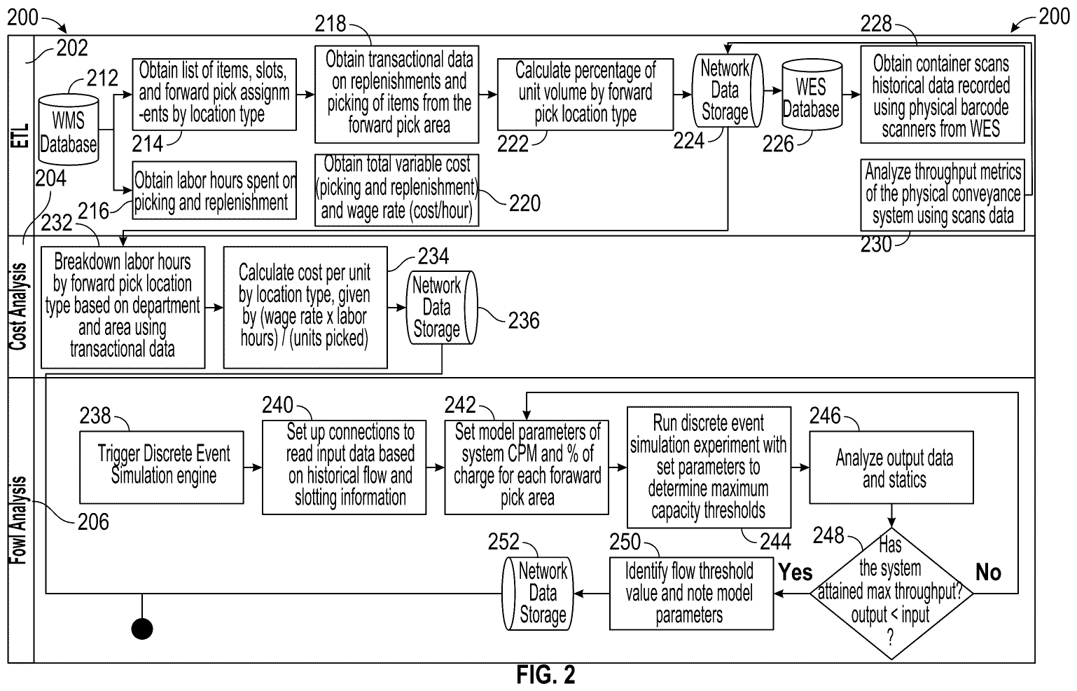

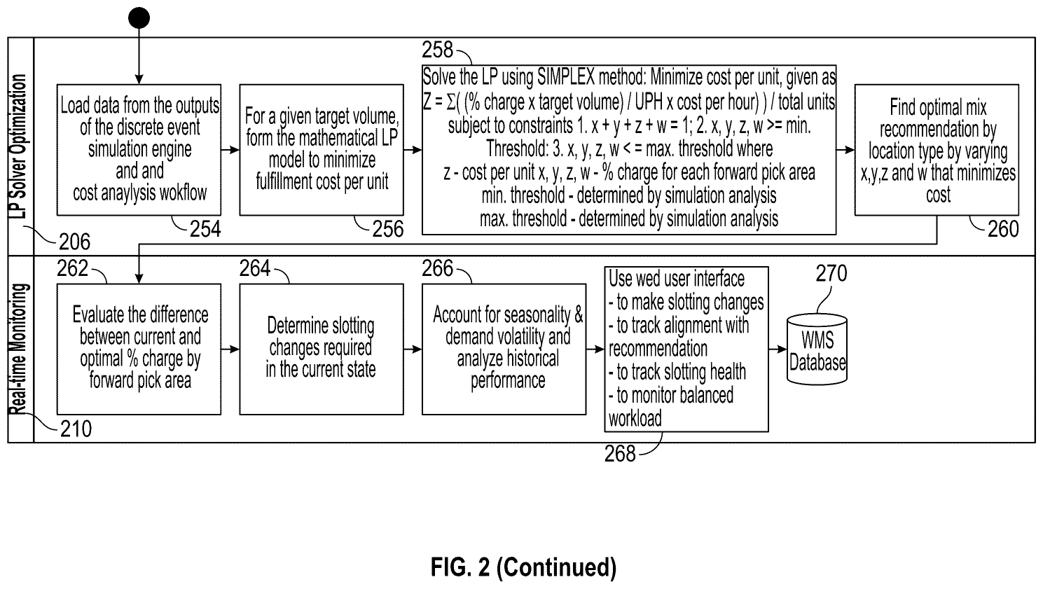

FIG. 2 is a block diagram of an example architecture 200 for optimal item placement for improving warehouse productivity, according to some embodiments. The architecture 200 may be modeled as a pipeline that includes a phase for extract, transform and load (ETL) (202), a phase for cost analysis (204), a phase for flow analysis (206), a phase for linear programming (LP) solver optimization (208), and a phase for real-time monitoring (210). The ETL phase 202 may include obtaining (214) a list of items, slots, and forward pick assignments by location type (214) from a WMS database 212, obtaining (218) transactional data on replenishments and picking of items from a forward pick area, calculating (222) percentage of unit volume by forward pick location type, and sending (224) results to a network data storage (224). The ETL phase 202 may include obtaining (216) labor hours spent on picking and replenishment from the WMS database 212, obtaining (220) total variable cost (e.g., picking and replenishment) and wage rate (e.g., cost and hour), and sending results to a network data storage 224. The ETL phase 202 may include obtaining (228) container scans historical data recorded using physical barcode scanners from a WES database 226, analyzing (230) throughput metrics of the physical conveyance system using scans data, and sending results to a network data storage 224. This may be followed by the cost analysis phase 204 that may include breaking down (232) labor hours by forward pick location type based on department and area using transactional data from the network data storage 224, calculating cost per unit by location type, which may be calculated by (wage rate times labor hours)/(units picked), and sending results to a network data storage 236. In the flow analysis phase 206, a discrete event simulation engine may be triggered (238), connections to read input data may be set up (240) based on historical flow and slotting information, model parameters of system CPM and percentage of charge may be set (242) for each forward pick area, discrete event simulation experiment with set parameters may be run (244) to determine maximum capacity thresholds, and output data and statistics may be analyzed (246). The flow analysis phase 206 may be configured to determine (248) if the system has attained maximum throughput. If the output is smaller than the input, the analyzed output data and statistics may be sent to identify (250) flow threshold value and note model parameters, and the results may be saved (252) in the network data storage accordingly. Or additionally, and/or alternatively, the analyzed output data and statistics may be used to optimize model parameters of system CPM and percentage of charge for each forward pick area. The LP solver optimization phase 208 may include loading data (238) from the outputs of the discrete event simulation engine saved in the network data storage 252 and the outputs of cost analysis workflow saved in the network data storage 236, forming the mathematical LP model for a given target volume to minimize fulfillment cost per unit (256), and solving the LP model using SIMPLEX method (258), and finding an optical mix recommendation by location type (260). The optimal mix may be the ideal percentage split of the total picked units across different storage configurations or forward pick location types. A given mix may be ideal (optimal) when it offers the least cost and least cycle time. The goal of the LP model may be to minimize cost per unit, given as Z=Σ((% change×target volume)/UPH×cost per hour))/total units.

Example constraints of the LP model include x+y+z+w=1, x, y, z, w≥minimum threshold, and x, y, z, w≥maximum threshold, where (1) z is cost per unit. (2) x, y, z, and w are percentage charge for each forward pick area, respectively, and (3) minimum threshold and maximum threshold are determined by simulation analysis. The real-time monitoring phase 210 may include evaluating (262) the difference between current and optimal percentage charge by forward pick area based on the results from the recommendation from the LP model 260, determining (264) slotting changes required in the current state, accounting (266) for seasonality and demand volatility and analysis historical performance, using (268) web user interface, and/or saving (270) results to the WMS database. Web user interface may be used to make slotting changes, track alignment with recommendation, track slotting health, and monitor balanced workload.

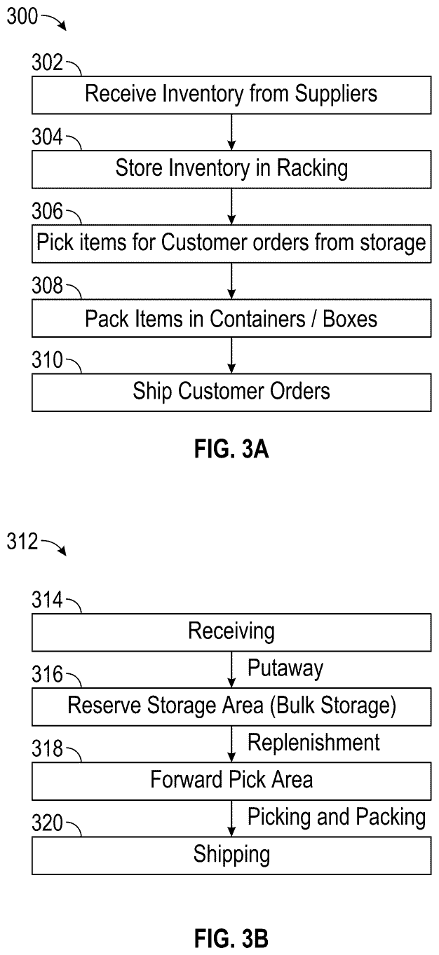

FIG. 3A shows a flowchart of an example process 300 for fulfillment operations, according to some embodiments. A first step in fulfillment operations may include receiving (302) inventory which involves unloading products from supplier trucks and verifying the contents against purchase orders before placing them into storage locations, typically racking structures. In an FC, products may be organized (304) for easy accessibility during the picking process, which involves choosing items to fulfill customer orders. Order picking is the most time-consuming and expensive step in the fulfillment process. After a customer places an order on an e-commerce platform or website, it is transmitted electronically to the FC, which must be processed promptly. Order processing typically starts with order picking (306), including identifying and retrieving products from storage shelves, then packing (308) selected items into shipping containers or boxes, followed by shipping (310) the orders.

FIG. 3B shows an example flow 312 of goods in an FC, according to some embodiments. A typical FC has two kinds of storage spaces: reserve and forward pick areas. After receiving (314) products, the products are kept (316) in reserve storage (static storage) until required in the forward pick area (dynamic storage). The area in the warehouse where items are routinely picked for order fulfillment due to ease of accessibility is known as the forward pick area. Depending on the size and weight of the goods, products are stored (318) in the forward pick area in different storage configurations so they may be quickly picked and sorted, before being shipped (320). Although picking from the forward pick area is most effective, FCs must have defined processes to replenish products in the forward pick area from the reserve storage area.

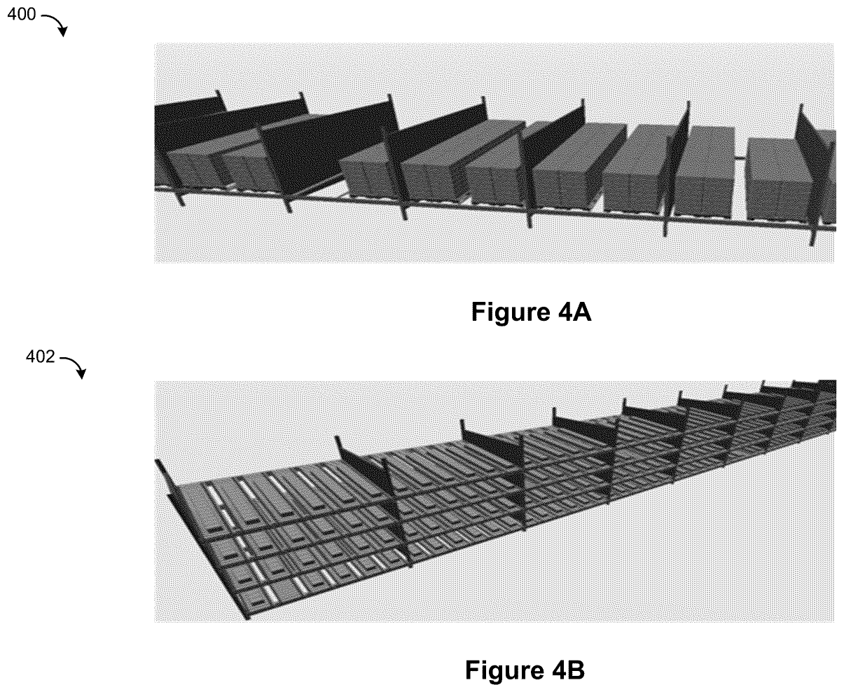

FIG. 4A shows an example storage 400 using packet flow racking, according to some embodiments. Carton flow storage is ideal for storing small to medium-sized products. ASRS is suitable for maximizing vertical space usage in the FC and minimizing the need for human intervention in the storage and retrieval process. FIG. 4B shows an example storage 402 using carton flow racking, according to some embodiments. Bin shelving is suitable for organizing and storing slow-moving items of varying sizes.

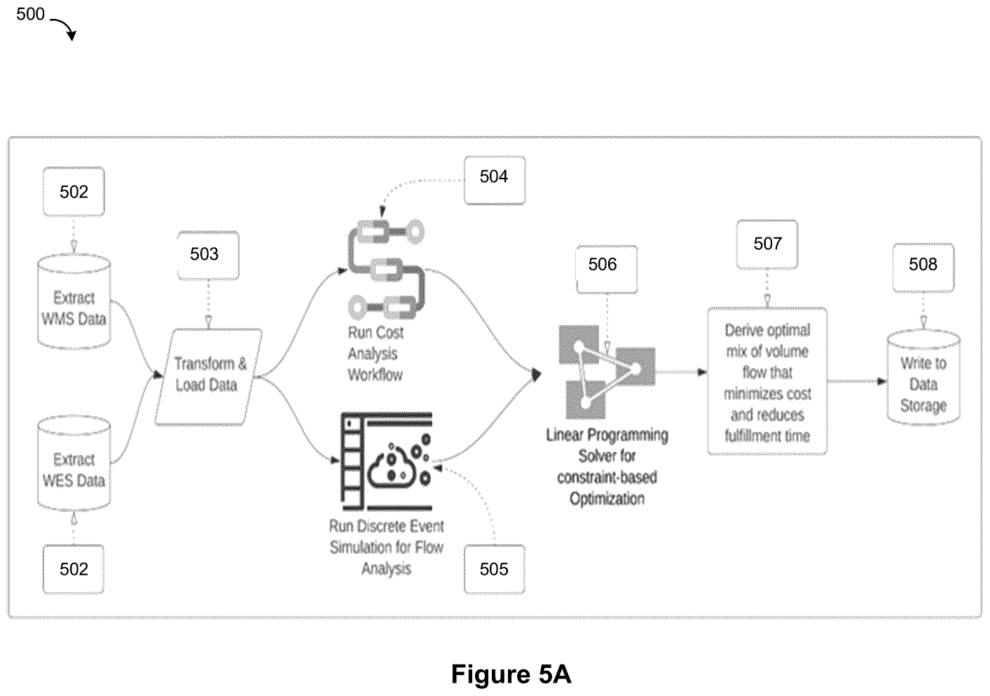

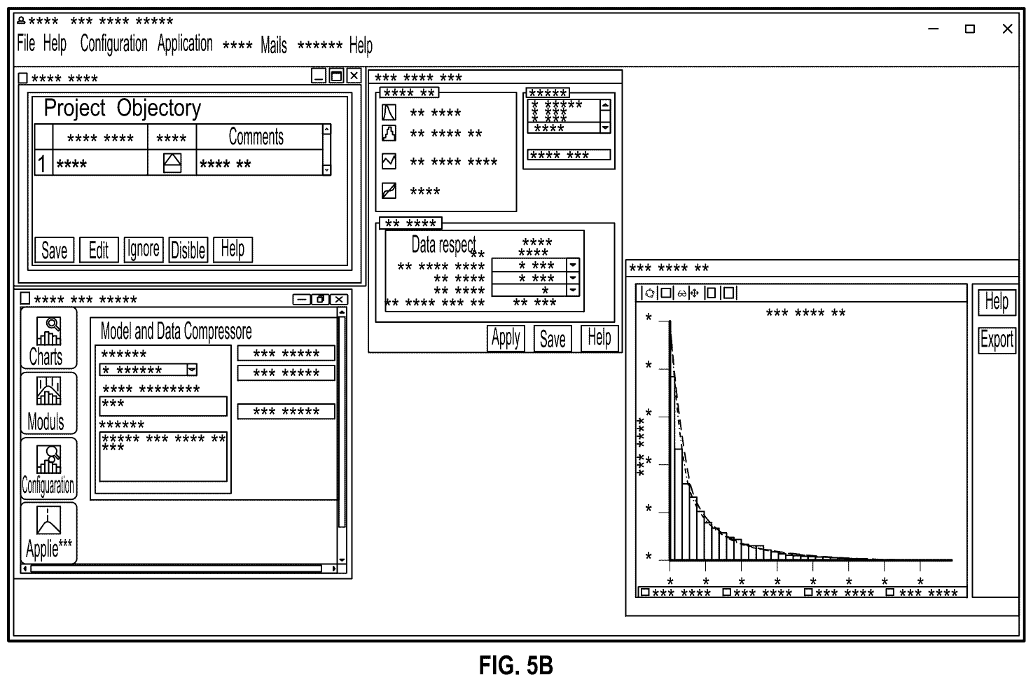

FIG. 5A is a schematic diagram of an example process 500 for optimal item placement for improving warehouse productivity, according to some embodiments. Some embodiments include an extract, transform, load process as a preliminary component within the system. During an extraction stage 201, historical data may be loaded from the Warehouse Management System (WMS) for a chosen time period. Critical data regarding Stock Keeping Units (SKU), physical storage locations, physical conveyance parameters and automation specifications. WMS data may include descriptive data on SKUs such as length, width, height, weight, volume movement, and item classification. Physical storage locations may be storage locations within the available storage configurations: SKUs may be stored in one of the available types of locations. Data may be extracted for these physical locations, such as location type, location dimensions (length, width, height), physical SKU storage limitations, X coordinates, Y coordinates, and Z coordinates. Systems parameters, such as container releases, work in progress queues, zone capacity settings, zone volume limits, and container processing paths, may be extracted.

Conveyance and automation parameters may be extracted from WES in stage 502. These parameters may include container barcode scans, divert confirmations, conveyance speeds, downtime, flow metrics such as recirculation, and/or critical containers per minute (CPM). Source data from the extraction process is then consolidated for the chosen time period.

WMS forward pick assignment is a WMS feature that allows assigning items to forward pick locations. This feature may be used to align the actual operations with the optimal mix by location type determined by this workflow. With WMS pick to exhaust feature, the WMS may direct all orders to pick all the available items from a specific location until it is emptied. This feature helps manage locations when re-aligning slotting to match the optimal mix. With WMS pick path planning. WMS may use picking flow integers to determine the pick path taken by containers flowing on the conveyance system to pick from different location types. This feature may be used to define how much volume is planned and released for one FC area/location type in a given time period. With the recommended optimal mix implemented in the actual world through slotting changes, WMS pick path planning may define the route of containers (manual pick zones to travel for picking). In addition to, or instead of, live order routing in the physical system, historical WES scanner data may be used for advanced analytics or planning. The example workflow shown in FIG. 5 may utilize scanner data to calculate recirculation and/or may map historical CPM across different areas required for DES engine inputs.

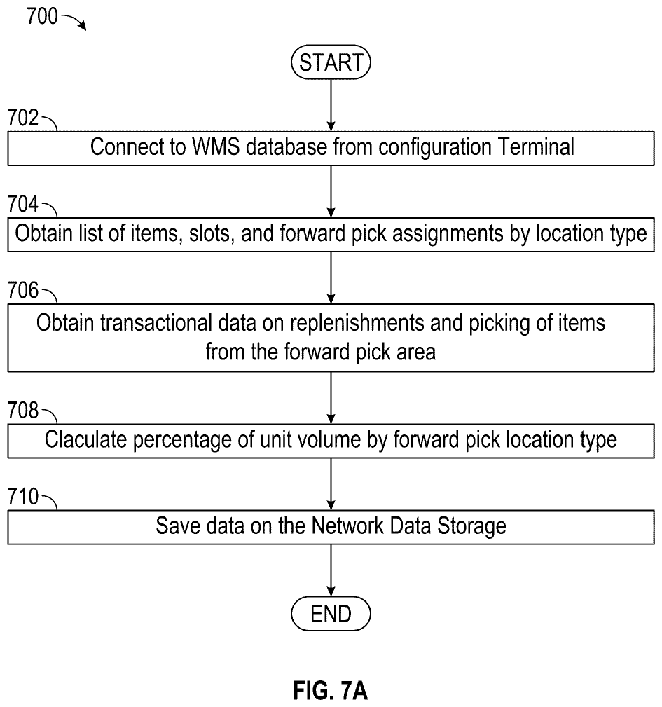

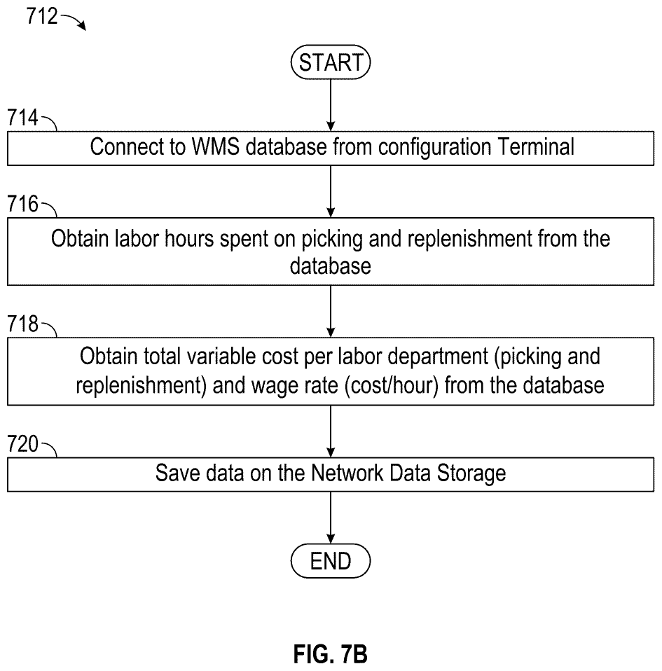

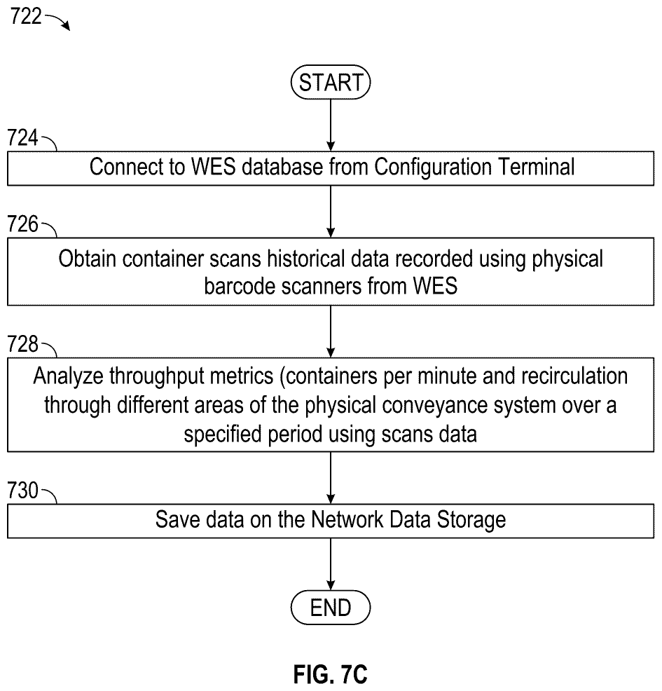

In the transformation stage 503, data may be cleansed, enriched, and manipulated into a consistent format that meets format requirements within the discrete event simulation engine. Subsequently, the load stage may include transferring the transformed data into a target network data storage system, making it readily available for cost and simulation analysis. Example workflows for the extract, transform and load stages are described below in reference to FIGS. 7A-7C, according to some embodiments.

Data cleansing may include the use of data-wrangling tools like SQL, Qlik, and KNIME. Data cleansing may include extracting data from WMS and WES, and/or transforming the data using various functions, such as string, numeric, date and time, aggregate, and set analysis functions. These functions may enable calculations, aggregations, data manipulations, and transformations to match the required format for cost and flow analysis. Additionally, ExpertFit software may be utilized for distribution fitting and statistical analysis of manual picking/dwell times. Example tools that may be used are described below.

SQL/Qlik Sense Engine: The input data for cost analysis may be extracted, transformed, and processed using SQL and Qlik syntax within the Qlik engine. The code may employ Common Table Expressions (CTEs), data retrieval and transformation, data combination, and data integration by joining and filtering information from multiple tables from WMS. The code may manipulate the data by transforming and aggregating it to calculate metrics like units, transactions, cost, labor hours, units per hour, and time in seconds for each warehouse, time segment, labor function, and location type.

SQL and database (DB) Connector within the simulation engine: In some embodiments, FlexSim DES engine uses the DB Connector feature to connect the simulation model to databases. It allows the model to read data from the database by importing the results of multiple SQL queries into FlexSim. Around 80% of the input data for the DES engine may be gathered using the DB Connector. Placeholder values from FlexSim variables may be dynamically inserted into queries. The query results may be accessed and retrieved within the simulation model, where the input data may be further transformed to derive and set specific flow model parameters using simulation code.

KNIME and ExpertFit: About 10% of the input data for the DES engine may be processed using KNIME and ExpertFit. Order picking is an important aspect of cost analysis and flow analysis. Order-picking data may be used in cost analysis workflow to determine the picking cost per unit associated with each location type. Within the DES flow analysis, picking is represented by container dwell times in both manual and automated picking areas/workstations. Dwell times may be modeled using a probability distribution based on historical data. Dwell times can dictate how much capacity in each of the picking areas is being utilized. The faster the order picking rate, the lower the dwell time, and the more the throughput. Container dwell time, which measures the duration a container spends at a specific location within a warehouse, is a metric affecting the efficiency and productivity of FC operations. Dwell time information may be extracted from the WES scans using KNIME. The data may undergoes preprocessing, including outlier removal, non-zero value handling, and noise removal, to ensure reliability and quality. Descriptive statistics may be calculated to analyze dwell times within different periods of the day. Outliers may be detected and removed using z-testing using KNIME. A random sample of 100,000 data points may be selected from the preprocessed dataset (on KNIME) for distribution fitting using ExpertFit. The best-fitting distribution may be identified through statistical tests, enabling accurate simulation and analysis of dwell times within the DES model. FIG. 5B shows an example user interface 510 for distribution fitting using ExpertFit, according to some embodiments.

Production Reports for Historical Data: Approximately 10% of the input data for the DES engine may be obtained from production reports. These reports may provide historical trends for metrics like inter-mod travel recirculation and historical CPM (containers per minute). The data from these reports may help set model parameters and/or validate the simulation by comparing it with historical data.

After data is transformed and ready in the form of input for analysis, cost analysis workflow 504 may be performed to determine the net picking and replenishment cost per unit processed in the FC, segregated by storage configuration (“location type”).

Discrete event simulation (DES) is a popular optimization tool for warehouse operations. DES is a computer-based modeling and analysis technique that simulates real-world systems and processes. The DES model may be built using a programming language (e.g., C, C++, Java) and is designed to simulate the behavior of the system over time. In a DES model, a system is represented as a series of interconnected components or entities, such as machines, workers, and customers, which interact with each other over time. The model is typically run multiple times, with different input parameters and scenarios, to explore the impact of different conditions and decisions on system performance.

There are several advantages in using discrete event simulation in warehouse logistics. Discrete event simulation is an ideal technique for simulating FC operations because it allows for the modeling of complex systems as a series of discrete events, which closely matches the way that orders flow through a fulfillment center. Fulfillment centers are highly dynamic and complex operations that involve many different processes and interactions between various components, such as orders, products, workers, equipment, robotics, automation, and transportation systems. DES is well-suited to simulating these types of operations because it allows for the modeling of discrete events, such as order arrivals, product movements, equipment processing and worker actions, which occur at specific points in time. One of the key advantages of using DES for simulating fulfillment center operations is its ability to test out different scenarios and strategies without disrupting the real-world operations of an FC. Businesses can experiment with different process flows, equipment configurations, and staffing levels in a safe and controlled environment without risking any negative impacts on the actual operations.

Object-oriented programming (OOP) is a useful technique for warehouse DES as it allows for the modular design and implementation of simulation models, making it easier to represent and manage the complex interactions between different entities within a warehouse. In a warehouse simulation, OOP may be used to represent various entities within the system, such as products, containers, storage locations, workers, and equipment. Each entity may be represented as an object with its own set of properties and methods. For example, a product object may have properties, such as its weight and dimensions and methods such as move and store. Similarly, a storage location object may have properties such as capacity, occupancy, and methods such as add and remove. By representing entities as objects, OOP allows for greater modularity and flexibility, such as creation of new customer orders, products, and locations. OOP also allows for code reuse as objects flow through different areas of the FC. Also, OOP can help develop complex simulation models, as it can represent and manage the interactions between various entities within an FC. By encapsulating the behavior of each entity within its own object, the overall complexity of the simulation model is reduced, making it easier to understand and modify over time.

To build the DES (discrete-event simulation) model for the FC, detailed engineering computer-aided design (CAD) drawings may be used to replicate the system accurately. CAD drawings may be utilized to build and visualize infrastructure within the 3D simulation environment. Data collected during the ETL process may be used to populate key points within the model to build the logical model required for analysis. Specific controls and systems environments may be replicated within the DES model with abstracted logic that captures behaviors accurately. This may be performed with a combination of C++ programming and logical flows involving token processing units. The model may be stored on the configuration terminal where it can be run in a continuous experimentation loop to build inputs for the linear programming engine. The model may be updated automatically with the data provided through the ETL process and is maintained by users through the configuration terminal. Discrete event simulation model may be run (505) in iterations based on the input data, until optimal volume thresholds flowing through different forward pick location types that reduce cycle time is determined.

Automated warehouse operations, such as automated storage and retrieval systems (ASRS), conveyors, robotics, and other computerized systems, are modeled in the DES engine to the appropriate level of abstraction that captures the throughputs and constraints of the system accurately.

The DES simulation may model detailed mechanical parameters of a conveyance system, such as conveyor speeds, sizes, sections, spacing, accumulation behavior, and accurate WES controls logic-automated routing, merge logic, gridlock avoidance, lane prioritization, container re-routing based on lane full conditions, and jam detection. The following sections of the conveyance system may be captured in the simulation: conveyor section lengths, speeds, and accumulation behavior, photo-eye placement and block/clear timeouts, induction-automated and manual box-making process, routing merge logic, prioritization, recirculation gridlock avoidance, pick module in/out flow, take-away merges based on prioritization and flow diversion, pack merge logic and prioritization, pack station dwell times, and/or ship merge and sortation.

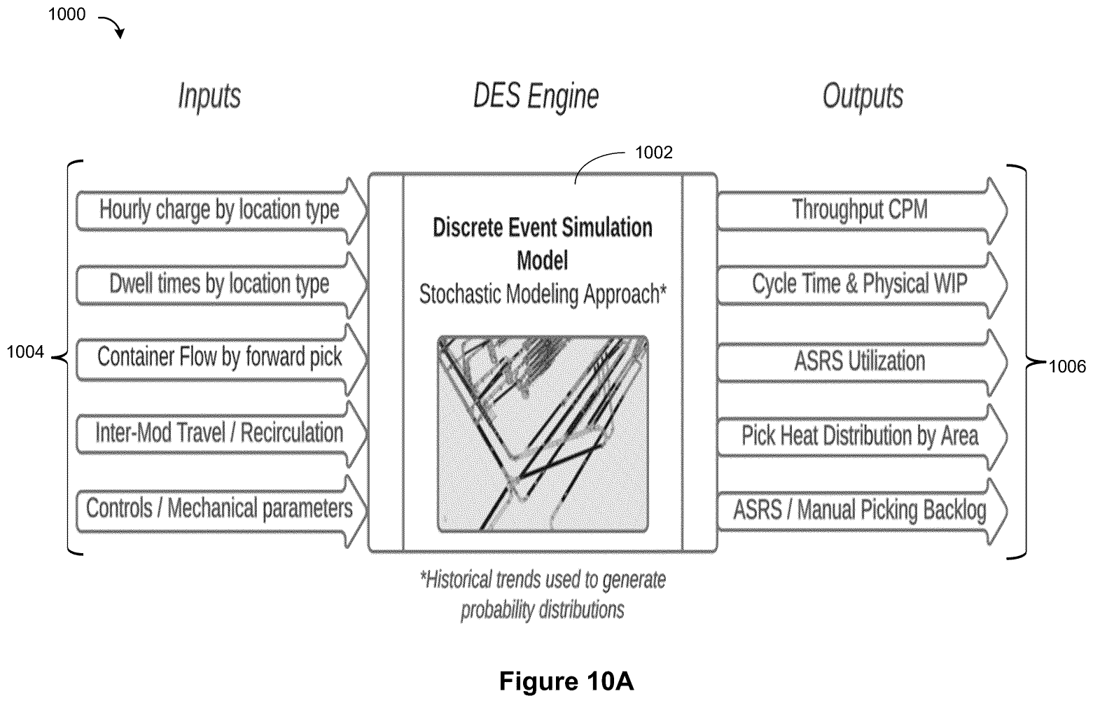

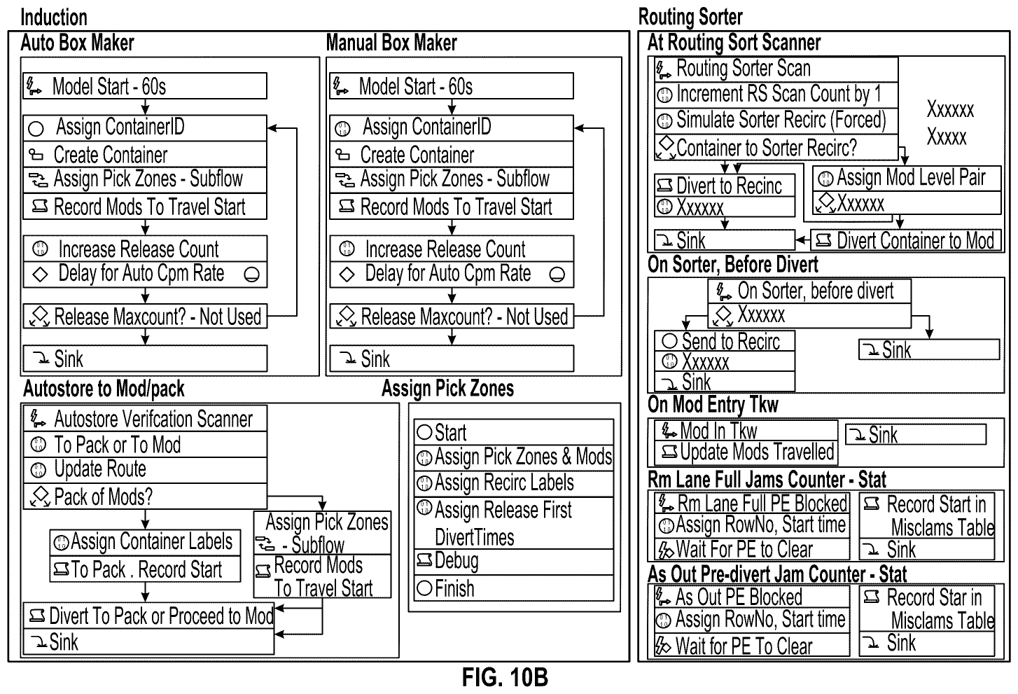

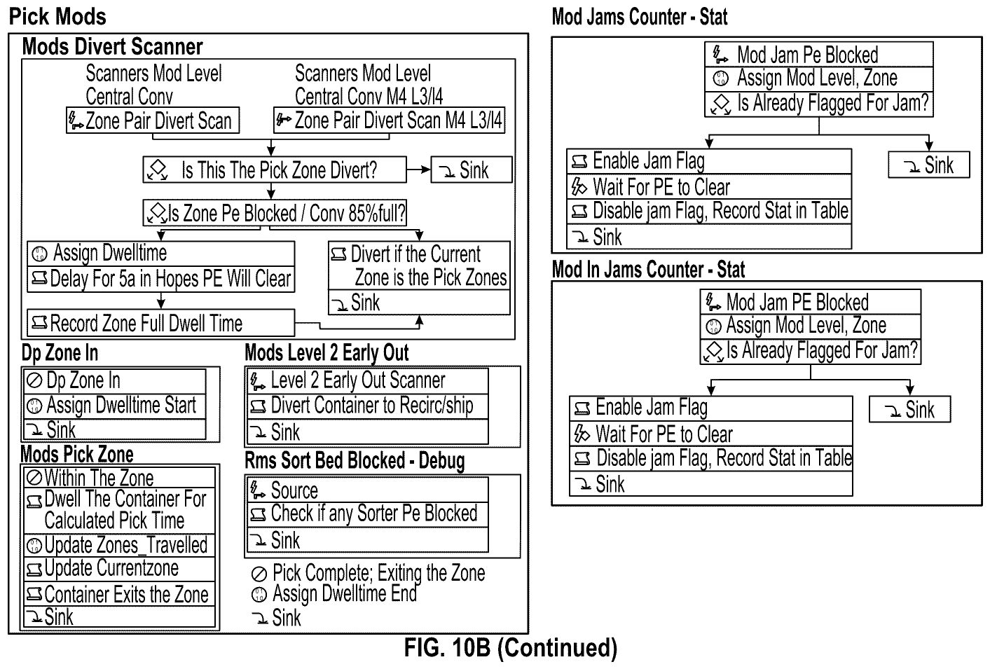

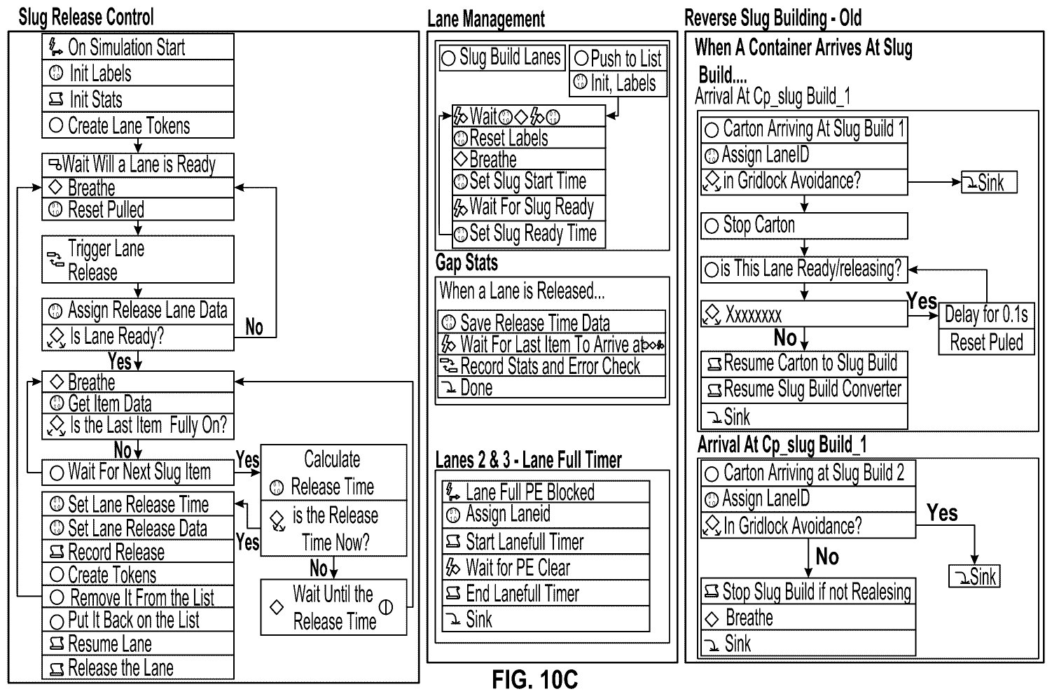

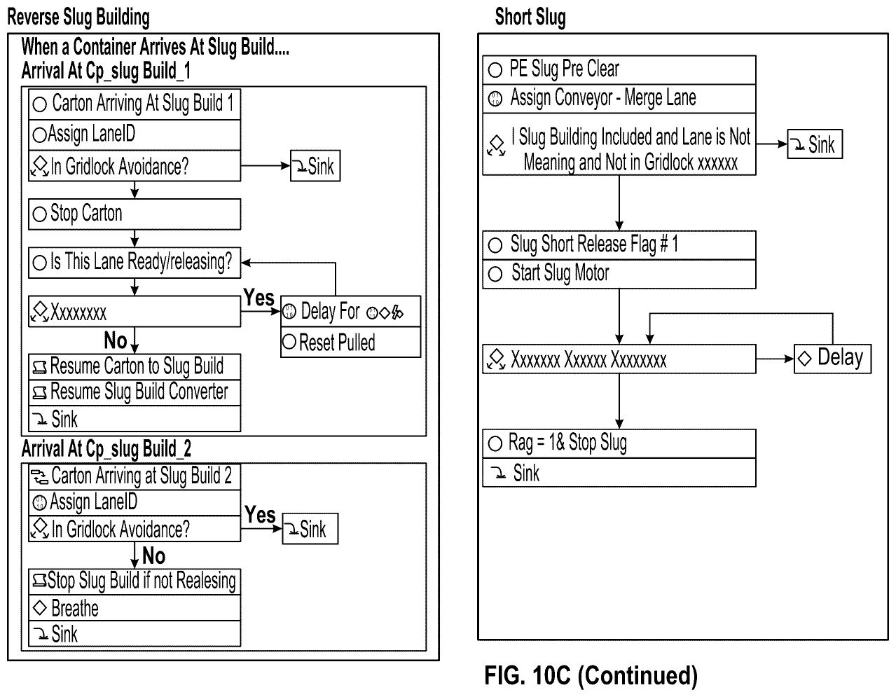

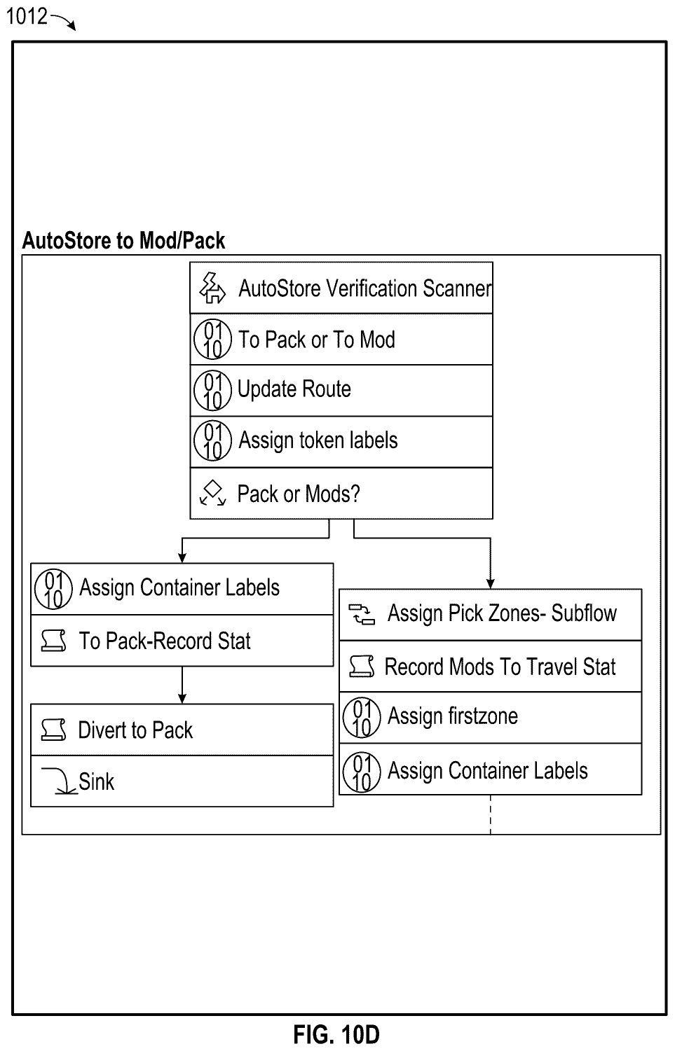

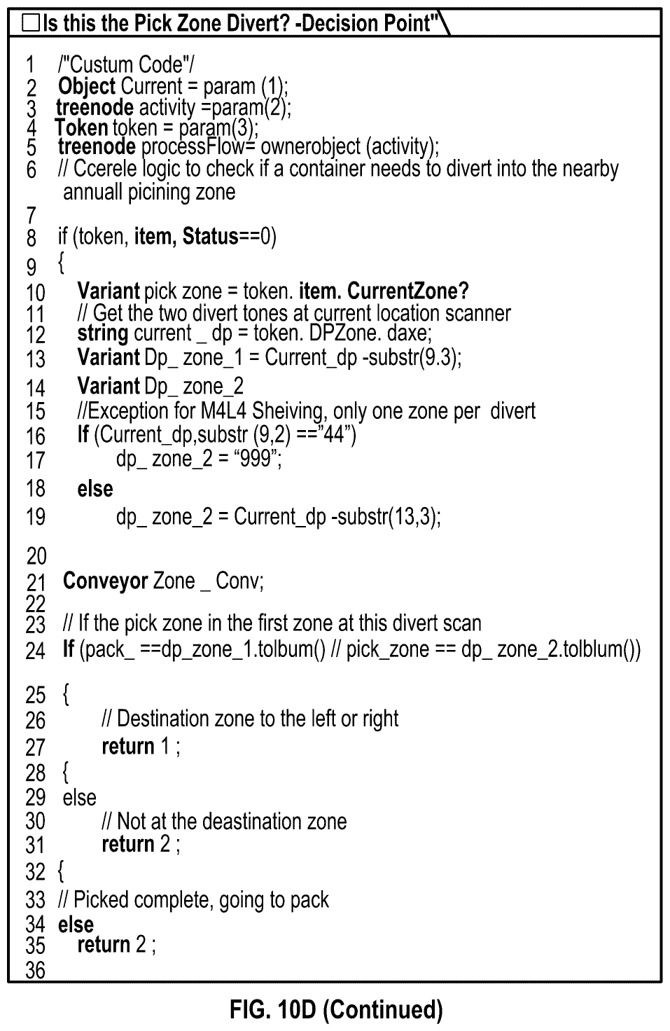

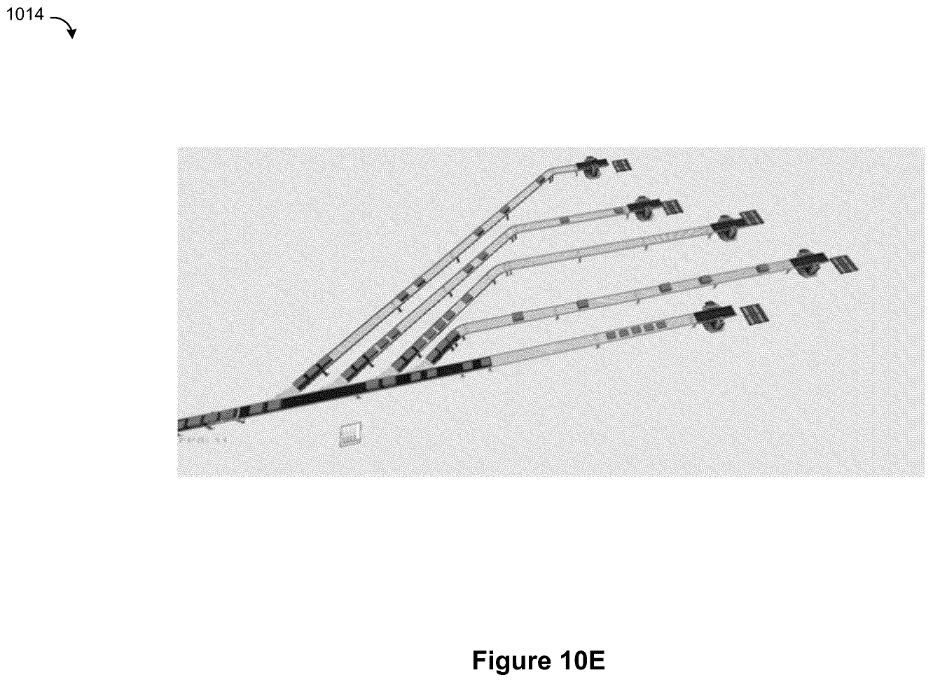

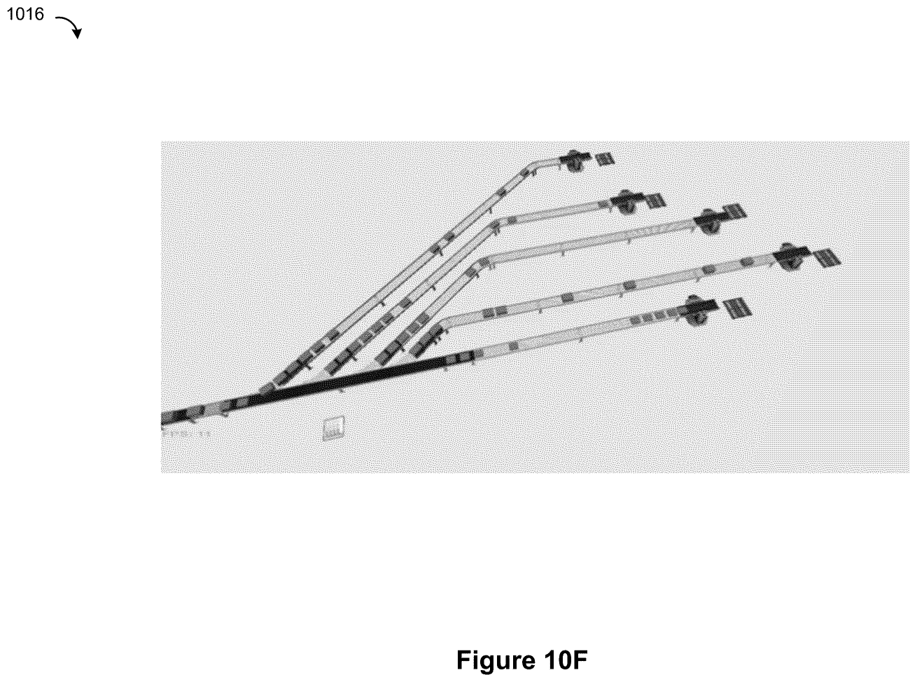

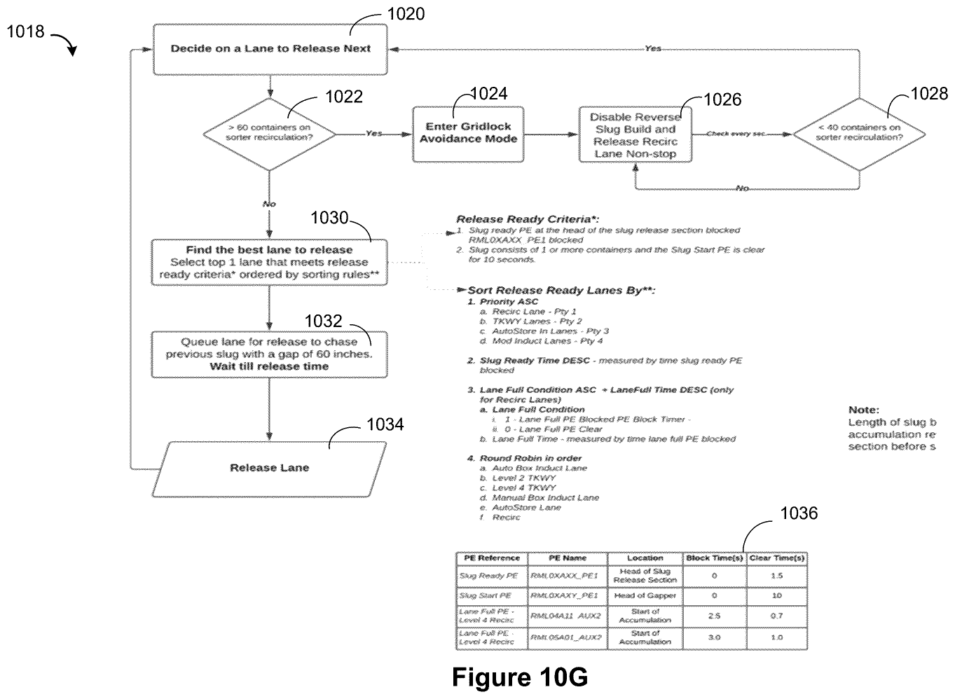

After the containers are placed onto the conveyance, the conveyor system may be replicated in the simulation to reflect real-world physical parameters, such as speed, size, and layout. The conveyor system may include control systems that route and direct containers to their next destination. These control systems may be represented through logic nodes within the simulation software, acting as decision points for containers (an example of which is described below in reference to FIG. 10D). Diverts, which are sections of the conveyance where containers are directed onto different paths, may be also represented virtually through these nodes. There may be three primary merge and sorters in the system: routing, pack, and ship sorters. These sorters merge containers from multiple conveyance pathways into a continuous loop. Containers can then move to other sections of conveyance to reach their next destination. Photo-eye sensors, which monitor jams, merger points, and blockages on the conveyance and sorters in the physical warehouse, may be replicated virtually in the simulation. These sensors detect objects' distance, absence, or presence using light transmitters and photoelectric receivers, and they may be crucial for accurate flow control within the simulation. FIGS. 10E and 10F described below provide an example 3D model overview of one of the merge points, according to some embodiments. FIG. 10G described below provides an example control logic flow that may impact system performance.

The warehouse management system (WMS) may be replicated within the simulation to accurately represent the workload and control systems of the actual warehouse. The hourly charge, which refers to the count of containers representing customer orders flowing into the WMS, is included in the model. Systems controls, such as safeguards and bottlenecks for directing and controlling container flow, also virtually represented before physical operations. Releases of containers may be based on the feedback loop, e.g., the number of containers released into the system is based on containers picked and capacity available in different warehouse areas.

Picking using the ASRS may be simulated as a black box system, where the output is emulated to match real-world operations, but the internal processes, such as bots moving items, are not simulated. Team members interact with the ASRS through picking ports, where items are presented in plastic totes. Team members pick items from the totes and place them into containers, marking the start of the simulation for ASRS processes. Once an item is placed into a container, the team member may push the container onto the conveyance. At this stage, the simulation checks if there is enough space on the conveyor for the containers to be pushed. If there is space, the team member completes the cycle with that container. If there is no space, the team member holds onto the container until space becomes available.

Simulating all possible combinations may be computationally expensive and time-consuming. By focusing on specific scenarios, computational resources can be utilized more efficiently, allowing for faster experimentation and analysis. Moreover, by stimulating specific scenarios that are relevant to real-world use cases, the practical implications of different automation and storage configurations can be better understood.

Specific scenarios explaining the mix may be provided. Some embodiments may provide visuals. Some embodiments may provide explanation of upper and lower bounds. Only practically possible scenarios of storage configuration charge mix may be considered. Practical scenarios may be defined by maximum limitation based on the maximum number of available forward pick locations for each storage configuration, the maximum number of pickers per pick zone (in manual picking), and/or the maximum available picking stations (in automated picking).

To align simulation experiments with the overall objective, input parameters may be modified for each scenario. The inputs may be classified as constants and variables. Constant parameters may be adjusted at the beginning of the simulation and remain constant throughout the experiment. Variable parameters, on the other hand, may be adjusted for each scenario of the simulation experiment and are essential to test the objective statement. Input types may include productivity parameters used to measure the efficiencies of the fulfillment center's operations, slotting parameters used to capture the macro-slotting decisions made throughout the FC forward picks, flow parameters used to determine how containers move through the system, considering both slotting and productivity parameters.

Example inputs for the simulation model and their classification are provided in the table below. Mods is the manual picking area with (RF, P2L and shelving location types) and AutoStore is the ASRS picking area.

| Input | Constant/Variable | Type | Definition/Impact |
|---|---|---|---|
| Target Ship | Variable | Productivity | For a given weekly volume target, |
| CPM | | | provides the required ship CPM target. |
| | | | Ship CPM = Weekly Volume/7.0/ |
| | | | Productive Hours/FC UPC |
| Productive | Constant | Productivity | Used to determine Ship CPM targets |
| Hours | | | based on weekly volume, assuming |
| | | | Operations productivity is measured by |
| | | | working hours. |
| Mods Dwell | Constant | Productivity | Simulates dwell time for picking |
| Times | | | operations in a zone on a container |
| | | | basis. Different dwell time distributions |
| | | | are modeled for each location type - |
| | | | RF, P2L, and Shelving. |
| AutoStore | Constant | Productivity | AutoStore picking rate used to simulate |
| UPH | | | container dwells at AutoStore Pick |
| | | | Ports. The simulation calculates |
| | | | AutoStore picking dwell by - |
| | | | [symbol] Avg. Dwell time (sec./container) = |
| | | | (3600 * AS UPC)/AS UPH |
| AutoStore | Variable | Slotting | % of containers starting at AutoStore |
| vs. Mods | | | vs. % of containers starting at Mods. |
| Start % | | | Determines containers for each |
| | | | processing path. This is a critical input |
| | | | for experimentation. |
| AutoStore | Constant | Slotting | % of containers that follow AS Only |
| Only % | | | process path. |
| AutoStore | Constant | Slotting | Units picked from AutoStore per |
| UPC | | | Container for all containers starting at |
| | | | AS. |
| Mods UPC | Constant | Slotting | Avg Units per Container per Zone for |
| per Zone | | | each location type (RF, AS, Shelving). |
| per | | | This is used to convert % unit charge |
| Location | | | into % container flow to each zone. |
| Type | | | |
| Unit Charge | Variable | Slotting | % of units charged to each location |
| % by | | | type. This is used to determine |
| Location | | | container flow to each zone based on |
| Type | | | location type. |
| | | | For varying AutoStore & Mods start %, |
| | | | we derive this by - |
| | | | AS Units = AS CPM * 60 * Productive |
| | | | Hours * AS UPC |
| | | | AS Unit Charge % = AS Units/Total |
| | | | FC Daily Units |
| Hourly | Constant | Flow | This is the hourly CPM charge pattern |
| Charge | | | by FC and by start location (AS vs. |
| Pattern | | | Mods). The input is represented as a |
| | | | fraction of the total 24 hours of charge. |
| | | | This is the rate at which containers are |
| | | | virtually inducted into the system. For |
| | | | Mods - pushed to Stamping bucket; for |
| | | | AS - pushed to AS Forecaster. |
| | | | Hourly charge for AS and Mods = |
| | | | hourly fractional * target ship CPM |
| Stamp and | Constant | Flow | This is the stamp max and release max |
| Release | | | setting per Mod Zone. Dictate the |
| Settings | | | number of containers that are stamped |
| | | | and released each cycle (every 30 |
| | | | seconds). |
| Box Size | Constant | Flow | This determines % of containers for |
| Distribution | | | each box type. Further, each container |
| | | | is inducted either via Auto Induct or |
| | | | Manual Induct based on box size. |
| Routing | Constant | Flow | This is the routing sorter % force |
| Sorter | | | induced into the system. Routing sorter |
| Recirc % | | | recirc occurs due to control issues such |
| | | | as no gap, jams, etc. which are |
| | | | simulated inherently. Rather, such |
| | | | instances are forced into the simulation, |
| | | | % of such instances given by this input. |
| Pure | Constant | Flow | This is pure inter-mod recirc % (pure |
| InterMod | | | means excluding zone full, sorter |
| Recirc % | | | recirc). Used to derive # of mods |
| | | | traveled distribution. |
| # of Mods | Constant | Flow | This decides the average number of |
| Travelled | | | mods traveled by containers. |
| Distribution | | | |
| Mods Heat | Constant | Flow | This decides the number of containers |
| Distribution | | | flowing into each mod for picks. |
| | | | Abstraction of pet category alignment |
| | | | and container heat. |
| # of Zones | Constant | Flow | This decides the average number of |
| Travelled | | | zones traveled by containers. |
| Distribution | | | Abstraction of affinity slotting and |
| | | | container heat. |

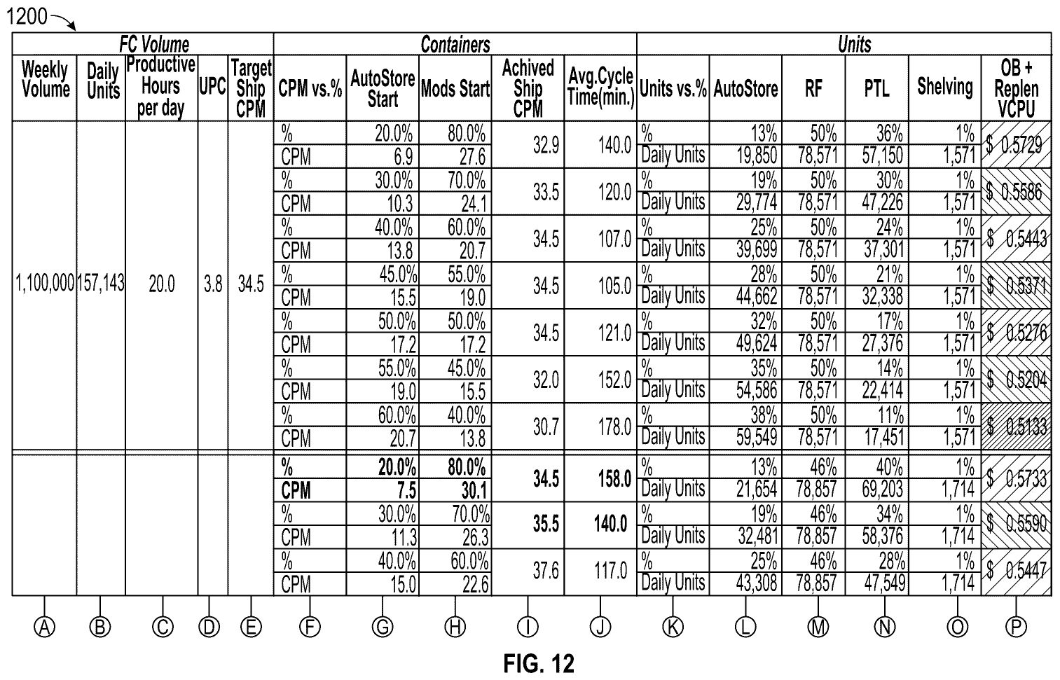

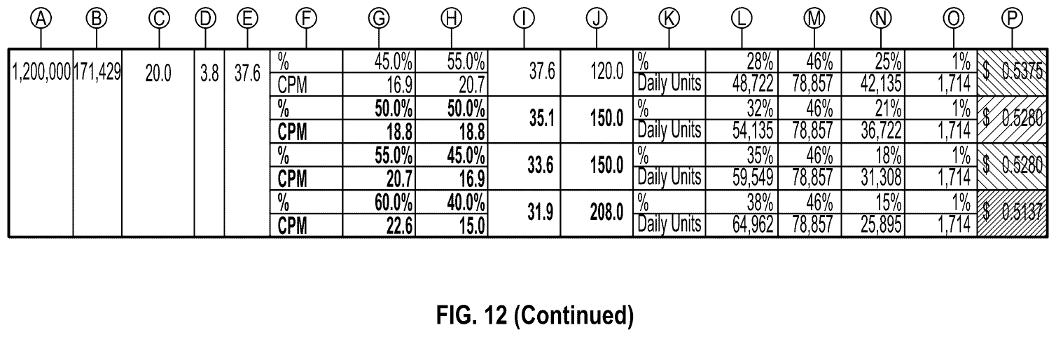

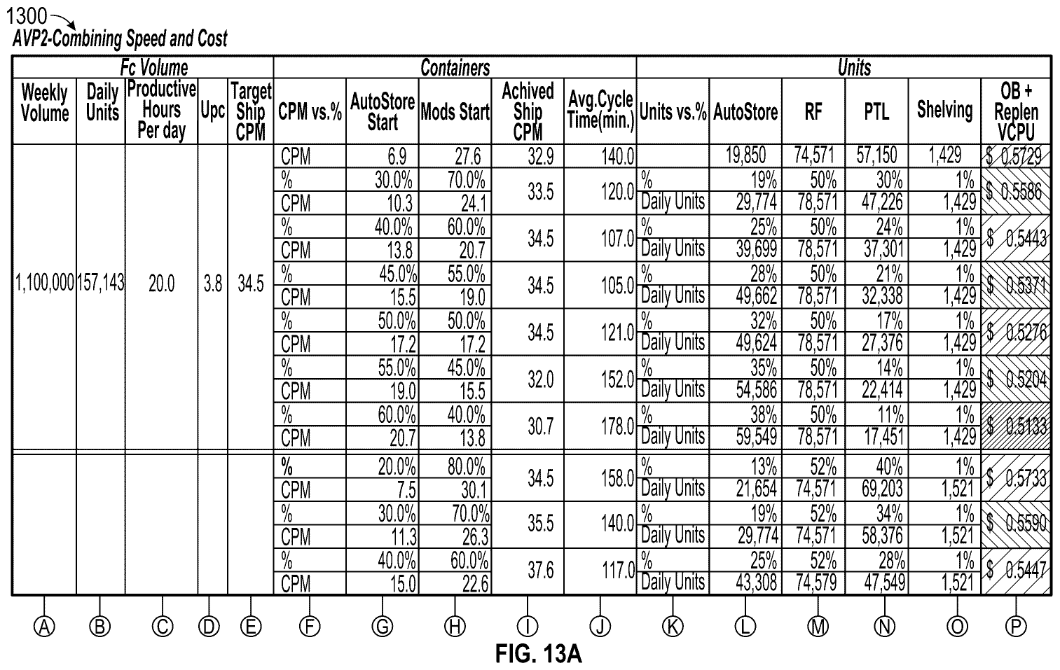

FIG. 12 shows a table 1200 for example simulation scenarios and results, according to some embodiments. In this example, weekly volume, container mix percentage between manual and ASRS picking, and unit charge percentage between storage configurations, are modified.

Referring back to FIG. 5, the output of cost analysis workflow 504 and the flow analysis using DES model 505 may be processed through a linear programming (LP) solver 506 to solve for an optimal cost solution. Linear programming is another optimization method that companies frequently utilize to enhance the performance of fulfillment centers. Linear programming provides a mathematical framework for optimizing warehouse resources, such as storage space, labor, and equipment, while satisfying operational constraints, such as capacity limitations and fulfillment speed. By formulating the warehouse optimization problem as a linear programming model, the objective function and constraints can be represented as linear equations and inequalities, making it possible to use well-established optimization algorithms such as simplex algorithm to find an optimal solution. Linear programming may be used to optimize warehouse operations, including the placement of products in the warehouse, routing of goods and pickers to minimize travel and scheduling of labor and equipment.

The LP engine may be based on the simplex method. Simplex linear optimization is an algorithmic approach for solving linear programming (LP) problems, which involve optimizing a linear objective function (cost) subject to a set of linear equality or inequality constraints. At each step, the simplex algorithm identifies the most promising direction for cost improvements bound by flow constraints, and continues to progress until no further improvement is possible, ultimately converging to the optimal vertex.

In some embodiments, the output of the linear programming solver is a recommendation 507 on optimal mix of volume through each forward pick storage configuration that minimizes cost and reduces fulfillment cycle time. This output may be written to a network data storage 508 from which operations team can execute on refining the slotting strategy to match optimal recommendations and plan daily operations around identified constraints.

### Example Process Architecture

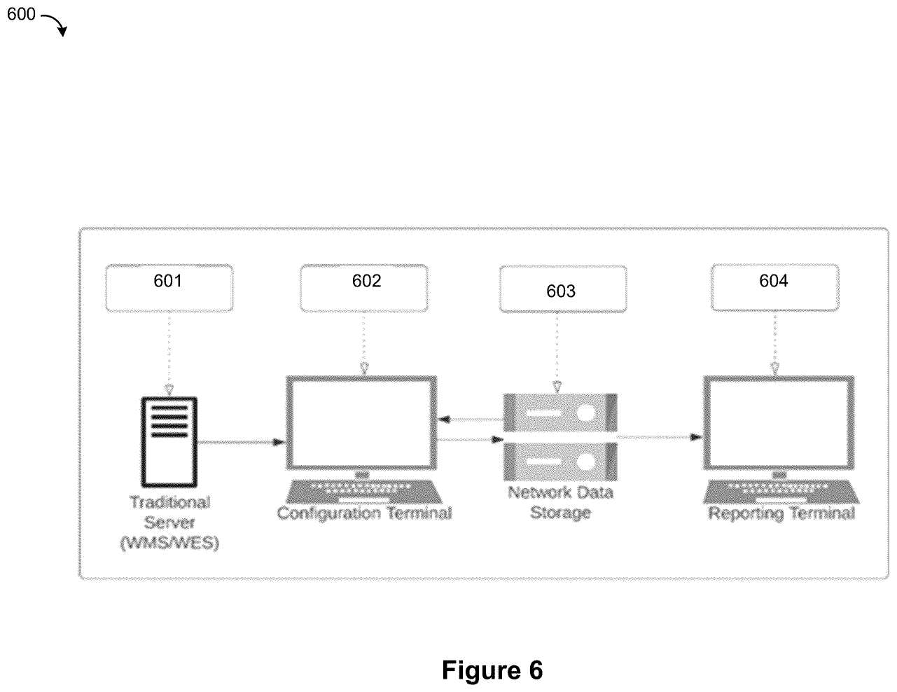

FIG. 6 shows an exemplary process architecture 600 for item placement for improving warehouse productivity, according to some embodiments. It does not imply any limitation regarding the environment in which different embodiments may be implemented. FIG. 6 represents an environment of physical and virtual nature in which the included illustrative embodiments may be implemented. A configuration terminal 602 may be the medium wherein users can maintain aspects of the workflow. The configuration terminal 602 may be connected to a data server 601 to extract historical WMS and WES data. Transformed data and output from configuration terminal may be stored in a network data storage 603 in the form of numbers, graphs, tables, and trends. Final output and actionable reports may be viewable by the operational users at a reporting terminal 604.

Example Extract and Transform-Item Slotting data and WMS Transactions

FIG. 7A shows a flowchart for an example process 700 for extract and transform, according to some embodiments. The flowchart corresponds to a workflow for analyzing costs and flow by utilizing item, slotting, and transactional data. In order to facilitate the analysis, it is necessary to obtain the required data from a WMS database. This process may begin by establishing a connection (702) to the WMS database through a configuration terminal, employing a data visualization tool.

After the connection to the WMS database is successfully established, a SQL query may be typically executed to retrieve (702) the item master details. The item master details may encompass comprehensive information regarding the items in question. Additional queries can be executed to extract specific item data from the database, including but not limited to current stock levels, location assignments, unit of measure, and any other pertinent item attributes.

To obtain detailed information about the slots within the warehouse, a slot query may be run. The slot query may fetch data pertaining to slot numbers, aisle locations, rack positions, and any other relevant slot attributes. This slot information may be used in the subsequent analysis.

Forward pick assignment details refer to the allocation of items to specific pick locations with the objective of enhancing order fulfillment efficiency. By querying the database, information such as assigned pick slots, quantities, and other pertinent details related to forward pick assignments can be retrieved.

To assess the flow of goods within the warehouse, transactional data concerning picking and replenishment activities may be obtained (706). In order to obtain this data, a query may be executed for each item and each forward pick location. The retrieved transactional picking data is utilized to calculate (708) the percentage of unit volume moved, commonly referred to as charge, through a specific forward pick location type.

The aforementioned data, comprising item details, slot information, forward pick assignment data, and transactional data, may be collected, segmented, and stored (710) within the network data storage. This storage system may provide a centralized repository where the data is readily available for subsequent analysis and evaluation of costs and flow.

### Example Extract and Transform-Input Data on Labor Hours and Cost

FIG. 7B shows a flowchart for an example process 712 for extract and transform, according to some embodiments. After connecting (714) to WMS database from a configuration terminal, in order to conduct cost analysis, some embodiments obtain (716) input data pertaining to labor hours spent working in various departments, specifically picking and replenishment since they can be associated with storage configurations (location types). To obtain the cost information related to labor hours, queries are executed on the WMS database to retrieve the specific cost data associated with each department. The queries focus on gathering the cost data specifically for picking and replenishment activities. Using the acquired labor hour data and the associated cost data, calculation (718) is performed to the aggregated wage rate (cost/hour). To perform cost analysis, input data on labor hours, i.e., hours spent working in different departments may be used. Then, cost associated with the labor hours by department may be queried, specifically for picking and replenishment. From the labor hours and associated cost, wage rate (cost/hour) may be calculated. The processed data may be stored (720) on the network data storage, ready for analysis. After the labor hour data, cost data, variable cost per unit, and wage rate have been processed and calculated, the resulting information may be stored within the network data storage.

### Example Extract and Transform-Input Data on Material Flow

FIG. 7C shows a flowchart for an example process 722 for extract and transform, according to some embodiments. After connecting (724) to WMS database from a configuration terminal, in order to obtain (726) relevant historical data regarding flow of material through the FC, the WES database may be queried. This historical data may be generated through the utilization of physical barcode scanners within the FC environment. Using the acquired container scans data, a detailed analysis (728) of throughput metrics may be performed. Throughput metrics, included but limited to number of containers processed per minute and the recirculation rate across different areas of the physical conveyance system, are calculated. By evaluating container throughput rates and recirculation patterns, limiting factors or bottlenecks in different areas of the FC can be identified. For scenarios where the system does not reach maximum throughput, there may be bottlenecks that throttle/restrict flow. Bottlenecks are chokepoints that restrict container flow due to operational or physical capacity limitations. Examples include picking capacity (operational bottleneck), routing merge capacity (e.g., 65 CPM maximum), and mods dwell times. This data serves as input for flow analysis to be performed using simulation, specifically noting trends of the chosen historical period. Upon completion of the analysis, the resulting data may be saved and/or stored (730) within the network data storage.

### Example Run Workflow for Cost Analysis

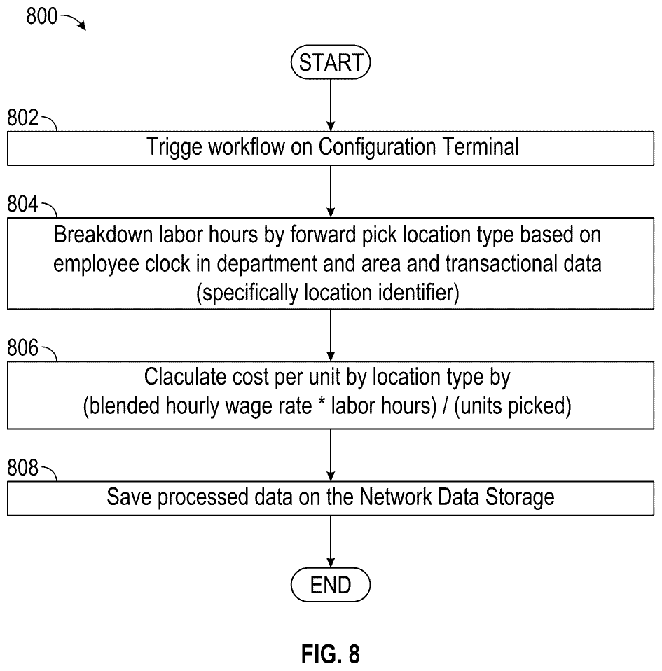

FIG. 8 shows a flowchart for an example workflow 800 for cost analysis, according to some embodiments. To perform cost analysis, a workflow may be triggered (802) on the configuration terminal. To analyze labor hours and cost, data from the example processes described above in reference to FIGS. 7A and 7B may be grouped by forward pick location type. This breakdown (804) may be achieved by utilizing employee clock-in records, department information, area specifications, and transactional data, specifically the location identifier. For example, replenishment labor hours may be broken down by employee clock-in identifier based on replenishment step involved. After the labor hour data is gathered and segmented by location type, calculations (806) may be performed to determine the cost per unit associated with each location type. This calculation may include multiplying the blended hourly wage rate by the labor hours dedicated to each location type and then dividing it by the total number of units picked within the respective location type. The resulting value may represent the cost per unit for that specific location type.

By associating labor costs with specific location types, it may become possible to evaluate the efficiency and cost-effectiveness of different pick locations and identify potential areas for optimization. After the labor hour breakdown and cost per unit calculations have been completed, the processed data may be stored (808) within the network data storage.

### Example Discrete Event Simulation for Flow Analysis

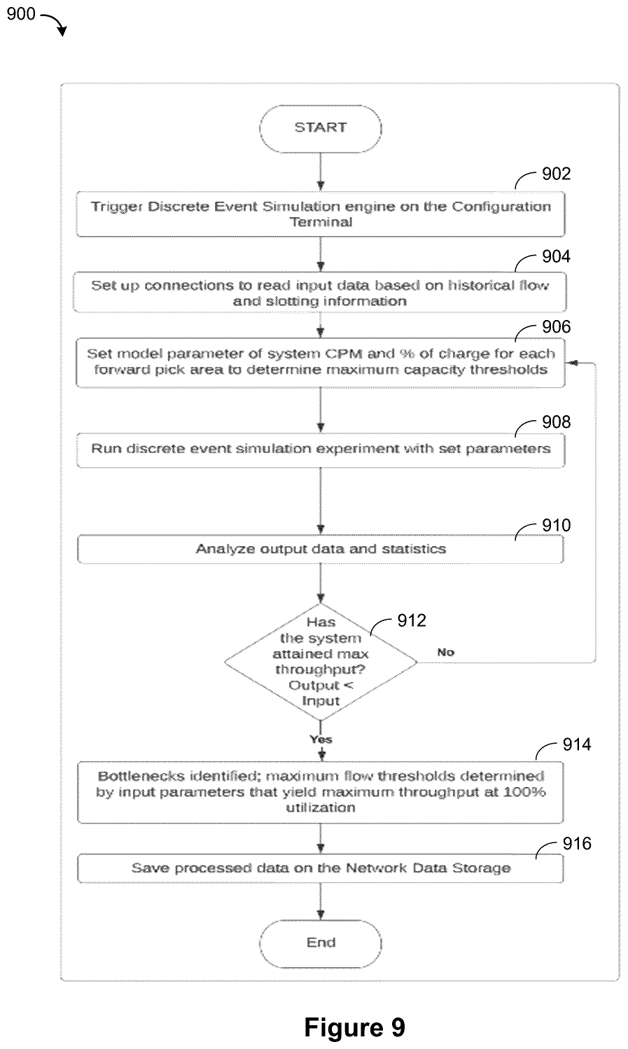

FIG. 9 is a flowchart for an example process 900 using discrete event simulation for flow analysis, according to some embodiments. To initiate the simulation process, the discrete event simulation engine may be triggered (902) on the configuration terminal. The discrete event simulation engine is responsible for generating and running discrete event simulation models. Various existing discrete event simulation engines can be utilized to implement engine, such as FlexSim, AnyLogic, Simio, AutoMod, and SimEvents. In order to set up the simulation, connection may be established (904) between simulation engine of the configuration terminal and network data storage to read input data based on historical flow and slotting information. This input data may be used for insights into past performance and warehouse configuration setting, enabling the simulation to model the system.

To determine maximum capacity thresholds through different forward pick location types, the simulation engine may set (906) two input parameters-target volume shipped, in terms of flow (containers per minute), and the percentage of charge for each forward pick area. These parameters may be used to define the behavior and constraints of the simulated system. The simulation experiment may be run (908) using the DES engine, based on the configured parameters to simulate the system's behavior over time.

Following the completion of the simulation experiment, the output data and associated statistics may be analyzed (910). Based on the analysis of the output data, an assessment may be made (912) to determine if the system has attained maximum throughput. This is evaluated by comparing the output data (system throughput) to the input data (target volume shipped). If the system has reached its maximum throughput, bottlenecks may be identified (914), and the maximum flow thresholds are determined based on the input parameters that yield optimal throughput at 100% utilization. If the system has not reached maximum throughput, the process may returns to step 906 to reassess and adjust the model parameters. The simulation experimentation may determine what mix of unit charge by location type/model parameter values can reach and cannot reach maximum throughput at a fixed weekly volume. Of the scenarios that do reach maximum throughput, the simulation experiments may help determine which one is optimal (least container cycle time). Scenarios and model parameter values highlighted in FIG. 12 are where the system may not reach maximum throughput. Unless the system is tested against unrealistic weekly volume (e.g., defined by greater than 1.5 million weekly units, limited purely by physical infrastructure), there is likely to be scenarios where the system reaches maximum throughput.

After the simulation analysis and optimization steps are completed, the processed data and simulation results may be saved (916) within the network data storage.

### Example Simulation Model

While cost analysis is helpful in deriving the optimal mix from a cost perspective, it may only provide a partial picture as it does not consider the mechanical capacities of the system. Flow analysis may be used to understand the systemic constraints and determine the maximum possible shipped volume out of each FC based on specified weekly volume targets. FIG. 10A is a schematic diagram of an example simulation engine 1000, according to some embodiments. A discrete event simulation model 1002 (e.g., a stochastic model) may be used for flow analysis as it may accurately abstract system dependencies and queuing behaviors, such as-backlog build-up, releasing and induction, picking and packing dwell times, ASRS and conveyance accumulation due to high routing sorter recirculation. The inputs 1004 to the DES model 1002 may include hourly charge by location type, dwell times by location type, container flow by forward pick, inter-mod travel or recirculation, and/or controls or mechanical parameters. The outputs 1006 from the DES model 1002 may include throughput CPM, cycle time and physical WIP, ASRS utilization, pick heat distribution by area, and/or ASRS or manual picking backlog. CPM is containers per minute (rate at which containers pass through parts of the system). Cycle time is the time between physical creation of a box and label to the completion of the container through the system (e.g., time when the container is placed on a truck for shipment). Physical work-in-progress (WIP) corresponds to containers that have been physically inducted into the system but not yet shipped. ASRS utilization corresponds to current throughput or maximum throughput capacity. ASRS utilization may be the attainable throughput of the ASRS against the actual output. Actual will be less than attainable. For example, if attainable throughput of the system is 10,000 units and actual is 8,000 units, the utilization is 80% of the ASRS throughput. Pick Heat Distribution may be percentage of pick units from different zones within the pick module picking area. Picking backlog refers to units of customer orders that have not yet been picked. Pick Heat Distribution may be the charge received by specific areas within the system. Each location type may have a specific pick heat distribution.

### Stochastic Modeling

Stochastic modeling is a modeling technique that may be used to represent and analyze systems that involve randomness, variability, and uncertainty. In a stochastic model, various factors within the system may be treated as random variables, and their values are determined probabilistically. This approach acknowledges that real-world systems are subject to inherent variability, and outcomes cannot be precisely predicted. Stochastic models are built on probability theory and statistical principles.

A stochastic model may be used in building simulation models for the following reasons:
Variability in Demand: FCs experience fluctuations in demand, with varying order sizes, arrival rates, and order patterns. Stochastic models can capture this variability by incorporating random variables, such as order arrival times and order quantities. By simulating different demand scenarios, the stochastic model helps assess the impact of demand fluctuations on the fulfillment center's performance, such as throughput, order processing times, and resource utilization.
Randomness in Processing Times: The time required to process orders within an FC can vary due to factors like item availability, picking efficiency, packing processes, and transportation times on conveyance. Stochastic models account for this randomness by incorporating random variables for processing times. By simulating different processing time distributions, the model can evaluate the impact on order fulfillment metrics and identify potential bottlenecks or areas for improvement.

Simulation runs may be automated using an experimenter tool that assists with random replications and automating multiple runs. This feature may be provided by DES engine providers that modelers can customize based on their need.

### Random Replications

Random replications refer to the repeated execution of a simulation model with different random seed values. Each replication represents an independent run of the simulation model, starting from a unique initial state due to the use of a distinct random seed. Random seeds may be used to initialize the random number generator within the simulation model. The random number generator may be responsible for generating random values used in various aspects of the simulation where stochastic modeling and probability distributions are used, such as flow management, dwell times, etc. The DES engine may assign a random seed value to each replication. This ensures that each replication may start with a different initial state, introducing randomness into the experiment.

By executing the simulation model multiple times with different random seed values, random replications may help capture the variability and assess the robustness of the system's behavior. This approach may provide a more accurate representation of the system's average performance, variability, and the likelihood of different outcomes. After conducting random replications, statistical analysis techniques may be applied, such as calculating average values, determining confidence intervals, identifying the variability of results, and exploring the probability distribution of different performance measures. To support random replications, model code (where probability distributions are sampled) may consider random streams. One example for random replications is sampling number of picking modules to travel, e.g., dempirical (NoOfMods_PDF, getstream (current)). The second parameter is the random stream. Another example is the sampling dwell time for a container in an RF location type zone (the fourth parameter is the random stream): beta (0.732368, 217.429872, 0.676542, 3.003460, getstream (current)).

The experimenter may allow users to perform random replications by running the simulation model multiple times with different sets of random input values. This feature is particularly useful when dealing with stochastic models, as it enables users to capture the variability and uncertainty inherent in the system. By running the simulation with random replications, users can obtain a range of results and analyze statistical measures such as mean, standard deviation, confidence intervals, or percentiles and get eliminate results based on chance or bias.

### Automation of Runs

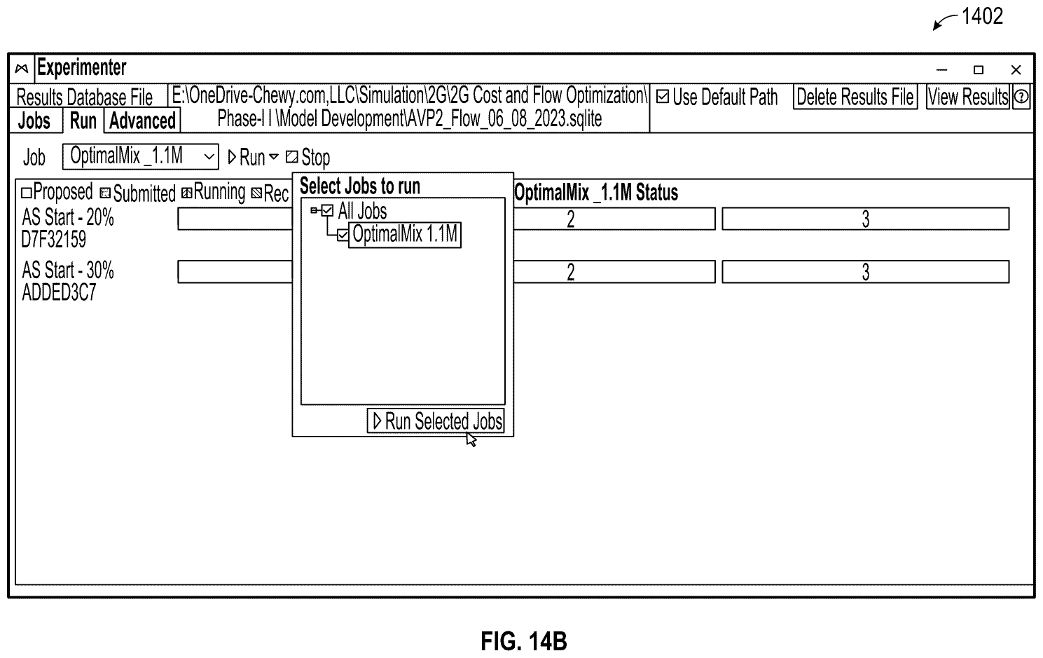

The experimenter feature may be used to automate the process of running multiple simulation experiments. Instead of manually configuring and executing each individual run, the modeler can define a set of experimental parameters and let DES engine automatically run the simulations. This saves time and effort, especially when dealing with a large number of simulation scenarios or conducting extensive sensitivity analyses. The experimenter feature within the DES engine may be used to automate the execution of simulation experiments. It allows setting up and defining parameters, their ranges or values, and the number of replications to be performed. Then, multiple replications of the simulation model can be run automatically as a batch. The experimenter collects the output data from each replication and organizes it for further analysis. FIG. 14A is an example graphical user interface 1400 for an experimenter job setup, according to some embodiments. FIG. 14B is an example graphical user interface 1402 for starting automated job runs, according to some embodiments.

Parameter Variation: The experimenter may allow users to define and vary input parameters systematically. A range or distribution for each parameter can be specified and let DES engine automatically generate random values within those ranges for each replication. This capability is valuable for conducting sensitivity analyses and studying the impact of different parameter settings on the simulation results.

Statistical Analysis: After the simulations are completed, the experimenter may provide built-in statistical analysis tools. It calculates summary statistics, generates charts and graphs, and performs hypothesis tests to analyze the results of the simulation experiments. This allows for drawing meaningful insights, identifying trends, and comparing scenarios.

The result from replications may be used to generate summary statistics (e.g., mean, median, minimum, maximum, standard deviation), perform hypothesis tests, calculate confidence intervals, and/or visualize the results through charts and graphs. This automated analysis helps validate the model behavior and draw meaningful conclusions from the experiment without the need for manual calculations.

FIG. 10B is a schematic diagram of an example process flow model 1008, according to some embodiments. The example shows models for induction, routing sorter, and pick mods. FIG. 10C is a schematic diagram of an example process flow model 1010, according to some embodiments. The example shows models for slug release control, lane management, reverse slug building old, reverse slug building, and short slug. Each block in the process flow may have corresponding code abstracting control logic. FIG. 10D shows an example process flow and code 1012 that abstracts WES control logic, according to some embodiments.

FIGS. 10E and 10F show a 5-to-1 merge example, according to some embodiments. The screenshot 1014 shown in FIG. 10E shows an earlier point in time in the process flow, and the screenshot 1016 shown in FIG. 10F shows a later point in time in the process flow. At merge points, there may be an initial backup, accumulation, or grid lock, then a merge control logic may be used to release lane for containers, as further described below in reference to FIG. 10G, according to some embodiments.

FIG. 10G shows a block diagram of an example method 1018 for lane release, according to some embodiments. The method 1018 may be performed by the system/modules 120, 130, and/or 132, described above in reference to FIG. 1, according to some embodiments. The method 1018 includes deciding (1020) on a lane to release next. The system/module may be configured to determine (1022) if there are more than a predetermined number of containers (e.g., sixty containers) on sorter recirculation. In accordance with the determination that the number of containers is more than the predetermined number, the system/module may enter (1024) gridlock avoidance mode and disable (1026) that may include reverse slug build and release recirculation lane non-stop. Gridlock avoidance mode may occur when too many containers are recirculating in the system, bringing the system to a halt. To resolve this, the control system may stop the reverse slug build process for all other lanes and start releasing recirculation lanes continuously. The system/module may be configured to determine (1028), in every second, if there are less than another predetermined number of containers (e.g., forty containers) on sorter recirculation then the system/module may return to step 1020; otherwise, the system/module may return to step 1026. In accordance with the determination that the number of containers is not more than the predetermined number (e.g., sixty), the system/module may identify (1030) the best lane to release by selecting top one lane that meets a release ready criteria ordered by sorting rules (examples of which are described below). The method 1018 may also include waiting (1032) till release time (e.g., queuing lane for release to chase previous slug with a gap of predetermined size, e.g., 60 inches) and releasing (1034) lane.

The method 1018 may also include summarizing (1036) sort release ready according to categories of preference, Photo-Eye (PE) name, location, block time, and clear time.

FIG. 10G provides an overview of an example control system logic that handles which lane to release next in a many-to-one merge-sortation system.

### Example Linear Programming Solver for Constraint-Based Optimization

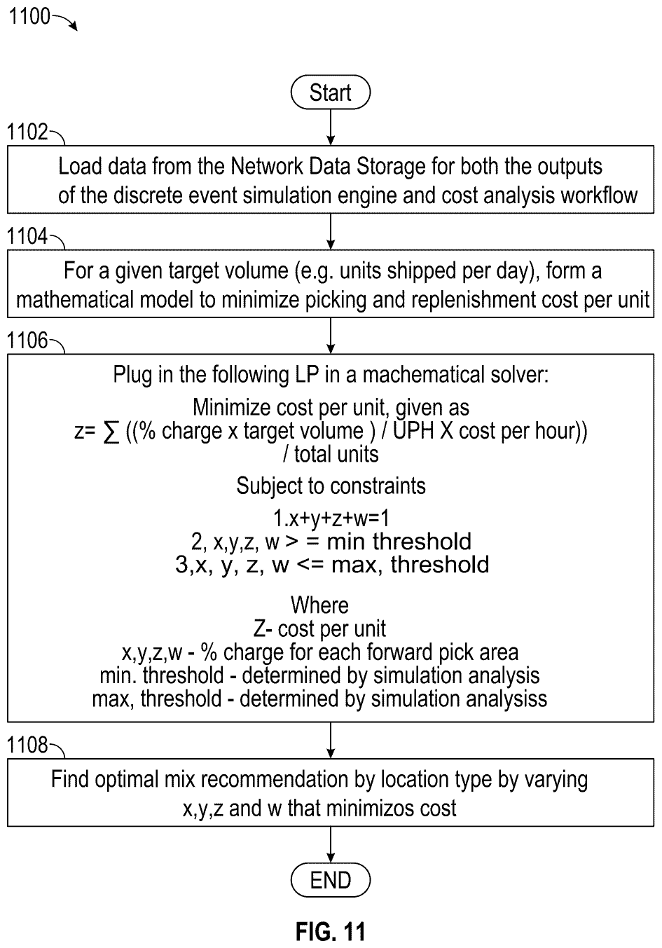

To combine cost and flow, outputs from the discrete event simulation workflow and the cost analysis workflow may be loaded from the network data storage. To optimize the picking and replenishment cost per unit for a given target volume, a mathematical model may be formulated. This model aims to minimize the cost per unit while meeting the specified target volume requirement. To solve the optimization problem, a linear programming (LP) formulation may be used. An example of the LP formulation is shown in the flowchart in FIG. 11 described below. The LP objective function may seek to minimize the cost per unit (represented as Z) by considering the charge percentage, target volume, unit per hour (UPH), and cost per hour. The LP formulation may be subject to various constraints specified in 206. The LP formulation may be then plugged into a mathematical solver to identify the optimal solution. The solver may consider the objective function, constraints, and the specified thresholds for each forward pick area. By varying the values of x, y, z, and w (representing the charge percentages for each forward pick area), the solver may identify the optimal mix recommendation that minimizes the cost.

FIG. 11 shows a flow chart of a method 1100 for an LP solver, according to some embodiments. The method 1100 may be performed by the module 208 described above in reference to FIG. 2, according to some embodiments. The method 1100 includes loading (1102) data from the network data storage for the output of the discrete event simulation engine and the cost analysis workflow. The method 1100 also includes, for a given target volume (e.g., units shipped per day), forming a mathematical model to minimize picking and replenishment cost per unit.

The method 1100 also includes plugging (1106) in a mathematical LP model in a mathematical solver. In some embodiments, the mathematical solver includes simplex method. The goal of solving the mathematical LP model may be to minimize cost per unit, which may be given as Z=Σ((% change×target volume)/UPH×cost per hour))/total units. Example constraints of the mathematical LP model include x+y+z+w=1, x, y, z, w≥minimum threshold, and x, y, z, w≤maximum threshold, where (1) z is cost per unit, (2) x, y, z, w is percentage charge for each forward pick area, respectively, and (3) minimum threshold and maximum threshold are determined by simulation analysis.

The method 1100 also includes finding (1108) an optimal mix recommendation by location type by varying x, y, z, and w that minimizes cost.

Another example for mathematical formulation for the LP solver is described herein, according to some embodiments. In some embodiments, inputs for deriving percentage of container flow by location type may include units per container (UPC) by location type per zone, average UPC per Mod zone, percentage of unit charge by location type with respect to total Mods units, and Mods in containers per minute (CPM). In some embodiments, percentage of unit charge by location type is calculated as Σ_{units by loc type}/Σ_{total units}, which is further equal to (CPM_{location type}×UPC_{location type})/(CPM_{total Mods}×UPC_{total Mods}), where unit charge per minute is CPM×UPC. In some embodiments, CPM_{location type} is calculated inversely as (percentage of unit charge_{location type}×CPM_{total Mods}×UPC_{total Mods})/UPC_{location type}. For instance, CPM of a location type of pick to light (P2L) can be calculated as

$$\frac{0.2 \; 89 \times 52.3 \times 1.29}{1.41} = 13.9 CPM ,$$

where percentage of unit charge_{location type}=0.289, CPM_{total Mods}=52.3, UPC_{total Mods}=1.29. Accordingly, the container flow of a location type of P2L is 13.9 CPM/52.3 CPM=26.6%. P2L is a light-directed picking technology and storage area. P2L may be a forward pick storage configuration within a fulfillment center.

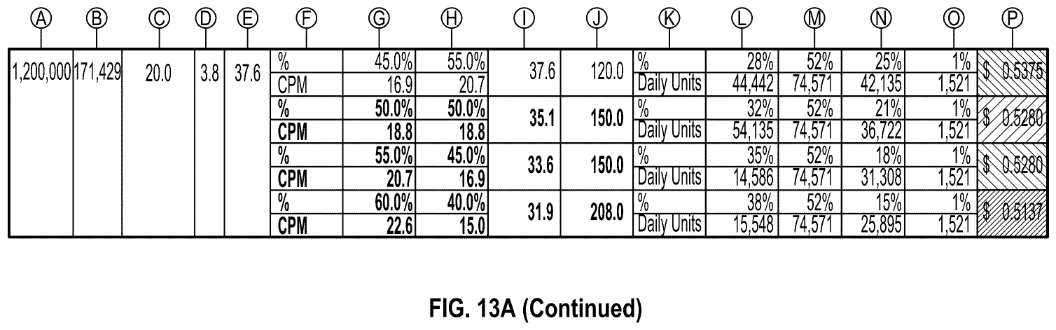

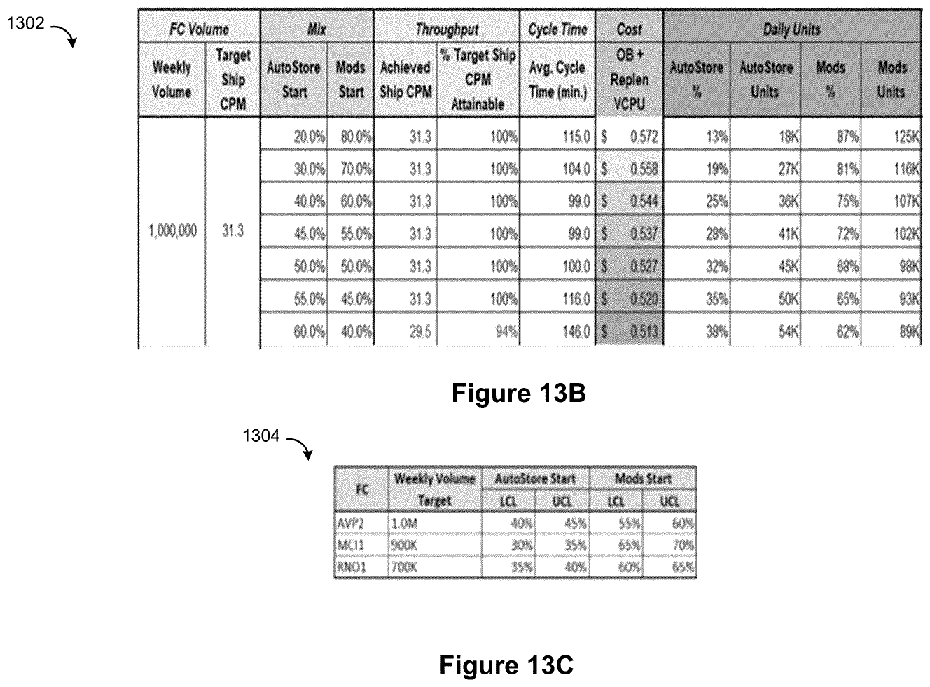

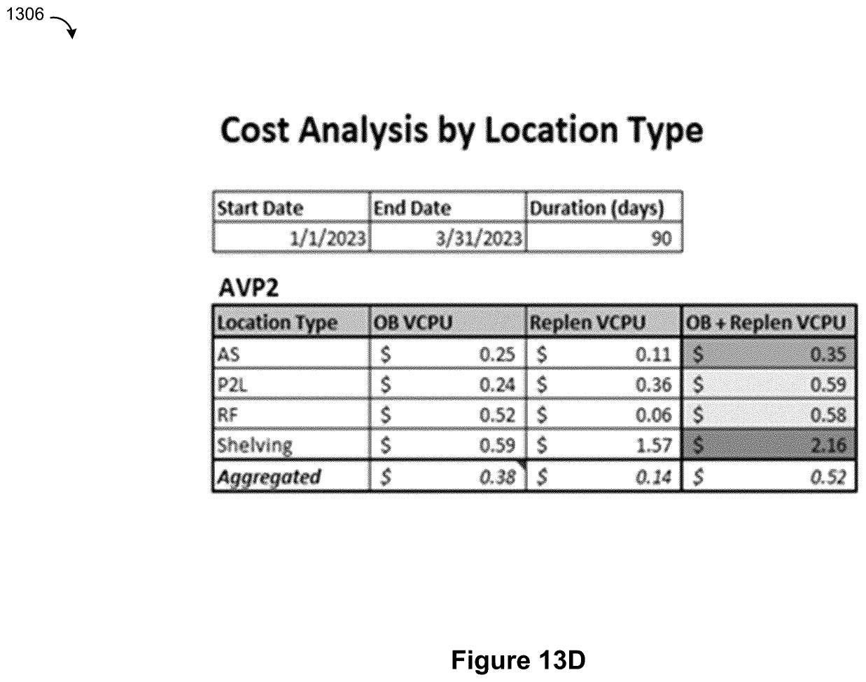

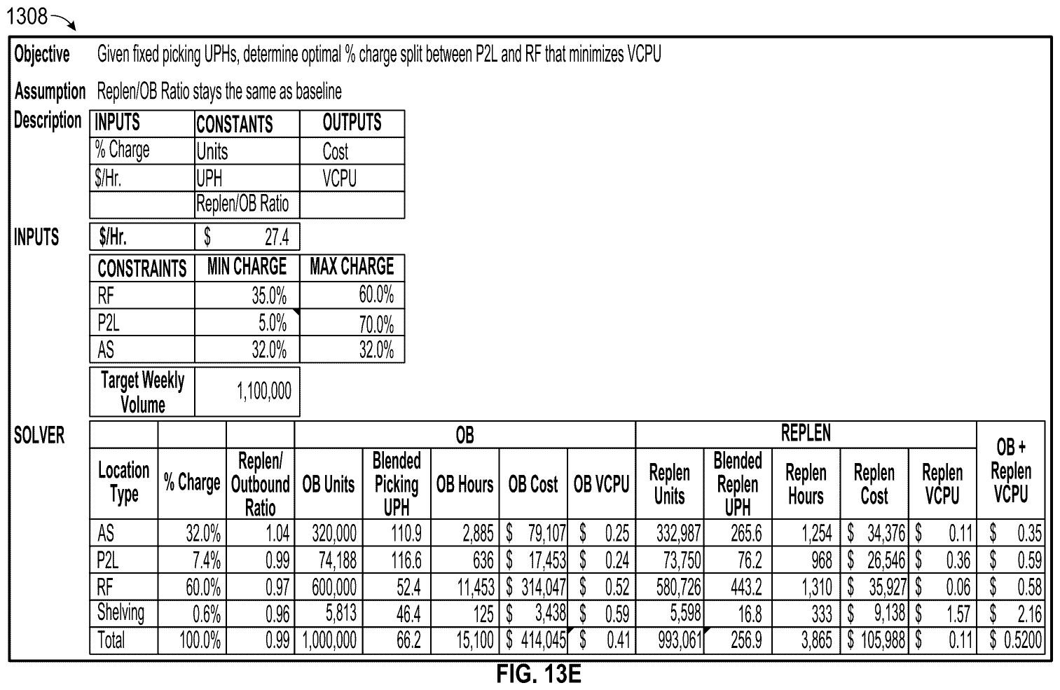

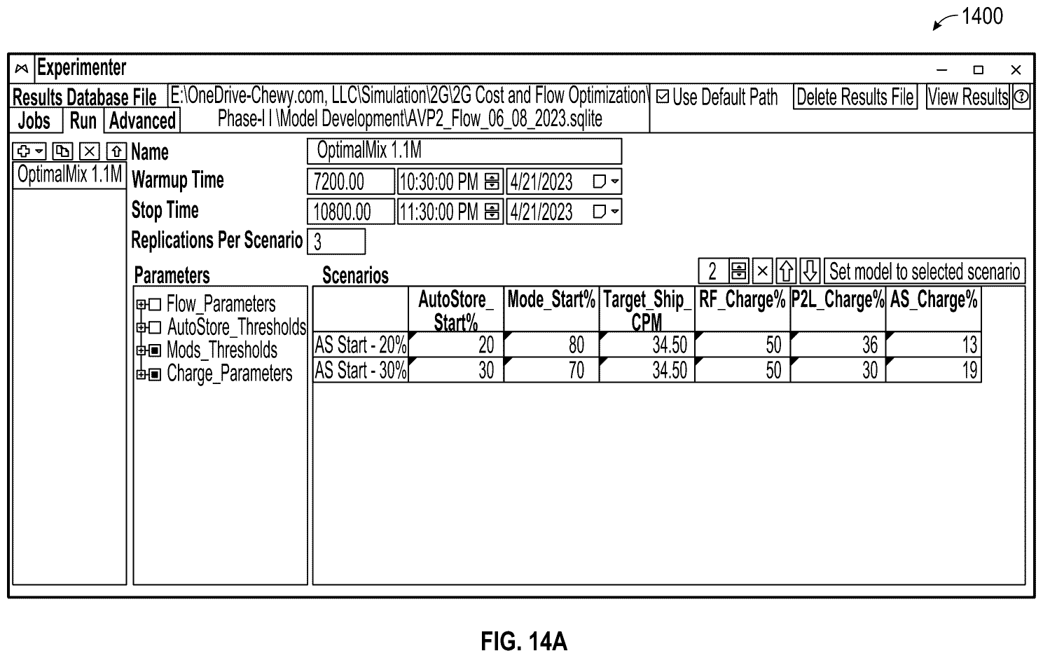

In accordance with some embodiments, a method executes at a computer system (e.g., the system described above in reference to FIGS. 1 and 2) having one or more processors and memory storing one or more programs configured for execution by the one or more processors. The system may be used for controlling item placement for managing warehouse productivity. The system may include one or more warehouse databases (e.g., the WMS database 134 and the WES database 138), and one or more processors. The one or more processors may be configured to interface with the one or more warehouse databases, extract, transform and load information (examples of which are described above in reference to FIGS. 7A-7C) from the one or more warehouse databases to form an input dataset, perform cost analysis (an example of which is described above in reference to FIG. 8) and discrete event simulation (an example of which is described above in reference to FIGS. 9 and 10A-10G) on the input dataset to obtain a candidate dataset, and generate a recommendation (examples of which are described above in reference to FIGS. 13A-13D) for an optimal mix of volume flow through different forward pick areas (optimal slotting) of a warehouse by applying a linear programming solver (an example is described above in reference to FIG. 11) on the candidate dataset.

In some embodiments, the system may automatically control, based on the recommendation, physical item placement in the warehouse. For example, as described above in reference to FIG. 1, the real-time monitoring 154 may include a user interface (156) to adjust volume and slotting, and/or a post-processor 158 to account for seasonality and demand volatility and to analyze historical performance. The system may cause automated storage and retrieval system robots to redistribute items between storage areas according to the recommendation. For example, as described above, ASRS is suitable for maximizing vertical space usage in the FC and minimizing the need for human intervention in the storage and retrieval process. Also, as described above, when a product is ready to be replenished into an ASRS an item (e.g., the item ‘183457’) may be moved (e.g., via a bot) into the ASRS. An ASRS system may be operated via an ASRS pick workstation, where users may interact with bots. Another example described above is a bot which may store and retrieve inventory in a 3D grid based on product demand and volume allocation.

In some embodiments, the system may adjust automated conveyor system routing and merge point controls to implement the recommended volume flow. For example, as described above, the DES simulation may model detailed mechanical parameters of a conveyance system, such as conveyor speeds, sizes, sections, spacing, accumulation behavior, and accurate WES controls logic (e.g., automated routing, merge logic, gridlock avoidance, lane prioritization, container re-routing based on lane full conditions, and jam detection).

In some embodiments, the system may dynamically adjust container release rates at merge points based on real-time monitoring of physical work-in-progress metrics to prevent system gridlock. Described above are examples of merge point control logic. At merge points, for instance, there may be an initial backup, accumulation, or grid lock, then a merge control logic may be used to release lane for containers. Further, gridlock avoidance mode may occur when too many containers are recirculating in the system, bringing the system to a halt. To resolve this, the control system may stop the reverse slug build process for all other lanes and start releasing recirculation lanes continuously.

In some embodiments, the system may continuously monitor container dwell times and physical work-in-progress at merge points, and automatically adjusts container routing and release timing to maintain the recommended optimal mix while preventing gridlock conditions in a physical conveyor system. Example details of monitoring conveyor system parameters, merge point control and gridlock avoidance, and real-time monitoring of flow and making adjustments are described above. Some embodiments may use a container dwell time, which measures the duration a container spends at a specific location within a warehouse. Container dwell time may affect the efficiency and productivity of FC operations.

In some embodiments, the information loaded from the one or more warehouse databases may include data regarding Stock Keeping Units (SKU), physical storage locations, physical conveyance parameters and automation specifications. WMS data may include descriptive data on SKUs, such as length, width, height, weight, volume movement, and item classification. Physical storage locations may be storage locations within the available storage configurations: all SKUs may be stored in one of the available types of locations. Data may be extracted for these physical locations, such as location type, location dimensions (length, width, height), physical SKU storage limitations, X coordinates, Y coordinates, and Z coordinates. Systems parameters may be extracted, and may include container releases, work in progress queues, zone capacity settings, zone volume limits, and container processing paths. Conveyance and automation parameters may be extracted from WES. These parameters may include container barcode scans, divert confirmations, conveyance speeds, downtime, flow metrics such as recirculation, and/or critical containers per minute (CPM). Source data from the extraction process may be then consolidated for the chosen time period.

In some embodiments, extracting information may include obtaining a list of items, slots and forward pick assignments by location type. Information related to slots may include data pertaining to slot numbers, aisle locations, rack positions, and any other relevant slot attributes, wherein information related to forward pick assignments include information on allocation of items to specific pick locations for enhancing order fulfillment efficiency.

In some embodiments, transforming the information may include cleaning, enriching, and manipulating data into a consistent format that meets format requirements of a discrete event simulation engine.

In some embodiments, loading the information may include transferring transformed data into a target network data storage system.

In some embodiments, performing discrete event simulation may include using a model representing a fulfillment center as a series of interconnected components or entities, including machines, workers, customers or combinations thereof, that interact with each other over time, as a series of discrete events that match how orders flow through the fulfillment center. The model may be run a plurality of iterations, with different input parameters and scenarios, to determine impact of different conditions and decisions on performance of the fulfillment center. Entities interact with the system through discrete events. Entities interact with other entities or components and trigger events that affect the system's behavior. By modeling entity interactions as discrete events, the simulation captures the dynamic nature of the system and enables the analysis of various aspects, such as system performance, resource utilization, bottlenecks, and other key metrics.

In some embodiments, the components may include orders, products, workers, equipment, robotics, automation, and transportation systems. The discrete events may include arrivals, product movements, equipment processing and worker actions, which occur at specific points in time.

In some embodiments, the model may include engineering computer-aided design (CAD) drawings that replicate infrastructure the fulfillment center. Data collected during the extract, transform and load may be used to populate key points within the model to build a logical model required for analysis.

In some embodiments, the model may be run continuously to build inputs for the linear programming solver.

In some embodiments, the model may be iteratively run based on the input dataset, until optimal volume thresholds flowing through different forward pick location types (that reduce cycle time) is determined.

In some embodiments, performing cost analysis may include determining net picking and replenishment cost per unit processed in a fulfillment center, segregated by storage configuration.

In some embodiments, performing cost analysis may include analyzing labor hours and cost, grouped by forward pick location type, utilizing employee clock-in records, department information, area specifications, transactional data or combinations thereof. For example, replenishment labor hours may be broken down by employee clock-in identifier based on replenishment step involved. After the labor hour data is gathered and segmented by location type, calculations may be performed to determine the cost per unit associated with each location type. This calculation may include multiplying the blended hourly wage rate by the labor hours dedicated to each location type and then dividing it by the total number of units picked within the respective location type. The resulting value may represent the cost per unit for that specific location type. By associating labor costs with specific location types, it is possible to evaluate the efficiency and cost-effectiveness of different pick locations and identify potential areas for optimization. After the labor hour breakdown and cost per unit calculations have been completed, the processed data may be stored within the network data storage described above.

In some embodiments, performing the discrete event simulation may include performing random replications by running a simulation model multiple times with different sets of random input values, to obtain a range of results and analyze statistical measures such as mean, standard deviation, confidence intervals, or percentiles and get eliminate results based on chance or bias.

In some embodiments, performing the discrete event simulation may include defining a set of experimental parameters for a discrete event simulation engine to automatically run simulations, including defining a range or distribution for each parameter and using the discrete event simulation engine to automatically generate random values within those ranges for each replication. This capability may be used to conduct sensitivity analyses and studying the impact of different parameter settings on the simulation results.

In some embodiments, performing the discrete event simulation may include representing picking by container dwell times in both manual and automated picking areas/workstations. Dwell times may be modeled using a probability distribution based on historical data. The dwell times indicate how much capacity in each picking area is being utilized. The faster the order picking rate, the lower the dwell time, and the more the throughput.

In some embodiments, the linear programming solver may be based on a Simplex method. Simplex linear is an algorithmic approach for solving linear programming (LP) problems, which involve optimizing a linear objective function (cost) subject to a set of linear equality or inequality constraints. At each step, the simplex algorithm may identify the most promising direction for cost improvements bound by flow constraints. The simplex algorithm may continue to progress until no further improvement is possible, ultimately converging to the optimal vertex.

In some embodiments, the linear programming solver may optimize picking and replenishment cost per unit for a given target volume, minimizes cost per unit while meeting a target volume requirement. The LP objective function may seek to minimize the cost per unit (represented as Z) by considering the charge percentage, target volume, unit per hour (UPH), and cost per hour. The LP formulation may be subject to various constraints, examples of which are described above in reference to FIG. 11. The LP formulation may be then plugged into a mathematical solver to identify the optimal solution. The solver may consider the objective function, constraints, and specified thresholds for each forward pick area. By varying the values of x, y, z, and w (representing the charge percentages for each forward pick area), the solver may identify the optimal mix recommendation that minimizes the cost.

In some embodiments, the one or more processors may be further configured to adjust item placement to align with recommended mix from different location types, continuously to reduce costs and improve cycle time.

In some embodiments, the one or more processors may be further configured to adapt to demand volatility by realigning item placement within a defined mix, including causing shifting items to more prominent locations, adjusting quantities based on demand forecasts, or accounting for new products allocated to a fulfillment center.

In some embodiments, the one or more processors may be further configured to generate a summary dashboard for real-time monitoring of fulfillment center slotting health, including listing open or unslotted location, charges by location type, and containers percentage with multi-mod (Module Order Distribution) travel.

In some embodiments, the one or more processors may be further configured to monitor fluctuations in volume of incoming units to a fulfillment center and implement adjustments to achieve a balanced distribution of workload (units to be picked) across various mods, levels, and zones.

In some embodiments, the one or more processors may be further configured to track metrics in real time, compare the metrics against predefined targets or benchmarks, and set up browser alerts or e-mail notifications based on thresholds being exceeded. Examples include (i) volume through ASRS drops below 45% or exceeds 50% of total fulfillment center containers (orders). The limits may be determined using flow analysis; and (ii) units picked (workload) across mods, levels, and/or zones is out of control limit compliance, where lower/upper control limits (lower control limit, upper control limit) are determined based on historical performance (mean+/−3 standard deviations).

In some embodiments, the one or more processors may be further configured to provide ongoing monitoring of benchmarked values pertaining to process path mix including an optimal number of units assigned to robots for picking tasks (ASRS) and an acceptable threshold that ensures uninterrupted flow during unit picking activities involving both robots (ASRS) and manual pickers.

In some embodiments, the one or more processors may be further configured to monitor week-over-week slotting performance metrics for each fulfillment center, analyze aggregated volume mix, heat mapping, identify improvement opportunities, and/or address constraints faced in achieving an optimal distribution of units between bot picking (ASRS) and manual picking activities.

In some embodiments, the one or more processors may be further configured to analyze distribution of orders across multiple MODs (Module Order Distribution).

In some embodiments, the one or more processors may be further configured to provide insights into number of containers fulfilled through inter-MOD travel, specifically within 1 MOD, 2 MODs, 3 MODs, and/or 4 MODs. These inter-MOD travel benchmarks may be established through simulation experiments, which consider several factors such as order composition (multi-product or single product), weekly volume targets, and available labor. The weekly volume targets may encompass a range of 900,000 units to 1.3 million units. This dashboard may assist the slotting team in understanding and optimizing the travel patterns of orders within the fulfillment center, which reduces recirculation and increases ship capacity of the system.

In some embodiments, the one or more processors may be further configured to adjust volume and mix across storage configurations by generating a locations user interface on a web portal that can be used to edit slotting parameters of forward pick locations.

In some embodiments, the workflow described above may be run on a fixed cadence (e.g., once every month) where historical data (e.g., past month) for FCs are used as inputs, and the outputs are used to derive and align slotting to match recommendations. Various real-time reports described above may be used to monitor, track and/or re-align slotting by location type to match optimal recommendations from this workflow. The re-alignment process may be performed continuously (e.g., on a daily basis) as the slotting may need to account for volatility in item demand and available inventory.

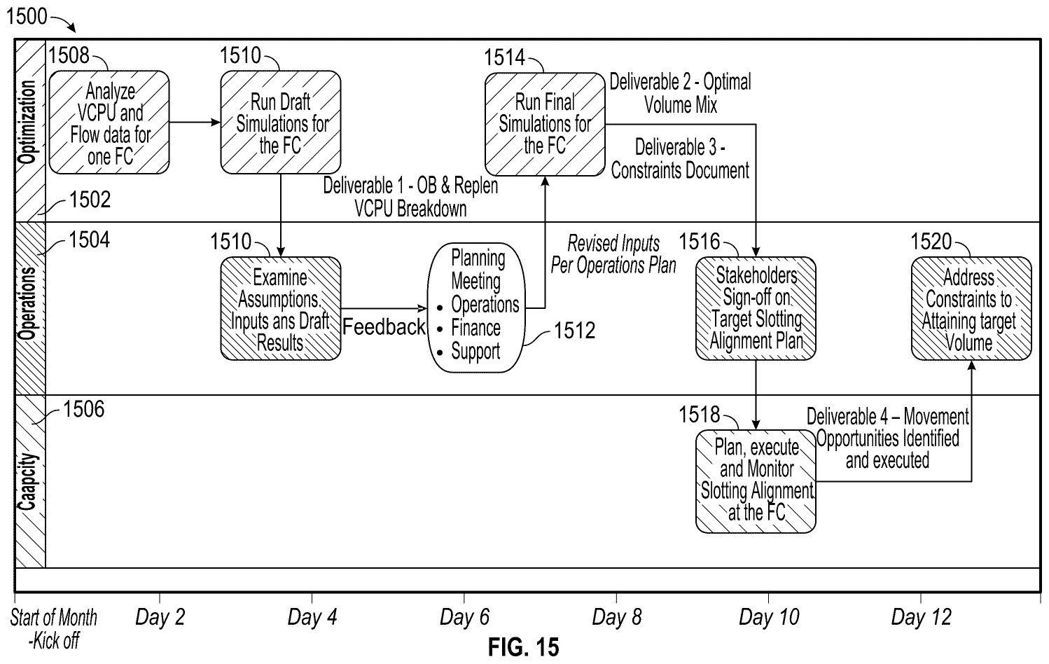

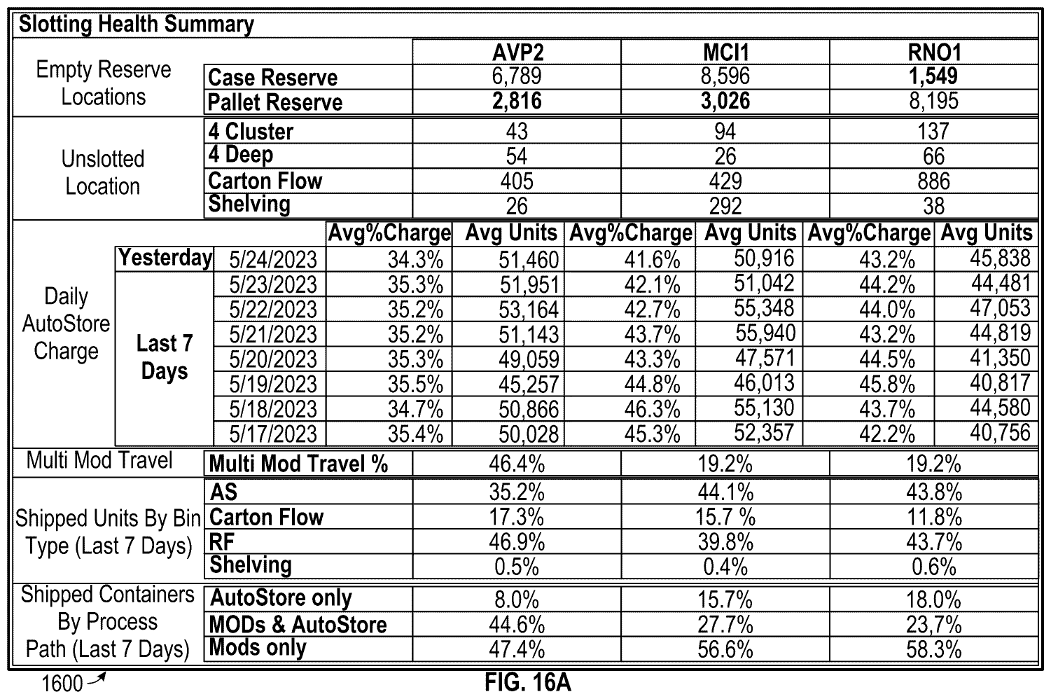

FIG. 15 is a schematic diagram of an example process 1500 for rerunning workflows, according to some embodiments. The process 1500 may be modeled as a pipeline as a function of time that includes a phase for optimization (1502), a phase for operations (1504), and a phase for capacity (1506). Between the kick-off date of two time periods (e.g., a month and day 2), variable cost per unit (VCPU) and flow data may be analyzed (1508) for one FC in the optimization phase 1508. VCPU may include labor cost. Labor costs may be tallied by specific pick areas. Between two days (e.g., day 2 and day 4), draft simulations may be run (1510) for the FC in the optimization phase 1502 and OB and replenishment VCPU breakdown, as deliverable 1, may be sent for examining (1510) assumptions, inputs and draft results in the operations phase. Between another two days (e.g., day 4 and day 6), the feedback including assumptions, inputs and draft results may be further sent for planning (1512) meetings for operations, finance, and support in the operations phase 1504. Between yet another pair of days (e.g., day 6 and day 8), the revised inputs per operations plan may be sent to the optimization phase 1502 for running (1514) final simulation for the FC, which may generate an optical volume mix as deliverable 2 and a constraints document as deliverable 3. On another day (e.g., day 10), deliverable 2 and deliverable 3 may be sent to the operations phase 1504 where stakeholders sign-off (1516) on target slotting alignment plan. In some embodiments, this operation may be automatically performed by the system, instead of or in addition to manual oversight. After the sign-off, slotting alignment may be planned, executed, and/or monitored (1518) at the FC in the capacity phase 1506, which creates deliverable 4 including movement opportunities may be identified and executed. Subsequently (e.g., after day 12), deliverable 4 may be used as input of the operations phase 1504 for addressing (1520)) constraints to attaining target volume.

When making slotting decisions to account for growth rates, seasonality, and demand volatility, several aspects of the workflow and models may come into play. For example, historical data may be used to understand past trends and patterns in growth rates, seasonality, and demand volatility. By taking historical data, such as outbound volume, units per container, and picking rates, as input parameters, some embodiments may account for seasonality and systemic variability. Some embodiments may use varying tiers of weekly volume parameter. For example, to account for growth rates and seasonality, varying tiers of weekly volume and target ship CPM parameters may be used in the flow analysis. These parameters may provide a future outlook with volume ramp-up at each FC. The targets may be set based on long-term planning with finance and operations teams. To address high demand volatility, slotting decisions may require daily re-alignment for a small percentage of items. Demand volatility refers to sudden fluctuations in customer demand, which can be influenced by various factors such as promotions, market trends, or unexpected events. To manage these fluctuations, the slotting may need to constantly monitor and analyze real-time data, and adjust the item placement to align with recommended mix from different location types as best as possible. This may be a continual process to reduce costs and improve cycle time. Despite demand volatility, a goal may be to achieve an optimal mix of volume flowing through each forward pick location type that reduces cost and improves cycle time. While the optimal mix might change when the workflow is run on a monthly basis, the slotting may need to adapt to demand volatility by realigning item placement within the defined mix. This realignment may involve shifting items to more prominent locations, adjusting quantities based on demand forecasts, or even accounting for new products allocated to FCs. In some embodiments, the workflows described above may be re-run at a fixed cadence (e.g., once per month). FIG. 15 described above provides an overview of an example timeline for monthly runs from a project management perspective.

### Example Output, Reports and Visualizations

FIG. 13A is an example optimal mix recommendation 1300, according to some embodiments. The example combines speed and cost for an FC (AVP2). FIG. 13B is an example high-level report 1302 for the optimal mix recommendation, according to some embodiments. The row highlighted in red shows the mix where the system fails to meet the expected throughput rate/target ship CPM. This is an non-feasible mix and should be avoided. FIG. 13C shows an example recommendation 1304 for a recommended mix between ASRS picking and manual picking start percentage, according to some embodiments. The columns indicate fulfillment center (FC), weekly volume target (the number of units the FC is expected to ship every week), auto-store/mods start that includes percentage of containers that are inducted in the ASRS versus manual picking area. LCL stands for lower control limit, and UCL stands for upper control limit. FIG. 13D shows an example cost analysis output 1306, according to some embodiments. The first table shows the timeframe and duration of the analysis. The second table compares the cost (VCPU) by location type. AS refers to auto-store, P2L refers to pick to light, RF refers to radio frequency pallet picking, and shelving includes bin shelves. These are the location types in a fulfillment center. OB VCPU refers to outbound variable cost of picking a unit through a location type. Replen VCPU refers to replenishment cost per unit.

FIG. 13E shows an example LP solver 1308 tying cost and flow, according to some embodiments. Units per hour (UPH) is a measure of human productivity. The measure the units picked may be compared with the labor hours used. So if a picker picks 100 units over 2 hours, they would have a UPH of 50. P2L refers to pick to light, which is a light-directed picking technology and storage area. This may be one of the forward pick storage configurations within a fulfillment center. An objective may be, for fixed picking UPHs, to determine optimal percentage charge percentage split between P2L and RF that minimizes VCPU. It may be assumed that replenishment versus outbound ration stays the same as baseline. The inputs may be shipment per hour cost, and constraints may be minimum to maximum charge for RF, P2L, and AS, and a target weekly volume.

Some embodiments may use automatically generated output or report to monitor and/or alter live operations within an FC. A capacity summary dashboard, slotting tolerance dashboards, recirculation report, unpickable visibility, and/or process path mix may provide real-time monitoring of key performance indicators (KPIs) and metrics relevant to the business and are useful for tracking slotting alignment.

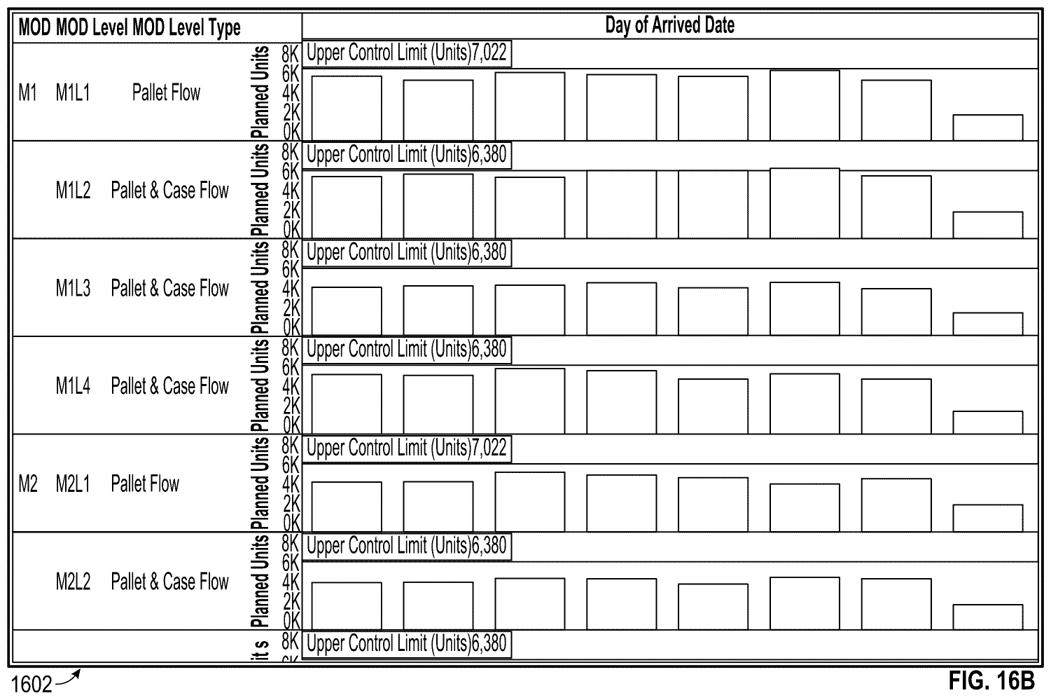

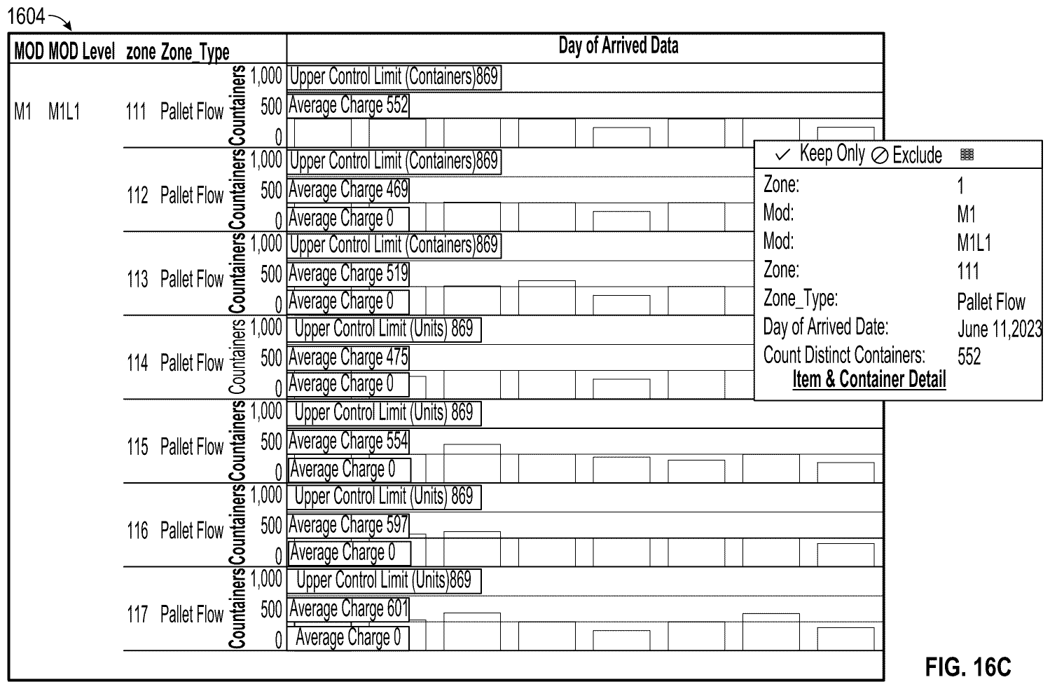

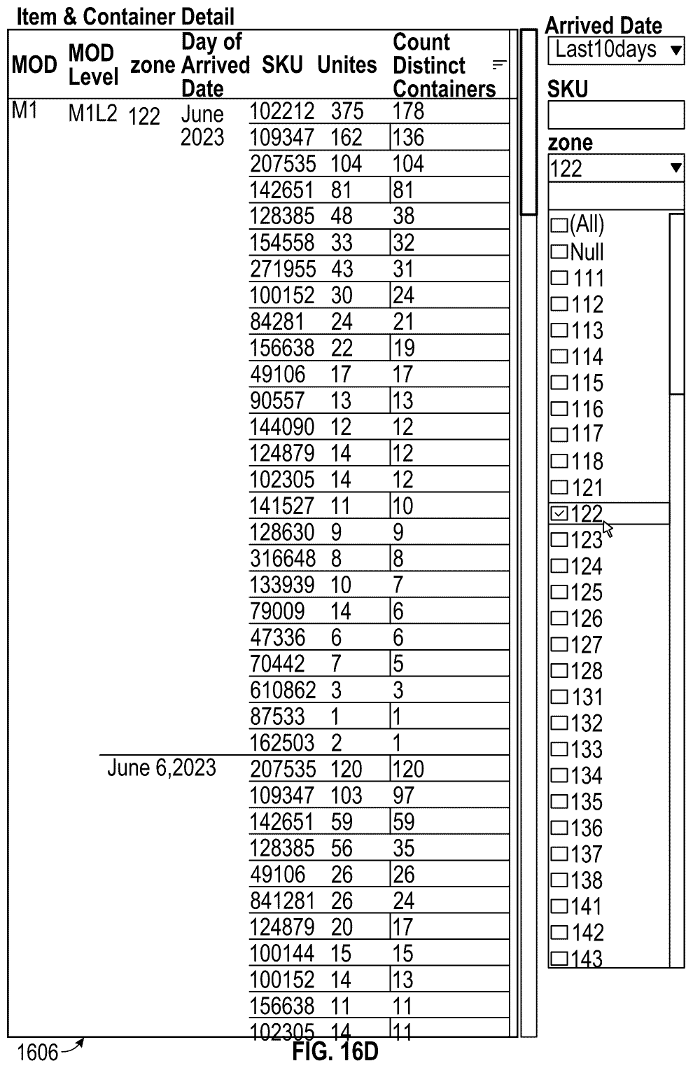

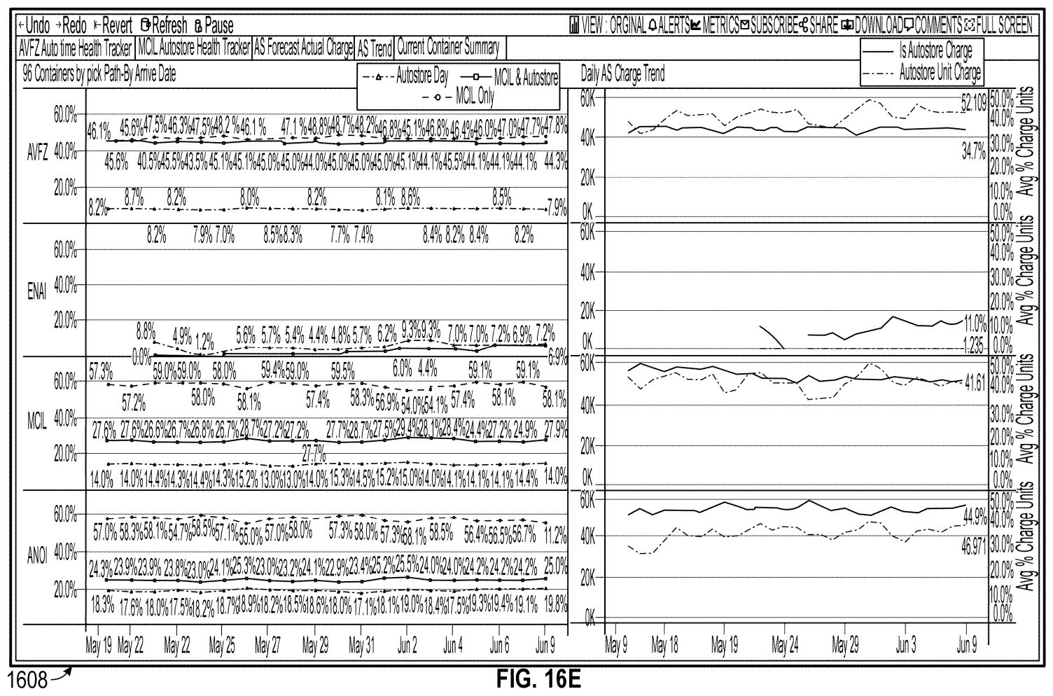

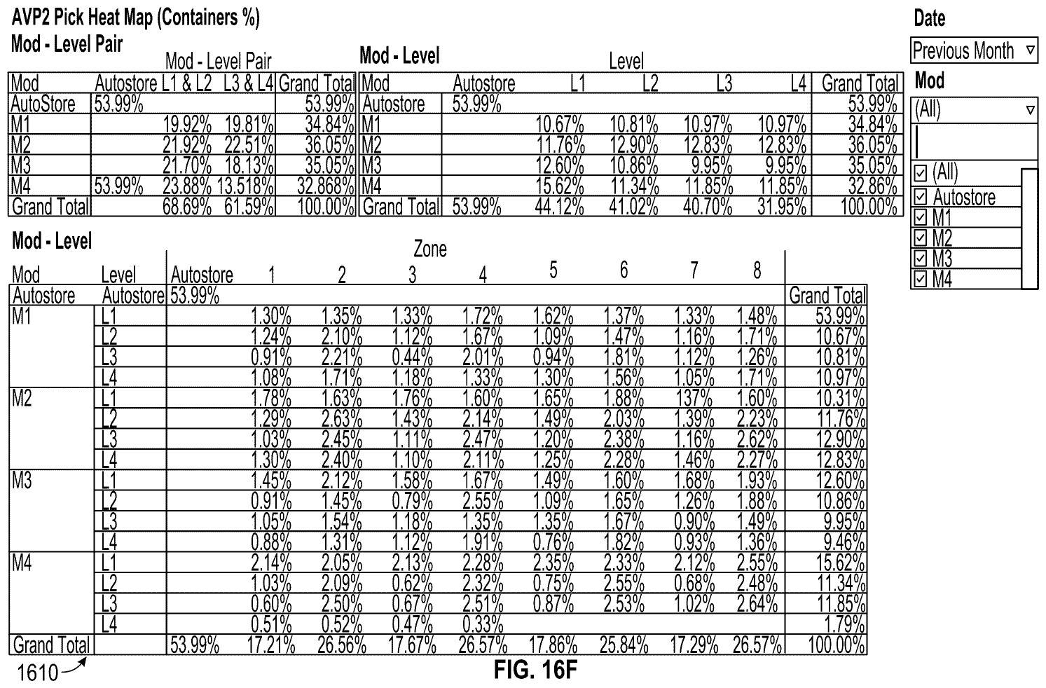

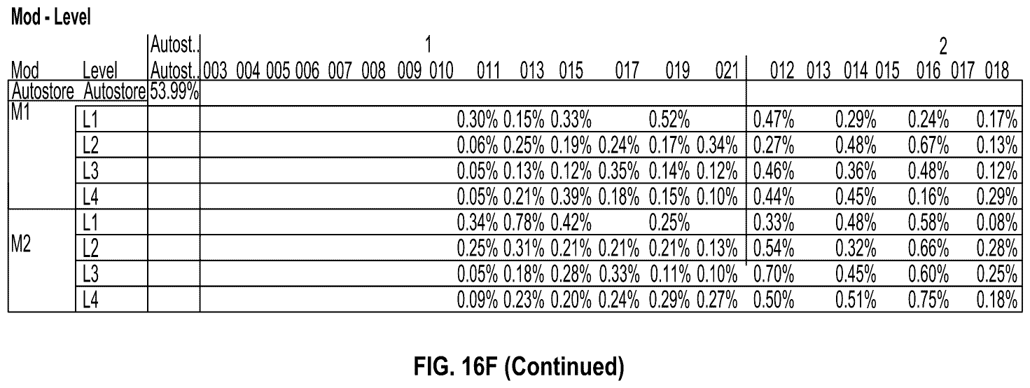

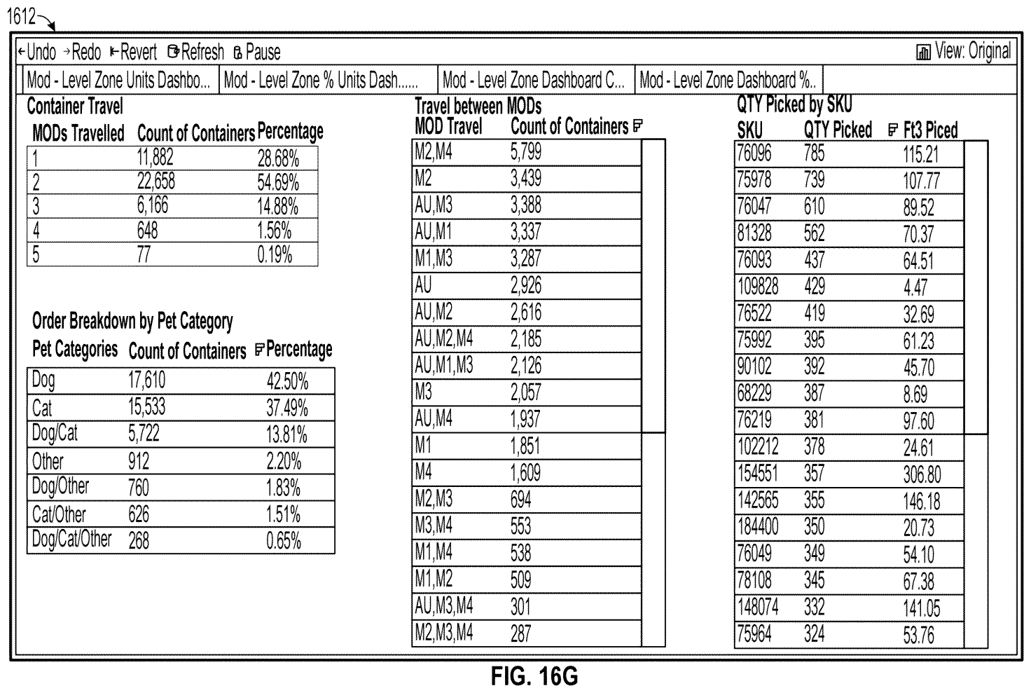

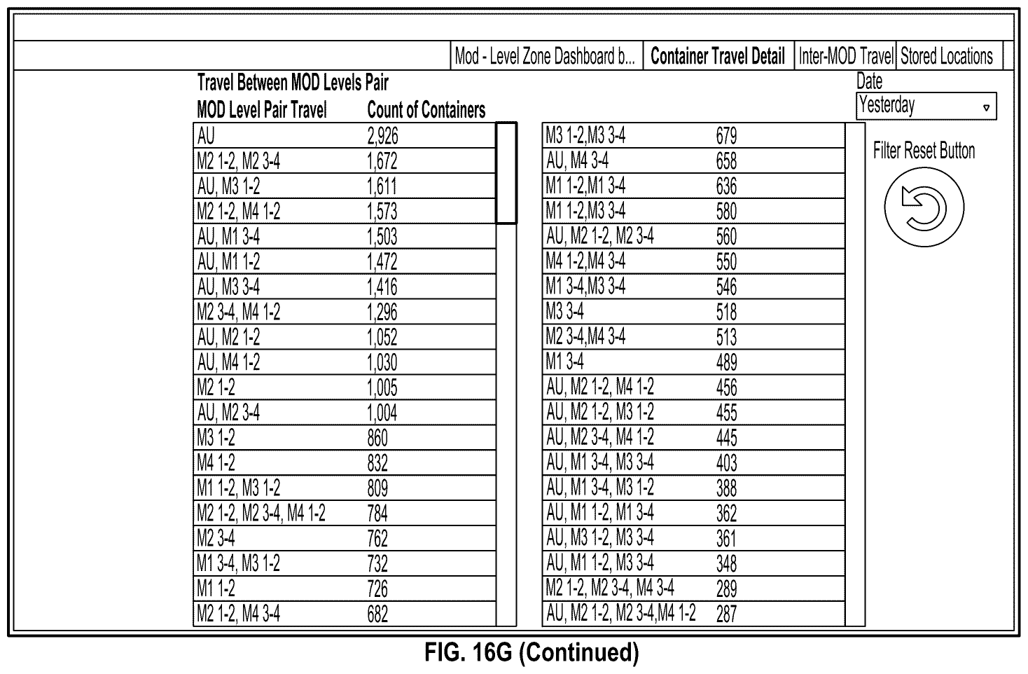

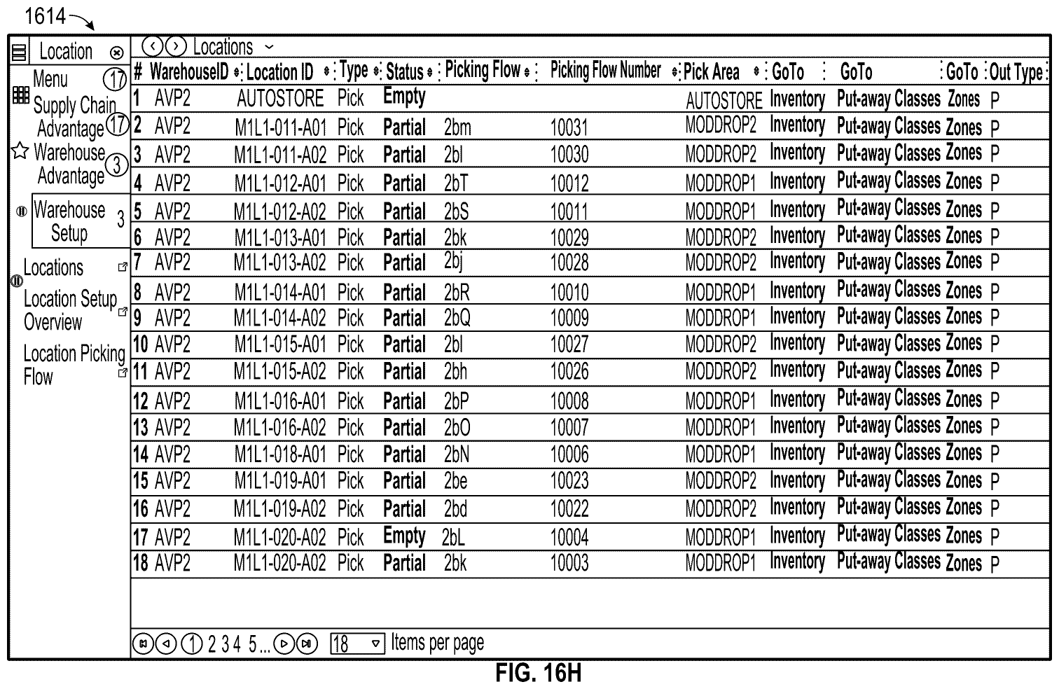

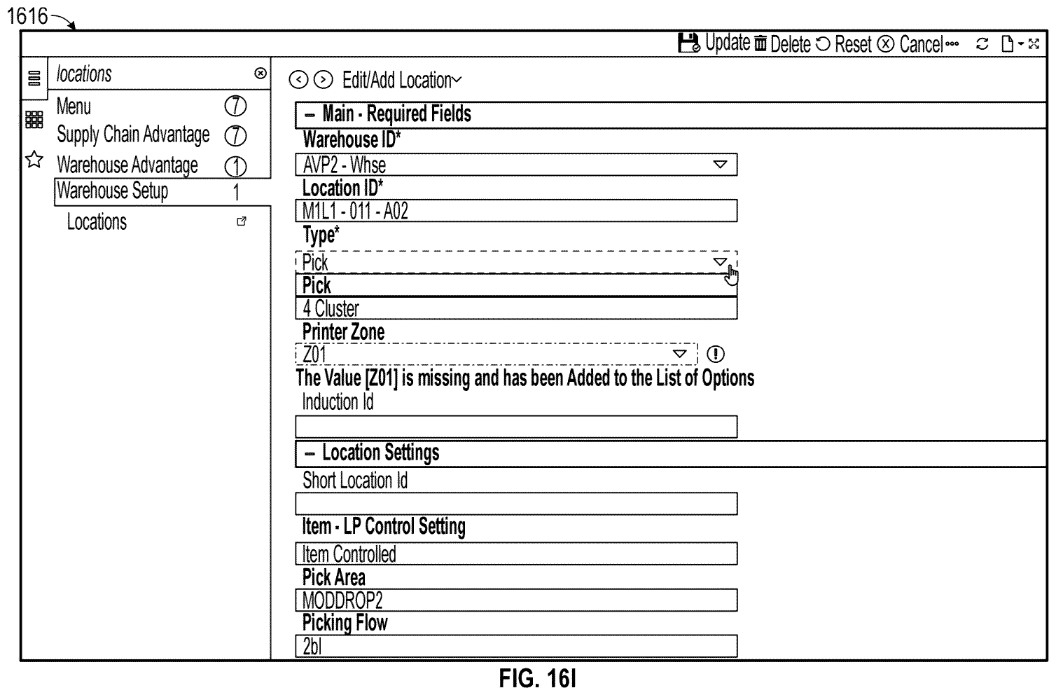

FIG. 16A shows an example slotting health summary 1600, according to some embodiments. This summary may be an executive-level summary dashboard for real-time monitoring of FC slotting health. The summary may list open or unslotted location, charge by location type, and containers percentage with multi-mod travel. A slotting team may review this live dashboard on a daily basis for deviations and address issues as needed.

### Example Slotting Tolerance Report

FIG. 16B shows an example slotting tolerance report 1602, according to some embodiments. In some embodiments, the slotting tolerance report may incorporate control limits obtained from the simulation model. The report may be generated in real-time or may be a live report. This report may enable slotting specialists and/or the system to automatically monitor fluctuations in the volume of incoming units to the FC and promptly implement adjustments to achieve a balanced distribution of workload (units to be picked) across various MODs, levels, and zones. FIG. 16C shows an example slotting tolerance report 1604 with drill-down options for viewing zone container overview, according to some embodiments. FIG. 16D shows an example slotting tolerance report 1606 with a detailed view of item and container, according to some embodiments. Users and/or the system may track these metrics in real time, compare them against predefined targets or benchmarks, and/or set up browser alerts or e-mail notifications to trigger when specific thresholds are exceeded. This feature may facilitate prompt attention and immediate action.

### Example Flow Health Tracker

FIG. 16E shows an example flow health tracker 1608 for container process path and daily ASRS trends, according to some embodiments. In some embodiments, a dashboard such as this example may provide ongoing monitoring of benchmarked values pertaining to the process path mix. The dashboard may provide the optimal number of units assigned to robots for picking tasks (ASRS) and/or the acceptable threshold that ensures uninterrupted flow during unit picking activities involving both robots (ASRS) and manual pickers. These benchmarked values may be derived from simulation experiments and may be subject to hourly tracking by the operations and slotting teams.

### Week Over Week and Historical Key Performance Indicator (KPI) Tracking

FIG. 16F shows an example heat map 1610 for container process path and daily ASRS trends for containers of an FC, according to some embodiments. This type of dashboard may facilitate the monitoring of the week over week slotting performance metrics for each FC, aiding teams in formulating actionable strategies. The dashboard may be used to analyze the aggregated volume mix, heat mapping, identify improvement opportunities, and/or address constraints faced by the team in achieving an optimal distribution of units between bot picking (ASRS) and manual picking activities. Various filters and drill downs may be applied to this view.

### Detailed Travel Path

FIG. 16G shows an example dashboard 1612 for container travel path details, according to some embodiments. The dashboard may be used by a slotting team or the system to analyze the distribution of orders across multiple MODs (Module Order Distribution). The dashboard may provide insights into the number of containers fulfilled through inter-MOD travel, specifically within 1 MOD, 2 MODs, 3 MODs, and 4 MODs, among others. These inter-MOD travel benchmarks may be established through simulation experiments, which consider several factors, such as order composition (multi-product or single product), weekly volume targets, and available labor. The weekly volume targets may encompass a range of 900,000 units to 1.3 million units. This dashboard may assist the slotting team in understanding and optimizing the travel patterns of orders within the fulfillment center, which reduces recirculation and increases ship capacity of the system.

### Location Changes User Interface (UI) in WMS

FIG. 16H shows an example user interface 1614 for viewing locations in a WMS web portal, according to some embodiments. FIG. 16I shows an example user interface 1616 for adjusting locations in a WMS web portal, according to some embodiments. To adjust volume and mix across storage configurations, a locations user interface on the WMS web portal may be used to edit slotting parameters of forward pick locations.

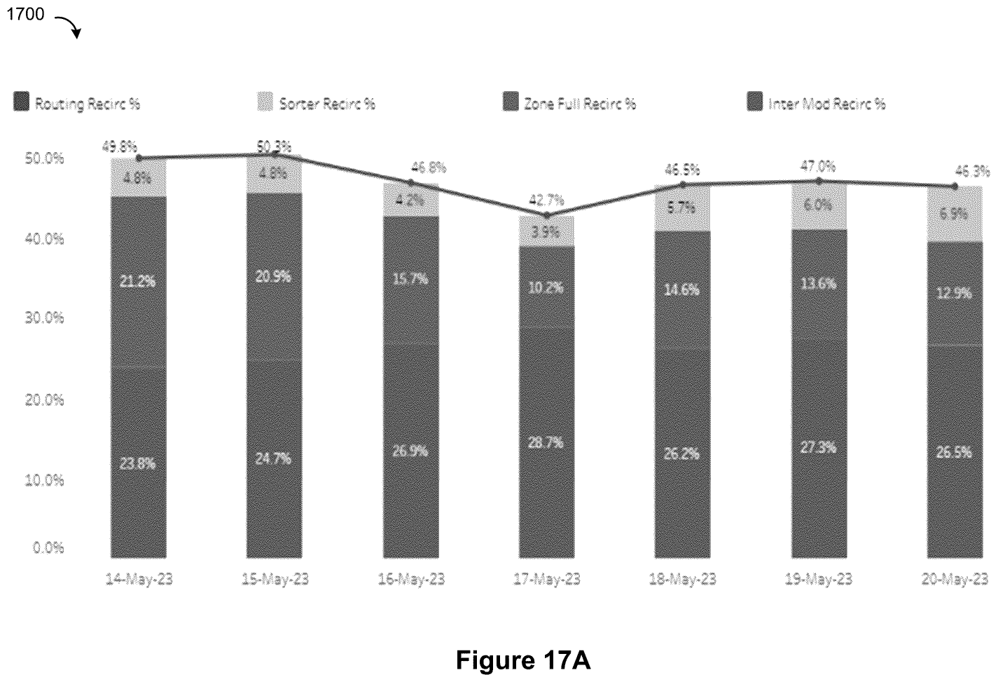

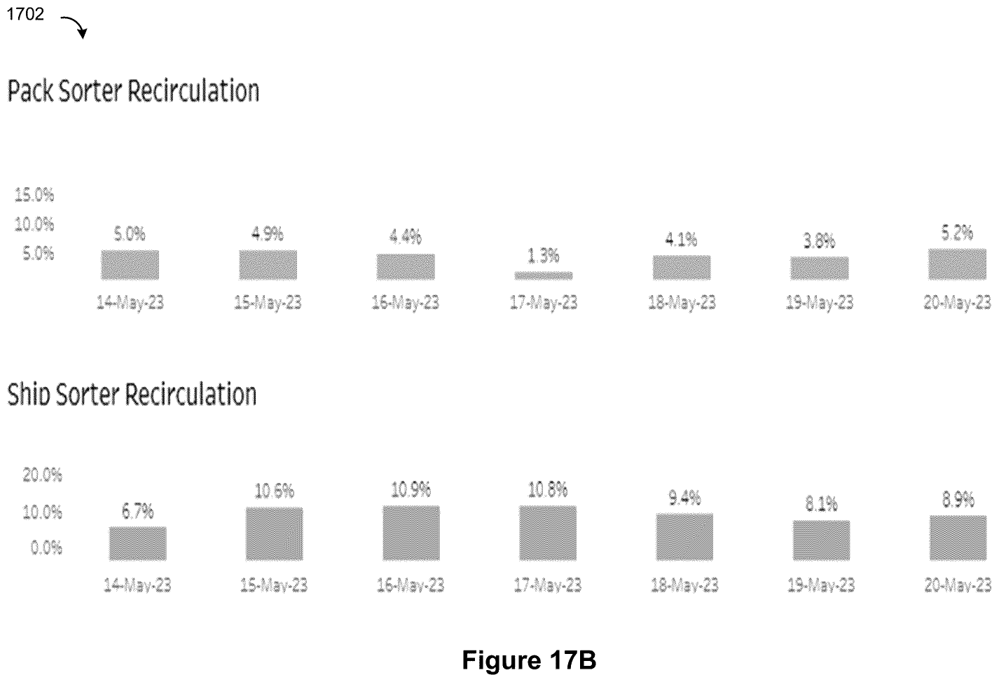

FIGS. 17A and 17B show example container flow tracking reports, according to some embodiments. FIG. 17A shows an example report 1700 for routing sorter recirculation, and FIG. 17B shows an example report 1702 for pack sorter recirculation and ship sorter recirculation.

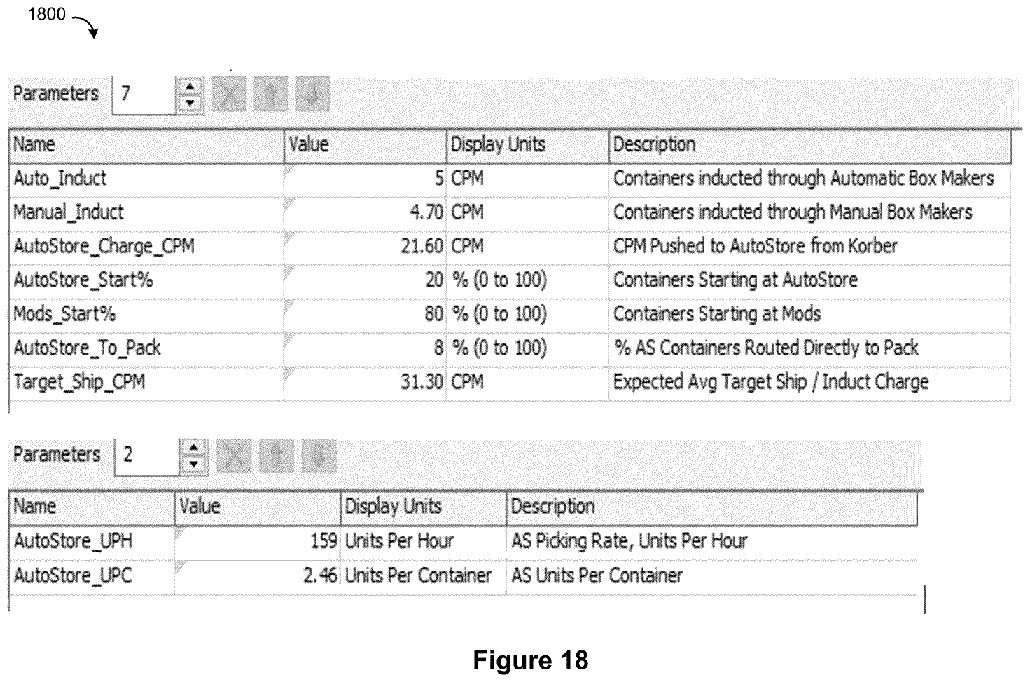

FIG. 18 shows an example user interface 1800 to specify simulation inputs, according to some embodiments.

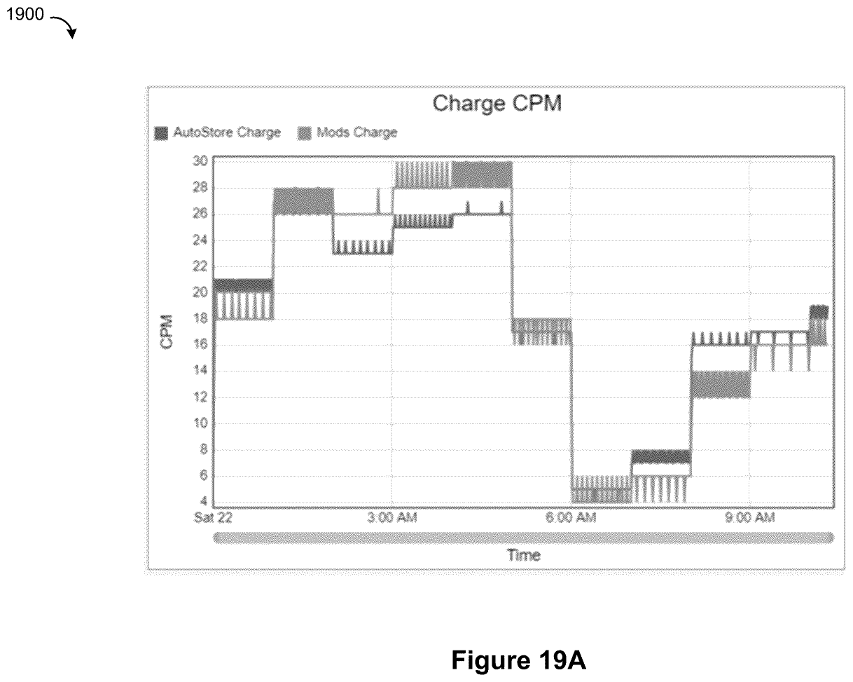

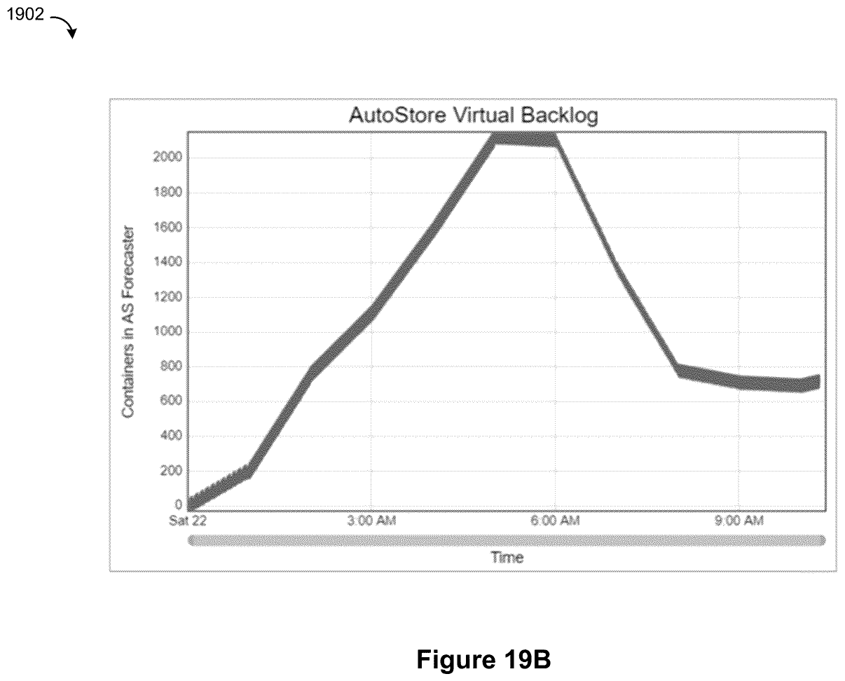

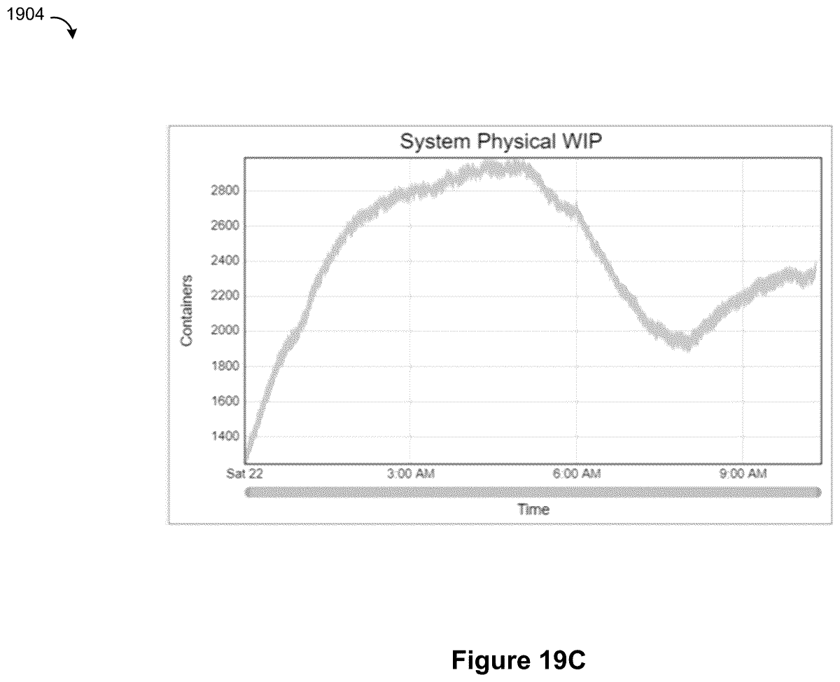

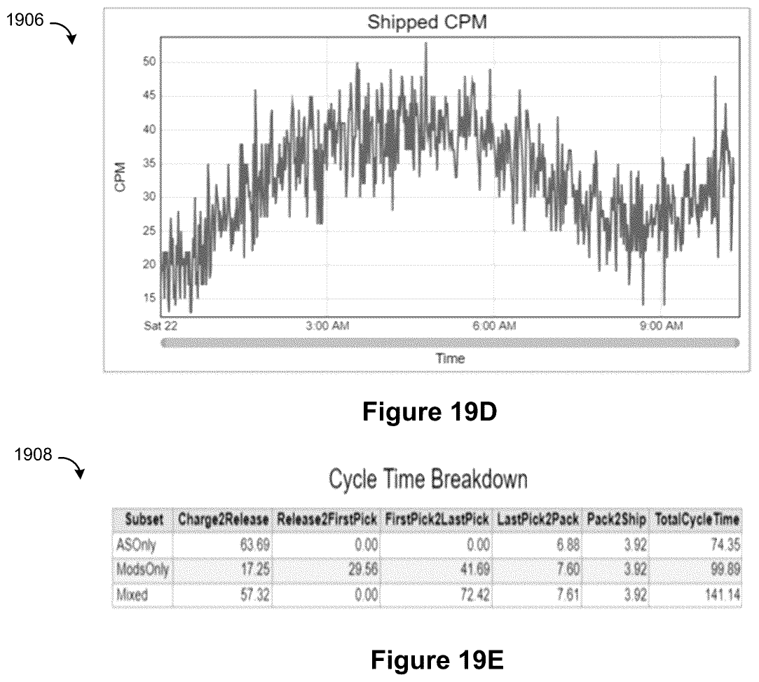

FIG. 19A is an example simulation dashboard 1900 for charge containers per minute (CPM), according to some embodiments. The example shows building charge by hour. The charge may be customer orders flowing into a building. FIG. 19B is an example simulation dashboard 1902 for auto-store virtual backlog, according to some embodiments. The dashboard shows customer orders dwelling in an ASRS before the orders are physically inducted or picked. This trend emulates real-world charge patterns that may be observed at fulfillment centers based on time of the day. FIG. 19C is an example simulation dashboard 1904 for system physical work in progress (WIP), according to some embodiments. This dashboard shows customer orders that may be physically inducted and are ongoing picking in the system. This trend line may be used to validate how well simulation emulates fulfillment center patterns of work release and availability. FIG. 19D is an example simulation dashboard 1906 for shipped CPM, according to some embodiments. FIG. 19D shows the number of containers shipped from a fulfillment center every minute. FIG. 19E is a table 1908 showing example cycle time breakdown, according to some embodiments. FIG. 19E shows a breakdown of different elements, such as charge to release, release to first pick, and pack to ship, that may constitute cycle time. Cycle time is defined as the time it takes for an order to be fulfilled from charge until it is shipped.

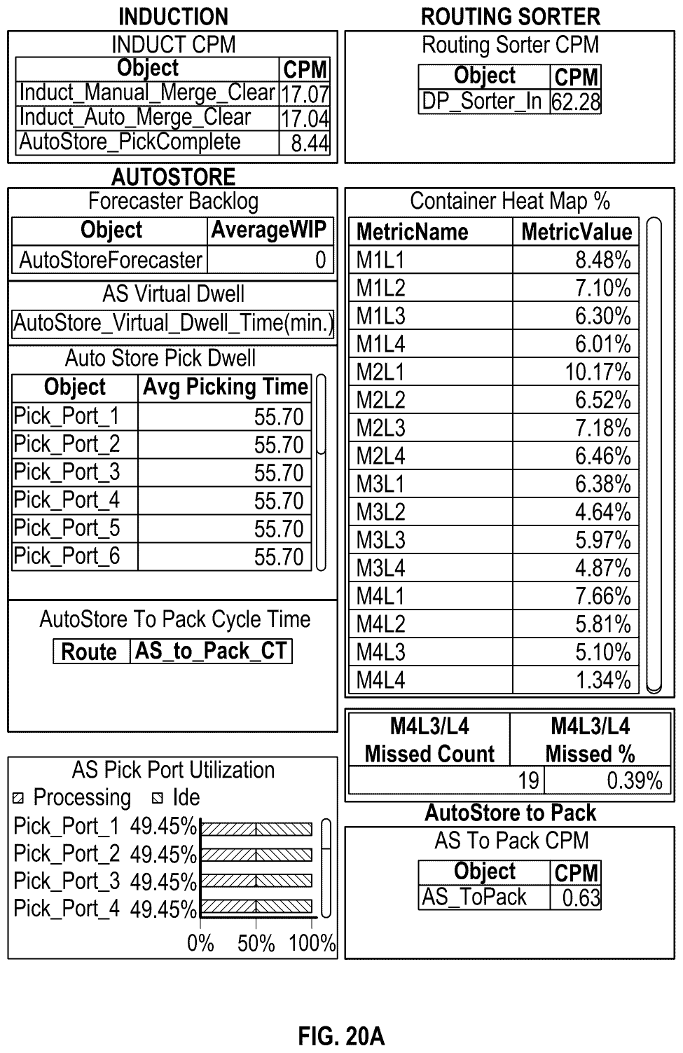

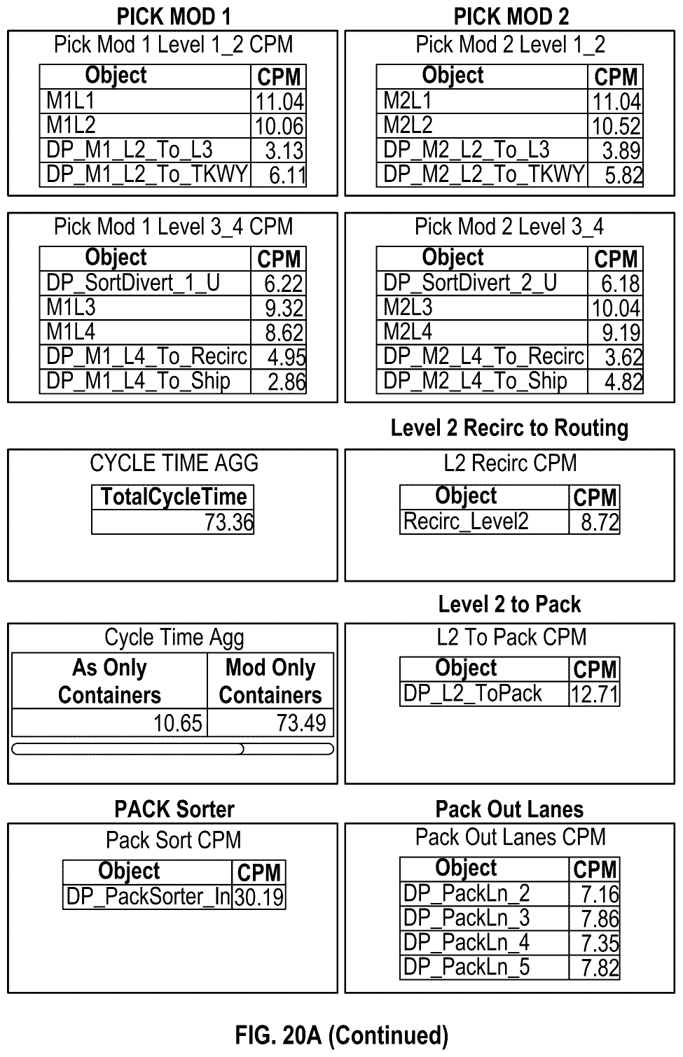

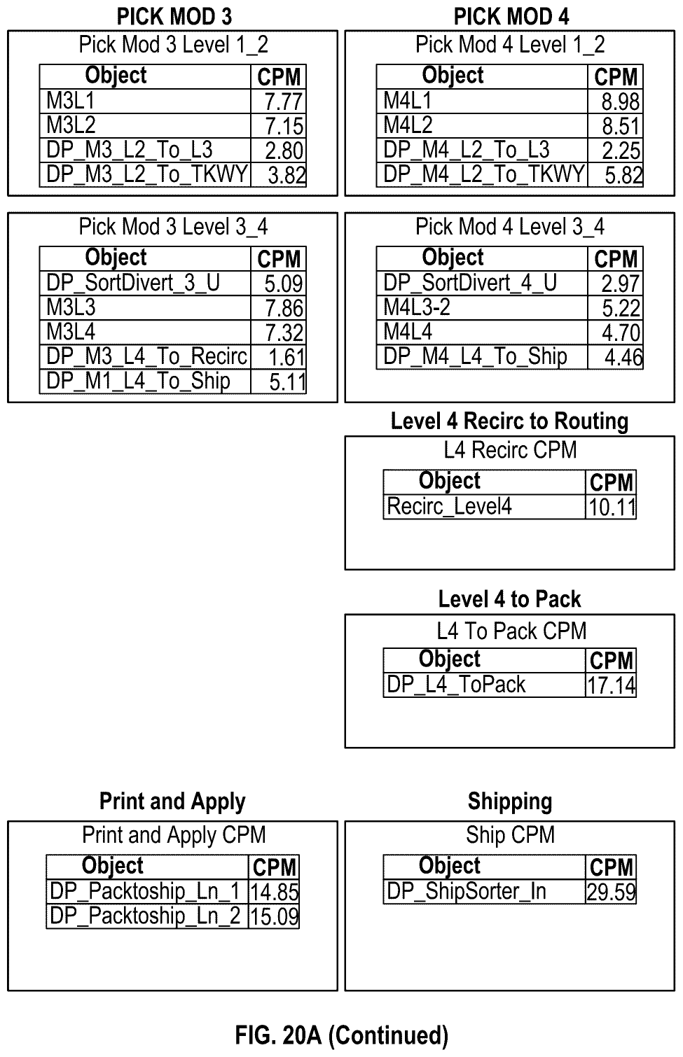

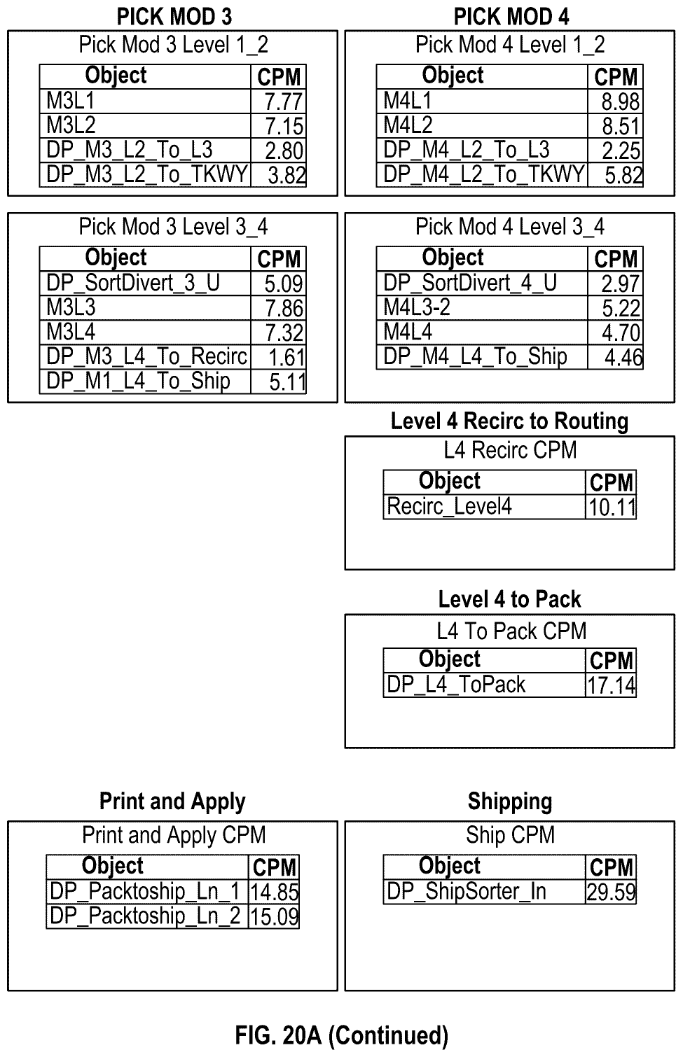

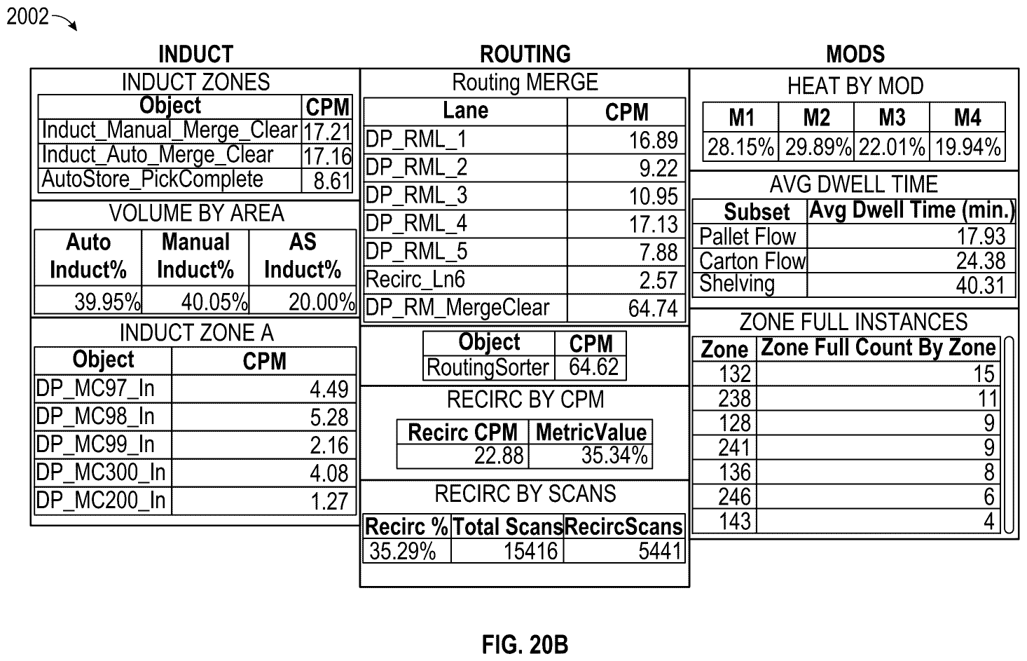

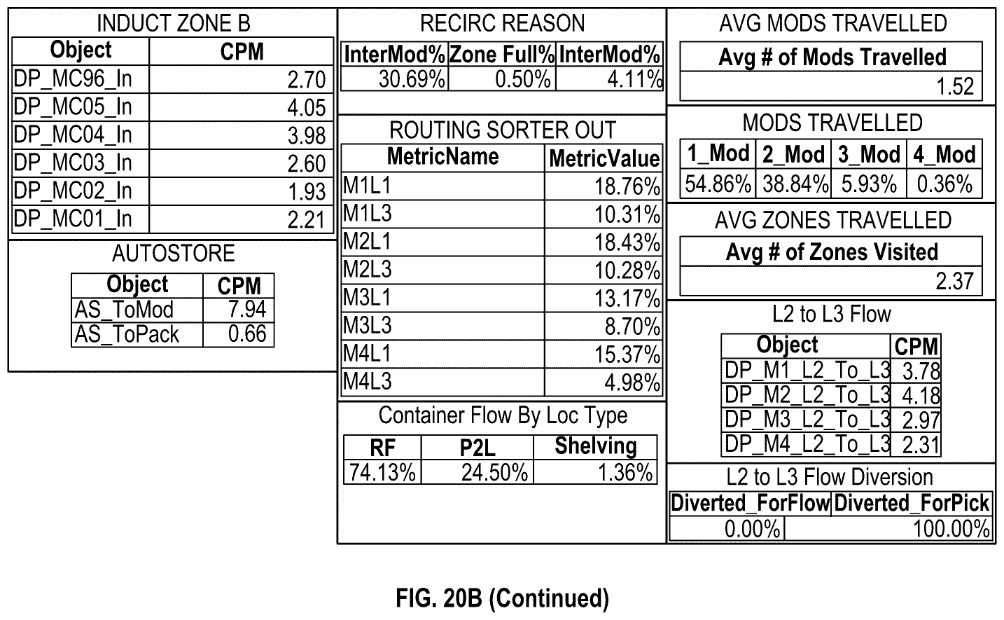

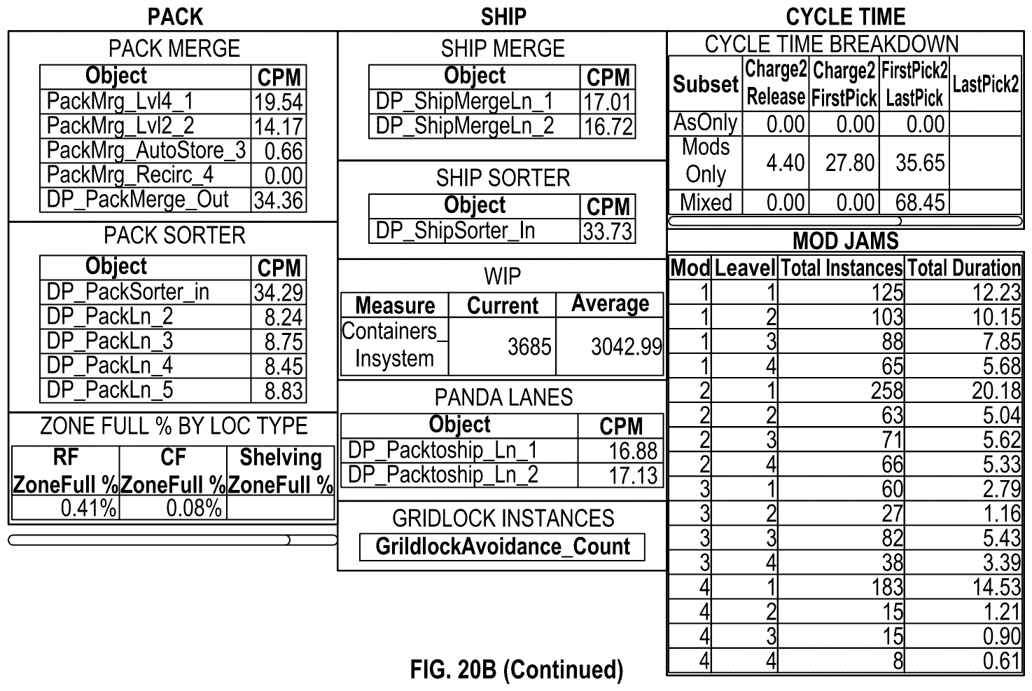

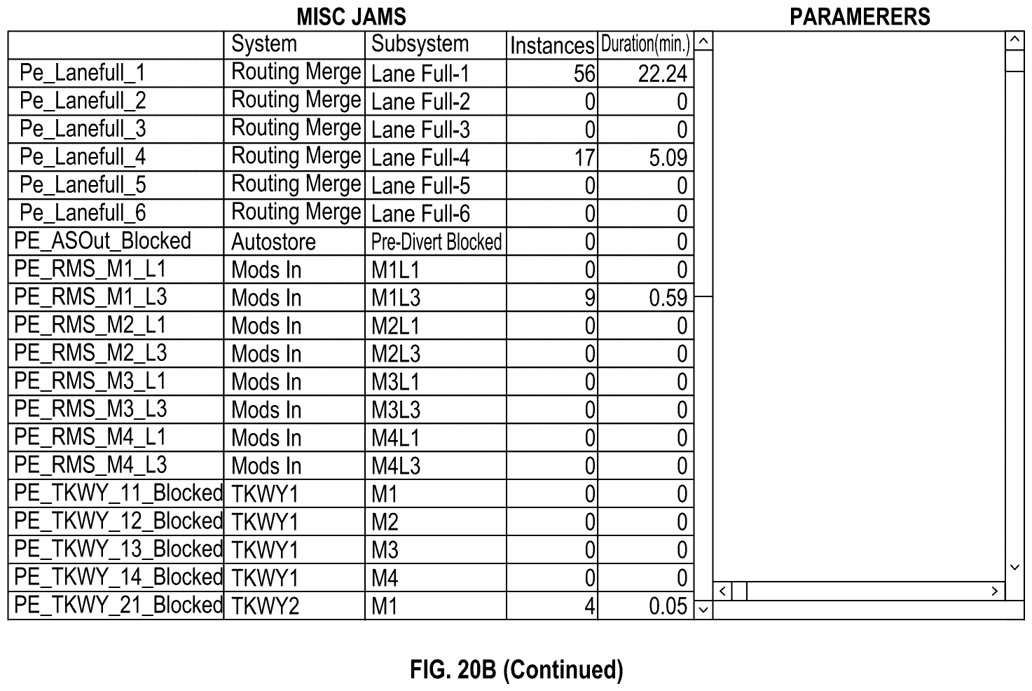

FIG. 20A is an example dashboard 2000 for material flow, according to some embodiments. FIG. 20A shows key performance indicators (KPIs), such as containers per minute, cycle time, pick heat distribution, and utilization, across different physical areas of the system. These KPIs may allow individual assessment of material flow across each area. FIG. 20B is an example dashboard 2002 for key metrics, according to some embodiments. FIG. 20B is an extension of FIG. 20A and displays more KPIs, such as recirculation, dwell times and conveyor jams (physical stoppages).

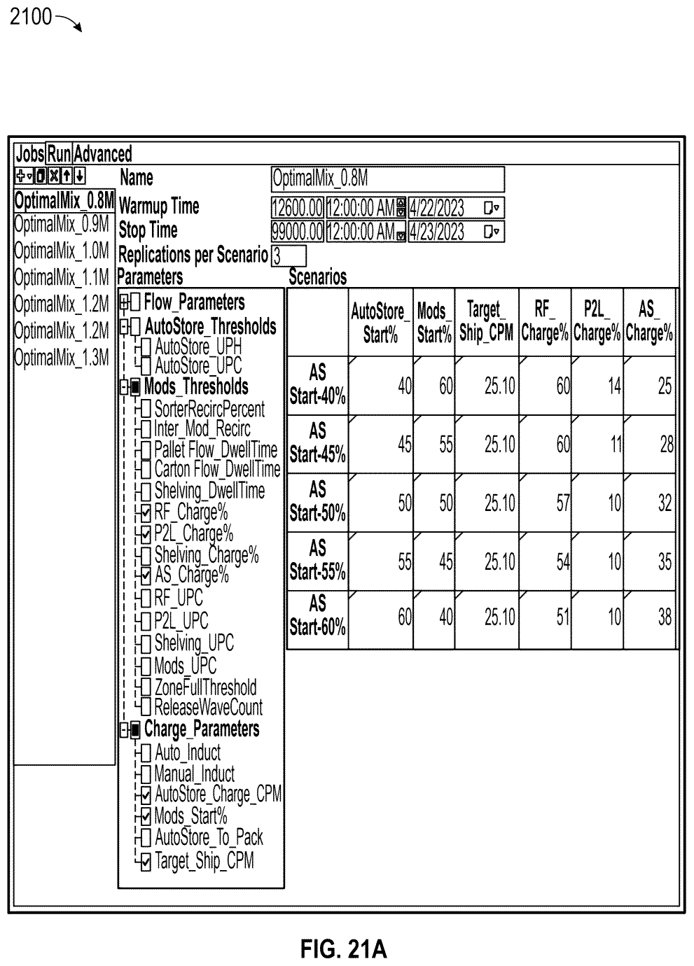

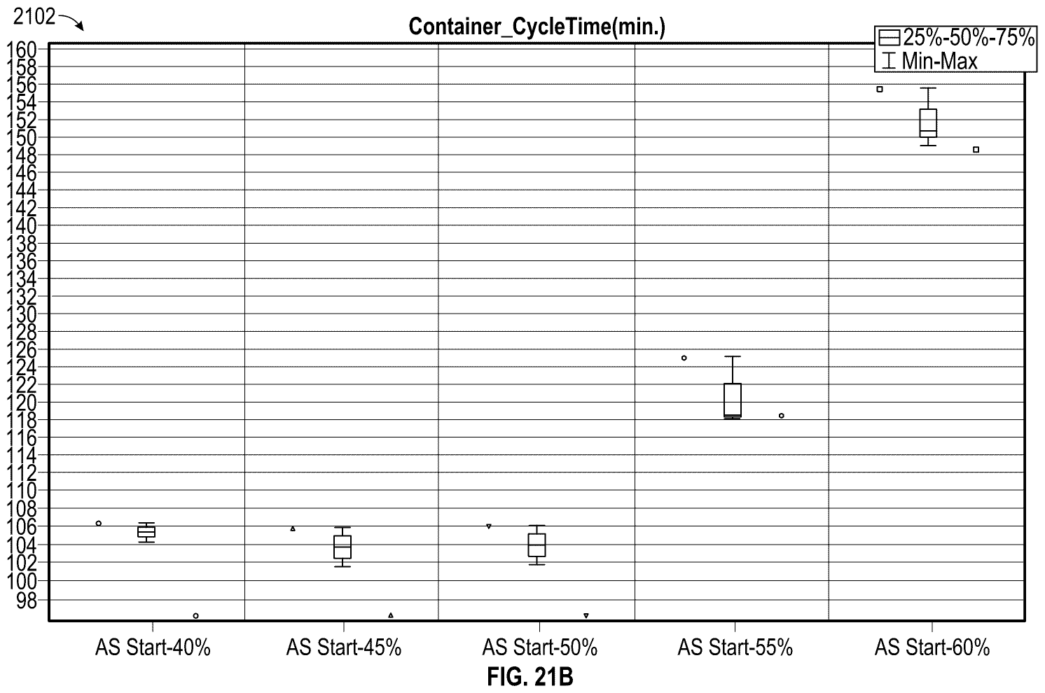

FIG. 21A is an example dashboard 2100 for viewing and/or selecting simulation experimentation runs, according to some embodiments. FIG. 21B is an example dashboard 2102 for viewing container cycle time, according to some embodiments. This dashboard represents a box plot distribution of container cycle time. Cycle time may be defined as the amount of time it takes to complete a task from start to finish. Cycle time represents charge to ship within the model. This is varied against where volume is being charged in the system to understand impact to cycle time.

Described below are example user interfaces (UIs) and automation that may be used to manage warehouses based on optimal item placement techniques described in the present disclosure. These automation methods and UIs may be used following (or concurrently with) simulation experiments described above.

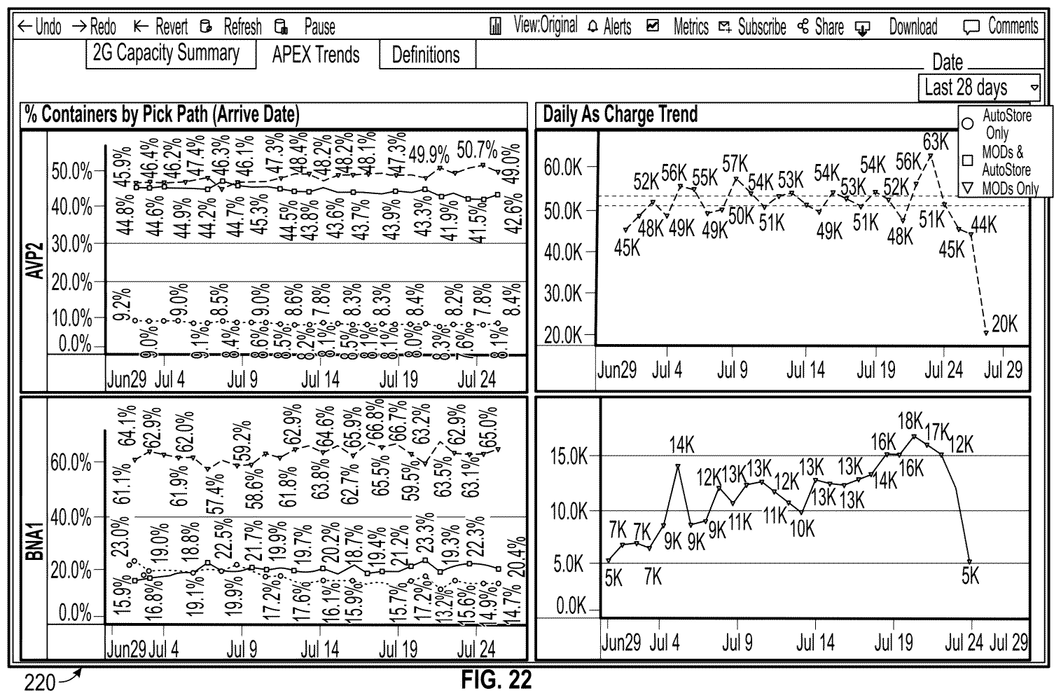

FIG. 22 shows an example user interface 2200 for comparing optimal mix recommendation results, according to some embodiments. After optimal item placement process is run, optimal mix recommendation results may be compared to historical performance in a daily monitoring UI such as the one shown in FIG. 22. In the top right chart (Daily AS Charge Trend), the ASRS daily throughput trend (blue line) is shown to be below a recommended threshold (highlighted grey). From this chart, it may be inferred that there is a need to increase the mix of volume flowing out of ASRS to align with the optimal mix recommendation.

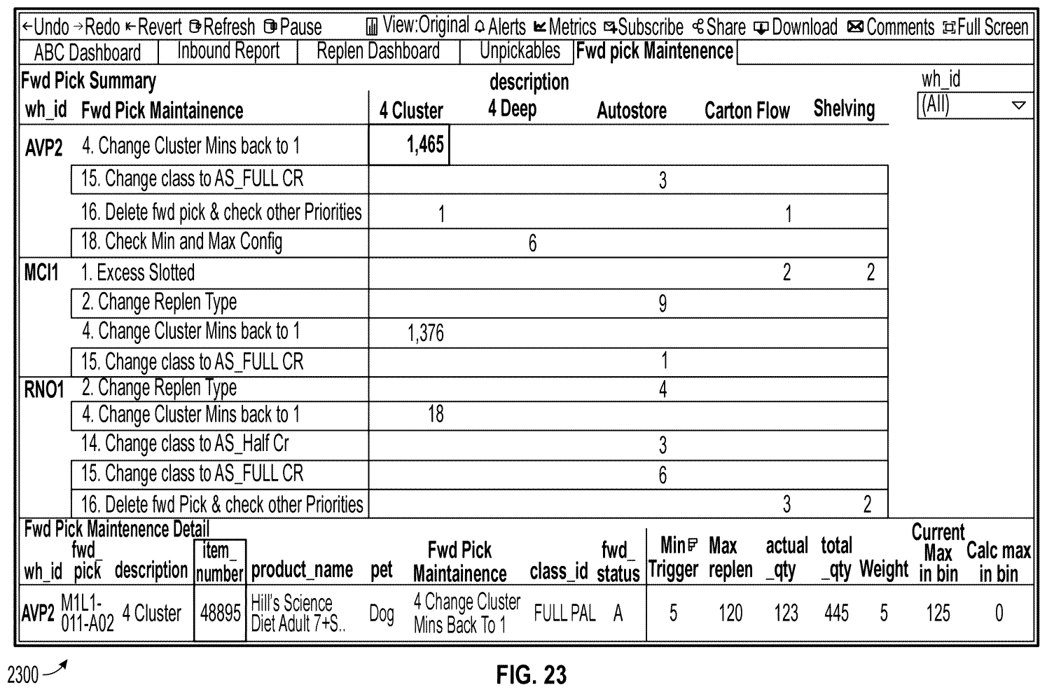

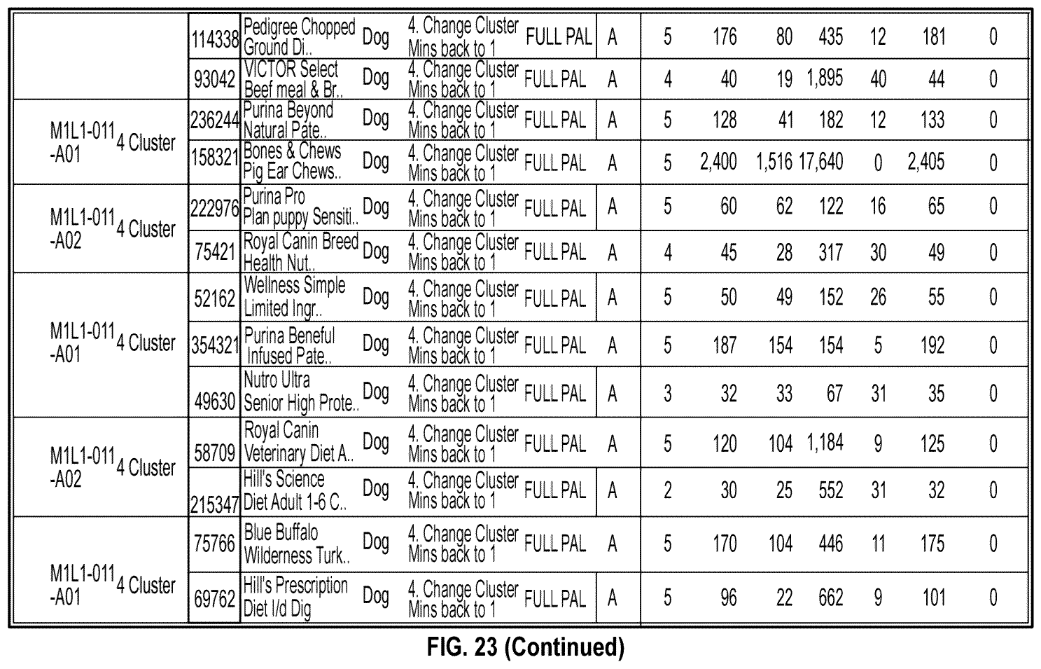

FIG. 23 shows an example user interface 2300 for real-time monitoring UI, according to some embodiments. To align with a recommended optimal item placement mix, the real-time monitoring UI may show a list of items and moves to be made by switching their picking location. As an example, a recommended item ‘183457’ from a list below, may be seen having to be re-slotted from the pick module picking location to Automated Storage and Retrieval Systems (ASRS).

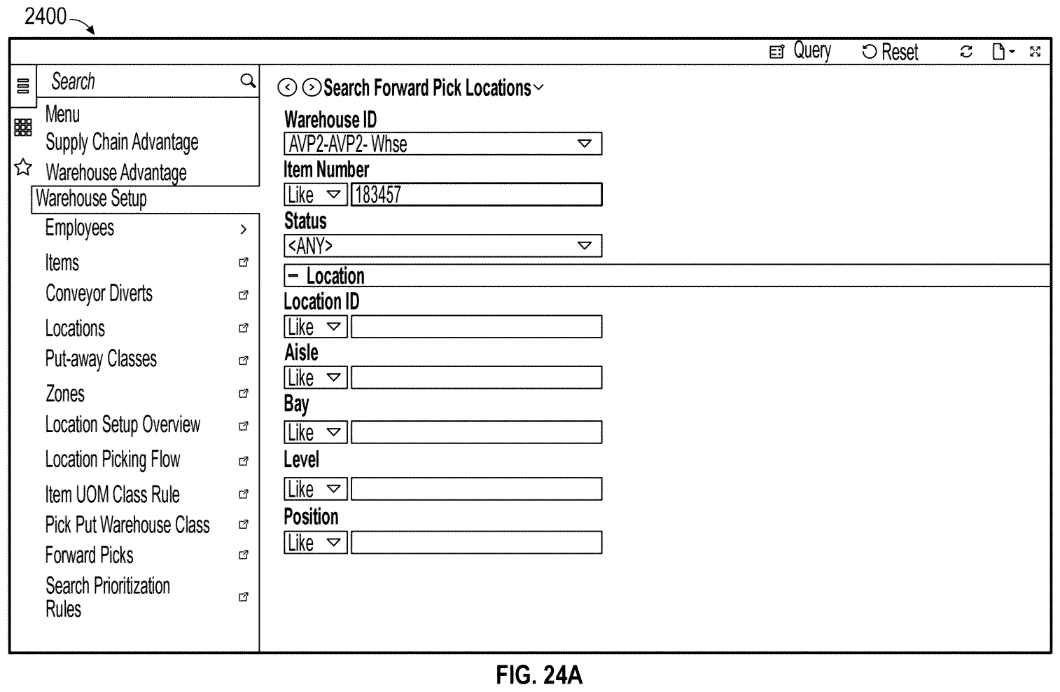

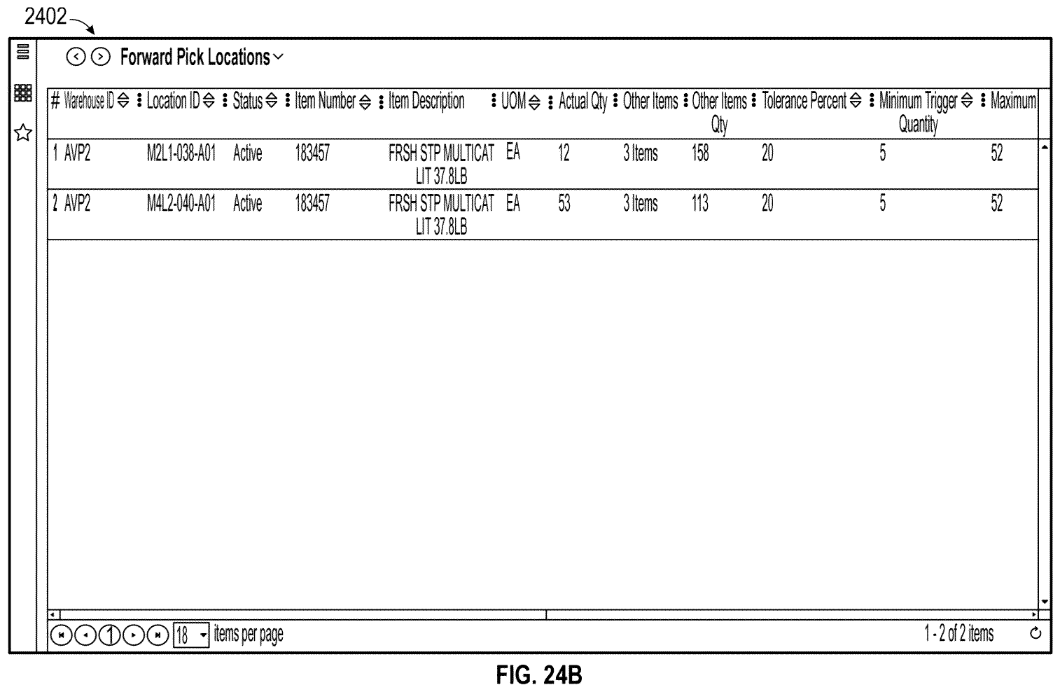

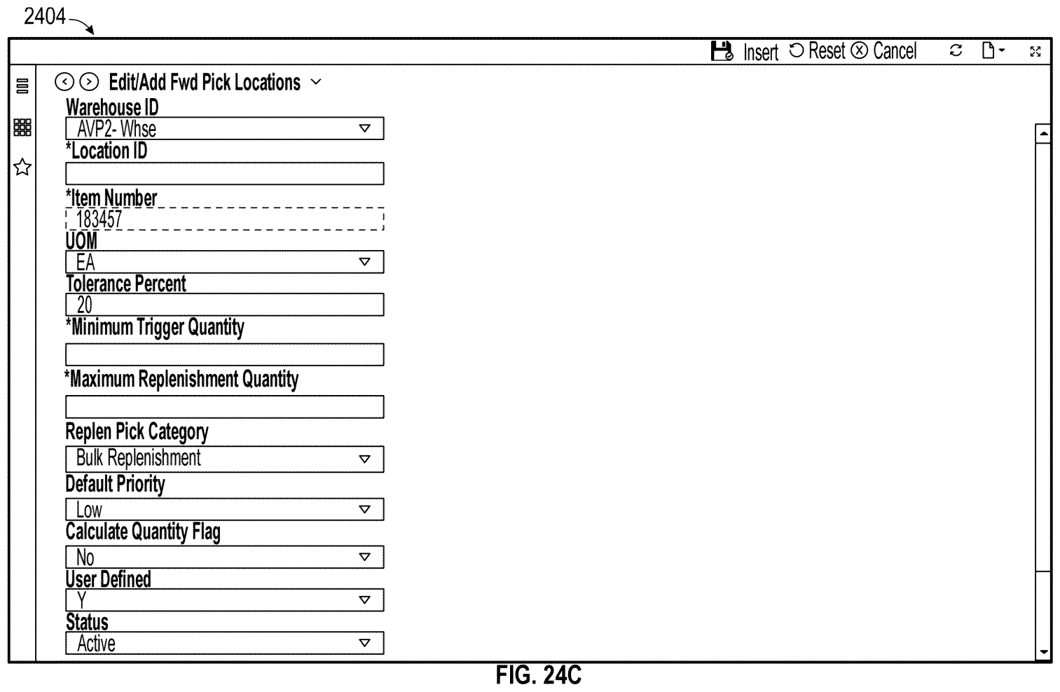

FIG. 24A shows an example user interface 2400 for a WMS, according to some embodiments. To take actions highlighted for an item placement alignment (e.g., the alignment described above in reference to FIG. 23), the WMS UI may allow viewing, creating, and/or adjusting each item's pickable locations and/or inventory replenishment to the pickable location settings. In the example shown, a user may search for pickable locations for a particular item with product number ‘183457’.

FIG. 24B shows another example user interface 2402 for WMS, according to some embodiments. The UI may show forward pick locations where ‘183457’ is currently slotted.

FIG. 24C shows another example user interface 2404 for WMS, according to some embodiments. As recommended by the optimal item placement workflow, a user and/or the system may proceed to add a new pickable location for this item in ASRS.

When a product is ready to be replenished into an ASRS an item (e.g., the item ‘183457’) may be moved (e.g., via a bot) into the ASRS. An ASRS system may be operated via an ASRS pick workstation, where users may interact with bots and a WES UI to pick products from totes/bins into customer order containers. An ASRS tote/bin may hold the inventory. A bot may store and retrieve inventory in a 3D grid based on product demand and volume allocation.

To store the item in an ASRS an ASRS UI may be used. A WES UI (sometimes referred to as WES Human Machine Interface or WES HMI) may be used to put an item into ASRS bins/totes. When a customer order arrives for this item, a WES UI may be used by users (e.g., humans, bots) to pick this item from ASRS totes/bins into customer order containers. A slotting interface may be used to show storage locations of products. This interface can be used to alter item placement within a WES.

After an item is picked into a customer order container (e.g., using the WES UI at an ASRS workstation), the item may be then routed either towards pack and ship area, or towards pick modules for manual picking of other items in the same customer's order. WES interfaces may be provided for pick module and ship sortation system, according to some embodiments. The WES interfaces may show a real-time view of material handling equipment and may be used to monitor and control the physical moves of the product on the conveyance system in different areas. Applications may include resolving flow issues, such as jams and lane full, manual override to control recirculation, view flow statistics, alerts, and/or notifications during downtime.

After a customer order or container arrives in the pick modules, the customer order or container may be routed to one of the forward pick locations, such as pick to light or carton flow, for picking secondary items. A carton flow forward pick location racking may be used, according to some embodiments. Light-directed technology may be used to guide humans and/or robots to the exact pick location within a given area.

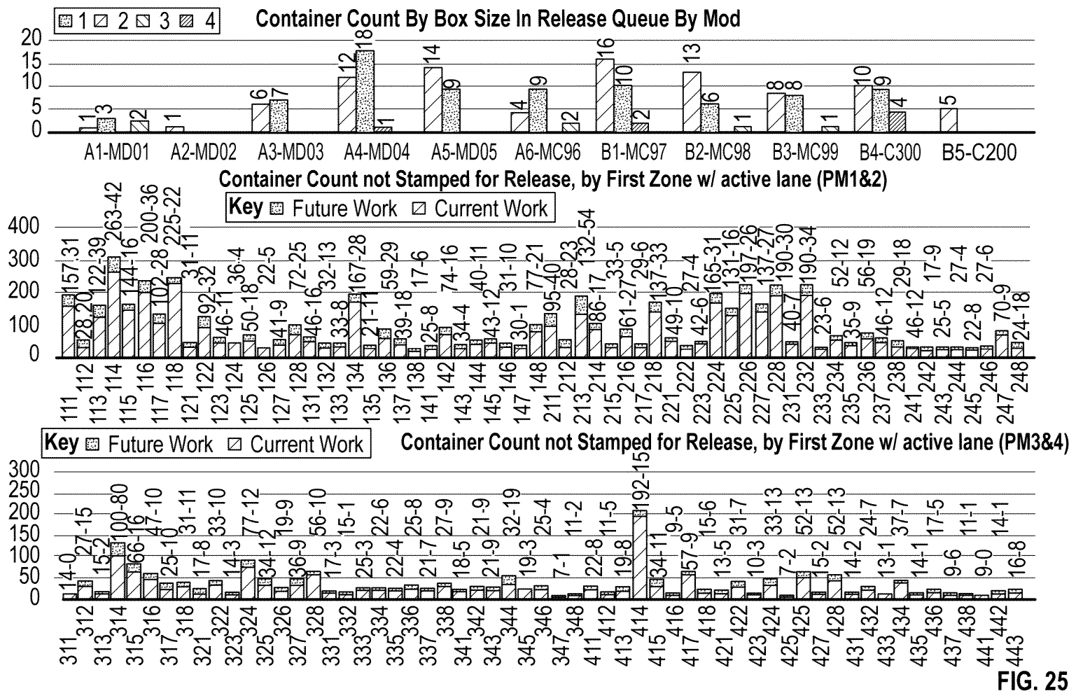

FIG. 25 shows an example UI 2500 for real-time monitoring flow recirculation, according to some embodiments. Pick Module Flow Monitoring may include staffing decisions (e.g., resource allocation, for labor, bots, and/or computing resources) within manual pick modules based on the monitoring UI. After a team member (or a bot) enters a zone for picking, they may complete the pick and push the container onto conveyance to be routed to the next pick zone or to pack and ship area if all items have been picked.

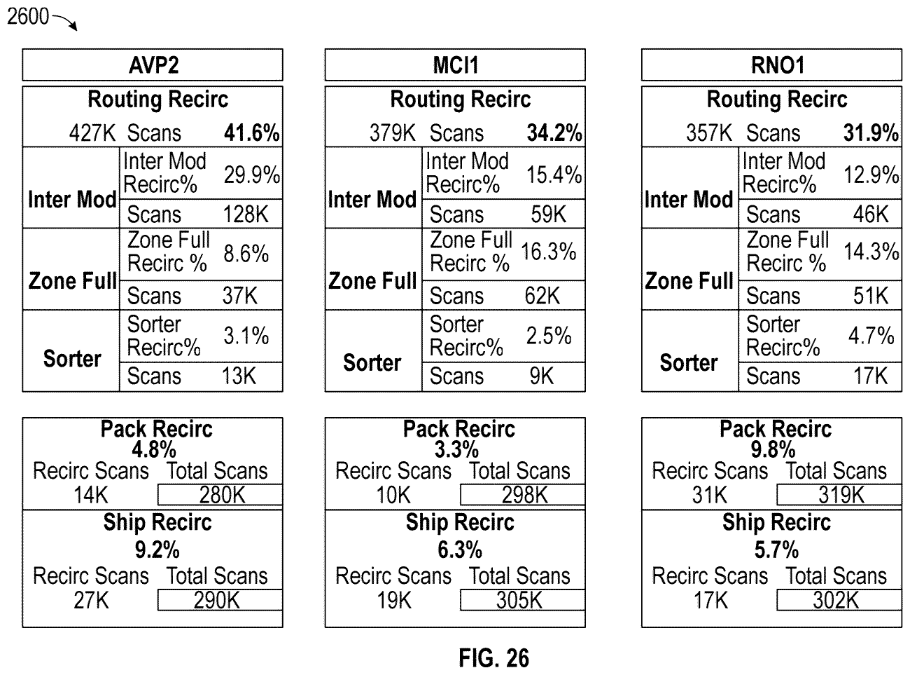

FIG. 26 shows another example UI 2600 for real-time monitoring flow recirculation, according to some embodiments. Recirculation monitoring may include real-time flow that be also managed using dashboards such as recirculation, which may use WES scan data. Actions to resolve flow issues identified may be derived based on this information.

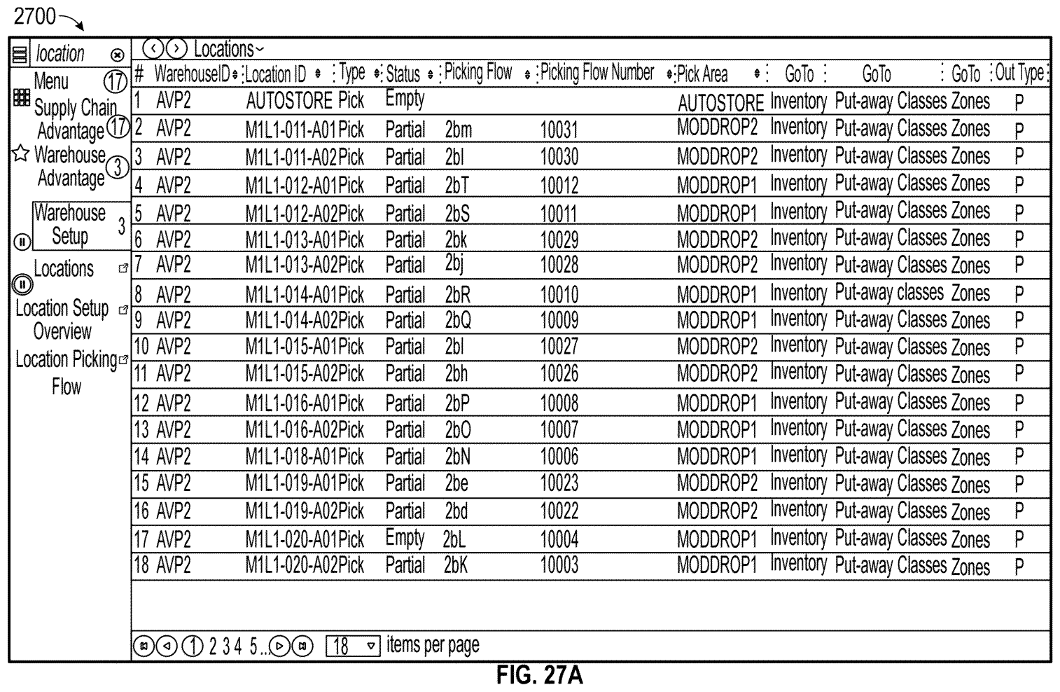

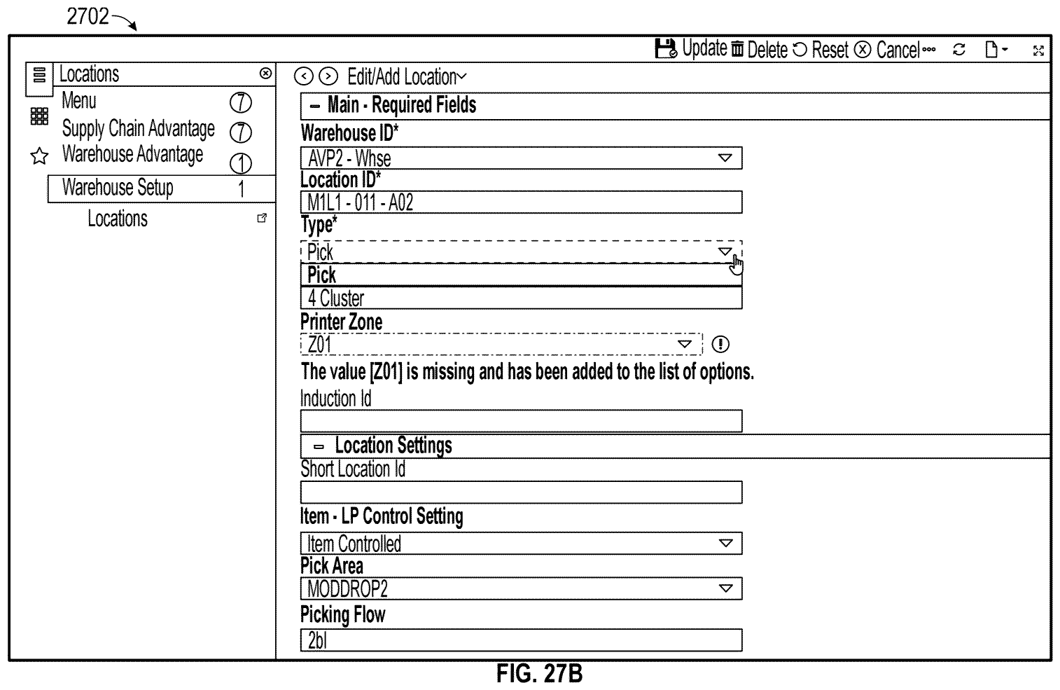

FIG. 27A shows an example WMS locations UI (list view) 2700, according to some embodiments. FIG. 27B shows another example WMS locations UI 2702 with edit/add location option, according to some embodiments. To adjust the settings across different forward pick locations simultaneously, the locations UI on a WMS web portal may be used to edit slotting parameters of forward pick locations. The recommendations for making changes are derived from the implementation of the claims.

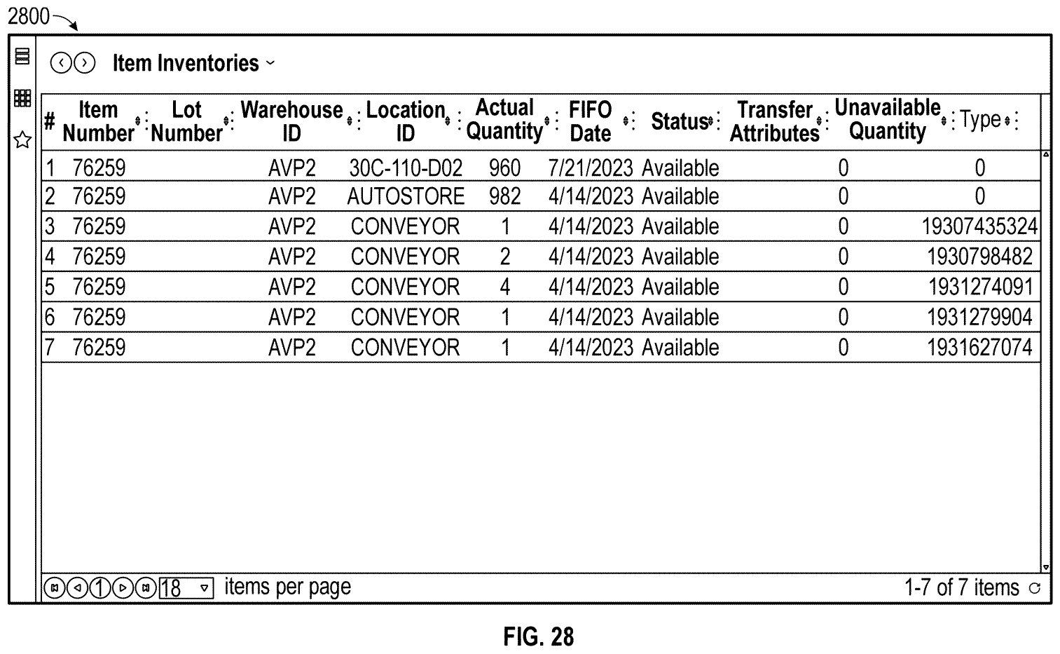

FIG. 28 shows an example WES inventory management UI 2800, according to some embodiments. The WMS inventory management UI may be used to manage inventory by assigning forward pick, checking quantity, and/or setting first-in-first-out (FIFO) rule, priority, and/or status. This may help ensure optimal item alignment within the WMS.

Thus, various techniques are described for controlling order fulfillment from a network of fulfillment centers.

The terminology used in the description of the invention herein is for the purpose of describing particular embodiments only and is not intended to be limiting of the invention. As used in the description of the invention and the appended claims, the singular forms “a.” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Some embodiments or implementations are described with respect to the following clauses:

Clause A1. A system for controlling item placement for managing warehouse productivity, the system comprising: one or more warehouse databases; and one or more processors configured to: interface with the one or more warehouse databases: extract, transform and load information from the one or more warehouse databases to form an input dataset: perform cost analysis and discrete event simulation to the input dataset to obtain a candidate dataset; and provide a recommendation for an optimal mix of volume flow through different forward pick areas of a warehouse by applying a linear programming solver on the candidate dataset.

Clause A2. The system of clause A1, wherein the one or more processors is further configured to: automatically control, based on the recommendation, physical item placement in the warehouse by: causing automated storage and retrieval system robots to redistribute items between storage areas according to the recommendation: adjusting automated conveyor system routing and merge point controls to implement the recommended volume flow; and dynamically adjusting container release rates at merge points based on real-time monitoring of physical work-in-progress metrics to prevent system gridlock.

Clause A3. The system of clause A2, wherein the system continuously monitors container dwell times and physical work-in-progress at merge points, and automatically adjusts container routing and release timing to maintain the recommended optimal mix while preventing gridlock conditions in a physical conveyor system.

Clause A4. The system of any of clauses A1-A3, wherein the information loaded from the one or more warehouse databases comprises data regarding Stock Keeping Units (SKU), physical storage locations, physical conveyance parameters and automation specifications.

Clause A5. The system of any of clauses A1-A4, wherein extracting information comprises obtaining a list of items, slots and forward pick assignments by location type, wherein information related to slots include data pertaining to slot numbers, aisle locations, rack positions, and any other relevant slot attributes, wherein information related to forward pick assignments include information on allocation of items to specific pick locations for enhancing order fulfillment efficiency.

Clause A6. The system of any of clauses A1-A5, wherein transforming the information comprises cleaning, enriching, and manipulating data into a consistent format that meets format requirements of a discrete event simulation engine.

Clause A7. The system of any of clauses A1-A6, wherein loading the information comprises transferring transformed data into a target network data storage system.

Clause A8. The system of any of clauses A1-A7, wherein performing discrete event simulation comprises using a model representing a fulfillment center as a series of interconnected components or entities, including machines, workers, customers or combinations thereof, that interact with each other over time, as a series of discrete events that match how orders flow through the fulfillment center, wherein the model is run a plurality of iterations, with different input parameters and scenarios, to determine impact of different conditions and decisions on performance of the fulfillment center.

Clause A9. The system of clause A8, wherein the components include orders, products, workers, equipment, robotics, automation, and transportation systems, wherein the discrete events include arrivals, product movements, equipment processing and worker actions, which occur at specific points in time.

Clause A10. The system of clause A8, wherein the model comprises engineering computer-aided design (CAD) drawings that replicate infrastructure the fulfillment center, wherein data collected during the extract, transform and load is used to populate key points within the model to build a logical model required for analysis.

Clause A11. The system of clause A8, wherein the model is run continuously to build inputs for the linear programming solver.

Clause A12. The system of any of clauses A1-A11, wherein the model is iteratively run based on the input dataset, until optimal volume thresholds flowing through different forward pick location types is determined.

Clause A13. The system of any of clauses A1-A12, wherein performing cost analysis comprises determining net picking and replenishment cost per unit processed in a fulfillment center, segregated by storage configuration.

Clause A14. The system of any of clauses A1-A13, wherein performing cost analysis comprises analyzing labor hours and cost, grouped by forward pick location type, utilizing employee clock-in records, department information, area specifications, transactional data or combinations thereof.

Clause A15. The system of any of clauses A1-A14, wherein performing the discrete event simulation comprises performing random replications by running a simulation model multiple times with different sets of random input values, to obtain a range of results and analyze statistical measures such as mean, standard deviation, confidence intervals, or percentiles and get eliminate results based on chance or bias.

Clause A16. The system of any of clauses A1-A15, wherein performing the discrete event simulation comprises defining a set of experimental parameters for a discrete event simulation engine to automatically run simulations, including defining a range or distribution for each parameter and using the discrete event simulation engine to automatically generate random values within those ranges for each replication.

Clause A17. The system of any of clauses A1-A16, wherein performing the discrete event simulation comprises representing picking by container dwell times in both manual and automated picking areas/workstations, wherein dwell times are modeled using a probability distribution based on historical data, wherein the dwell times indicate how much capacity in each picking area is being utilized.

Clause A18. The system of any of clauses A1-A17, wherein the linear programming solver is based on a Simplex method.

Clause A19. The system of any of clauses A1-A18, wherein the linear programming solver optimizes picking and replenishment cost per unit for a given target volume, minimizes cost per unit while meeting a target volume requirement.

Clause A20. The system of any of clauses A1-A19, wherein the one or more processors are further configured to adjust item placement to align with recommended mix from different location types, continuously to reduce costs and improve cycle time.

Clause A21. The system of any of clauses A1-A20, wherein the one or more processors are further configured to adapt to demand volatility by realigning item placement within a defined mix, including causing shifting items to more prominent locations, adjusting quantities based on demand forecasts, or accounting for new products allocated to a fulfillment center.

Clause A22. The system of any of clauses A1-A21, wherein the one or more processors are further configured to generate a summary dashboard for real-time monitoring of fulfillment center slotting health, including listing open or unslotted location, charges by location type, and containers percentage with multi-mod (Module Order Distribution) travel.

Clause A23. The system of any of clauses A1-A22, wherein the one or more processors are further configured to monitor fluctuations in volume of incoming units to a fulfillment center and implement adjustments to achieve a balanced distribution of workload (units to be picked) across various mods, levels, and zones.

Clause A24. The system of any of clauses A1-A23, wherein the one or more processors are further configured to track metrics in real time, compare the metrics against predefined targets or benchmarks, and set up browser alerts or e-mail notifications based on thresholds being exceeded.

Clause A25. The system of any of clauses A1-A24, wherein the one or more processors are further configured to provide ongoing monitoring of benchmarked values pertaining to process path mix including an optimal number of units assigned to robots for picking tasks (ASRS) and an acceptable threshold that ensures uninterrupted flow during unit picking activities involving both robots (ASRS) and manual pickers.

Clause A26. The system of any of clauses A1-A25, wherein the one or more processors are further configured to monitor week-over-week slotting performance metrics for each fulfillment center, analyze aggregated volume mix, heat mapping, identify improvement opportunities, and/or address constraints faced in achieving an optimal distribution of units between bot picking (ASRS) and manual picking activities.

Clause A27. The system of any of clauses A1-A26, wherein the one or more processors are further configured to analyze distribution of orders across multiple MODs (Module Order Distribution).

Clause A28. The system of any of clauses A1-A27, wherein the one or more processors are further configured to provide insights into number of containers fulfilled through inter-MOD travel, specifically within 1 MOD, 2 MODs, 3 MODs, and/or 4 MODs.

Clause A29. The system of any of clauses A1-A28, wherein the one or more processors are further configured to adjust volume and mix across storage configurations by generating a locations user interface on a web portal that can be used to edit slotting parameters of forward pick locations.

What is claimed is:

1. A system for controlling item placement for managing warehouse productivity, the system comprising:
one or more warehouse databases; and
one or more processors configured to:
interface with the one or more warehouse databases;
extract, transform and load information from the one or more warehouse databases to form an input dataset;
perform cost analysis and discrete event simulation to the input dataset to obtain a candidate dataset; and
generate a recommendation for an optimal mix of volume flow through different forward pick areas of a warehouse by applying a linear programming solver on the candidate dataset.

2. The system of claim 1, wherein the one or more processors is further configured to:
automatically control, based on the recommendation, physical item placement in the warehouse by:
causing automated storage and retrieval system robots to redistribute items between storage areas according to the recommendation;
adjusting automated conveyor system routing and merge point controls to implement the recommended volume flow; and
dynamically adjusting container release rates at merge points based on real-time monitoring of physical work-in-progress metrics to prevent system gridlock.

3. The system of claim 2, wherein the system continuously monitors container dwell times and physical work-in-progress at merge points, and automatically adjusts container routing and release timing to maintain the recommended optimal mix while preventing gridlock conditions in a physical conveyor system.

4. The system of claim 1, wherein performing discrete event simulation comprises using a model representing a fulfillment center as a series of interconnected components or entities, including machines, workers, customers or combinations thereof, that interact with each other over time, as a series of discrete events that match how orders flow through the fulfillment center, wherein the model is run a plurality of iterations, with different input parameters and scenarios, to determine impact of different conditions and decisions on performance of the fulfillment center.

5. The system of claim 4, wherein the components include orders, products, workers, equipment, robotics, automation, and transportation systems, wherein the discrete events include arrivals, product movements, equipment processing and worker actions, which occur at specific points in time.

6. The system of claim 4, wherein the model comprises engineering computer-aided design (CAD) drawings that replicate infrastructure the fulfillment center, wherein data collected during the extract, transform and load is used to populate key points within the model to build a logical model required for analysis.

7. The system of claim 4, wherein the model is run continuously to build inputs for the linear programming solver, wherein the model is iteratively run based on the input dataset, until optimal volume thresholds flowing through different forward pick location types is determined.

8. The system of claim 1, wherein performing the discrete event simulation comprises representing picking by container dwell times in both manual and automated picking areas/workstations, wherein dwell times are modeled using a probability distribution based on historical data, wherein the dwell times indicate how much capacity in each picking area is being utilized.

9. The system of claim 1, wherein performing the discrete event simulation comprises performing random replications by running a simulation model multiple times with different sets of random input values, to obtain a range of results and analyze statistical measures such as mean, standard deviation, confidence intervals, or percentiles and get eliminate results based on chance or bias.

10. The system of claim 1, wherein the one or more processors are further configured to provide ongoing monitoring of benchmarked values pertaining to process path mix including an optimal number of units assigned to robots for picking tasks (ASRS) and an acceptable threshold that ensures uninterrupted flow during unit picking activities involving both robots (ASRS) and manual pickers.

11. The system of claim 1, wherein performing the discrete event simulation comprises defining a set of experimental parameters for a discrete event simulation engine to automatically run simulations, including defining a range or distribution for each parameter and using the discrete event simulation engine to automatically generate random values within those ranges for each replication.

12. The system of claim 1, wherein the one or more processors are further configured to monitor week-over-week slotting performance metrics for each fulfillment center, analyze aggregated volume mix, heat mapping, identify improvement opportunities, and/or address constraints faced in achieving an optimal distribution of units between bot picking (ASRS) and manual picking activities.

13. The system of claim 1, wherein the one or more processors are further configured to generate a summary dashboard for real-time monitoring of fulfillment center slotting health, including listing open or unslotted location, charges by location type, and containers percentage with multi-mod (Module Order Distribution) travel.

14. The system of claim 1, wherein the one or more processors are further configured to monitor fluctuations in volume of incoming units to a fulfillment center and implement adjustments to achieve a balanced distribution of workload (units to be picked) across various mods, levels, and zones.

15. The system of claim 1, wherein transforming the information comprises cleaning, enriching, and manipulating data into a consistent format that meets format requirements of a discrete event simulation engine.

16. The system of claim 1, wherein the one or more processors are further configured to track metrics in real time, compare the metrics against predefined targets or benchmarks, and set up browser alerts or e-mail notifications based on thresholds being exceeded.

17. The system of claim 1, wherein the one or more processors are further configured to adapt to demand volatility by realigning item placement within a defined mix, including causing shifting items to more prominent locations, adjusting quantities based on demand forecasts, or accounting for new products allocated to a fulfillment center.

18. The system of claim 1, wherein the one or more processors are further configured to provide insights into number of containers fulfilled through inter-Module Order Distribution (MOD) travel, within 1 MOD, 2 MODs, 3 MODs, and 4 MODs.

19. The system of claim 1, wherein the one or more processors are further configured to adjust item placement to align with recommended mix from different location types, continuously to reduce costs and improve cycle time.

20. The system of claim 1, wherein extracting information comprises obtaining a list of items, slots and forward pick assignments by location type, wherein information related to slots include data pertaining to slot numbers, aisle locations, rack positions, and any other relevant slot attributes, wherein information related to forward pick assignments include information on allocation of items to specific pick locations for enhancing order fulfillment efficiency.
